(19) United States
(12) Patent Application Publication
(10) Pub. No.: US 2018/0026823 A1
(43) Pub. Date: Jan. 25, 2018

(54) HIGH CAPACITY ORTHOGONAL FREQUENCY DIVISION MULTIPLE ACCESSING SYSTEMS AND METHODS

(71) Applicant: Rajendra Kumar, Cerritos, CA (US)

(72) Inventor: Rajendra Kumar, Cerritos, CA (US)

(21) Appl. No.: 15/217,919

(22) Filed: Jul. 22, 2016

(51) Int. Cl. H04L 27/26; H04L 5/26; H04L 1/00

(52) U.S. Cl. CPC H04L 27/2646; H04L 1/0057; H04L 27/2628; H04L 5/26; H04L 27/265; H04W 84/042

(57) ABSTRACT

Various embodiments of the invention are directed to methods and systems for high capacity OFDM transmitters and receivers. For example, various embodiments of the transmitter may utilize an architecture comprised of a multiplicity of baseband processing subsystems for receiving and modulating user input data from the respective groups of users, a subsystem for the generation of an OFDM signal comprised of a multiplicity of OFDM signals with spectrum sharing, and a baseband to RF conversion subsystem. Various embodiments of the receiver may utilize an architecture comprised of a multicarrier demodulator, a vector splitter, an inverse transform unit, and an interference mitigating symbol detection subsystem.

### BACKGROUND

Broadband wireless systems are in a rapidly evolutionary phase in terms of the development of various technologies, development of various applications, deployment of various services and generation of many important standards in the field. Although there are many factors to be considered in the design of these systems, the key factors have been the bandwidth utilization efficiency due to the limited bandwidth allocation, flexibility in operation and robustness of the communication link in the presence of various disturbances while achieving the specified performance. At present, the OFDM techniques have been adapted in many wireless communication standards, such as the World-wide Interoperability for Microwave ACCESS (Wimax), digital audio broadcasting (DAB), digital video broadcasting-terrestrial (DVB-T), Long Term Evolution (LTE), etc.

One of the advantages of the OFDM system is the mitigation of a major source of distortion present in high data rate wireless communication links, namely the inter symbol interference (ISI) achieved by reducing the symbol period by the use of multiple carrier transmission. However, the use of a large number of carriers based on the orthogonality property in the OFDM system makes the performance of the system very sensitive to any carrier frequency offsets introduced, for example, by the Doppler shifts encountered in the wireless channels. The proper operation of the OFDM system requires means for precise estimate of the Doppler that may be different for different carriers in the frequency selective fading channel, and means to mitigate such a Doppler effect from the received OFDM signal. Various methods exist in the prior art to solve this problem.

Another important problem arising with the use of a relatively large number N of carriers used in the OFDM signal is a relatively high peak to average power ratio resulting in a much reduced radio frequency (RF) power amplifier efficiency. Due to the inherent saturation in the RF power amplifier, the signal with amplitude exceeding the input linear range of the amplifier is clipped or distorted. In order to keep the distortion to some specified limit arrived at by the signal to distortion plus noise power ratio considerations, the output RF power is backed off from the maximum available power at the amplifier output and higher is the peak to average power ratio of the signal at the amplifier input, larger is the required back off in the output power. The output back off concurrently also results in the reduction of the DC to RF power conversion efficiency of the RF power amplifier thus increasing the drain on the battery or any other power supply source in the mobile devices. Another problem arising due to distortion caused by the amplifier is the spreading of the spectrum of the OFDM signal outside the allocated band.

Various methods exist in the prior art to solve the problem of high peak to average power ratio including the method taught by Kumar in, “Multi Transform OFDM Systems and Methods with Low Peak to Average Power Ratio Signals,” U.S. Pat. No. 8,995,542, Mar. 31, 2015. The simulation results with the Multi Transform OFDM Systems show that the system effectively eliminates any increase in the peak to average power ratio of the OFDM signal due to a relatively large number of carriers.

The OFDM systems have relatively high bandwidth efficiency compared to various other multiple accessing communication systems and methods. However, there is a continuous demand for a higher and higher capacity to meet the requirements of various evolving technologies and applications. Therefore, there is a strong motivation to come up with systems and methods that achieve even higher bandwidth efficiency compared to the traditional OFDM system while inheriting various advantages of the traditional OFDM system.

Among the existing methods of increasing the capacity of communication links carrying a single carrier, it is known, for example, in the commercial television industry, that increased communication link capacity of a link carrying a single carrier maybe obtained using power division multiple accessing (PDMA). According to PDMA, two or more signals may occupy the same spectrum bandwidth. However, the power levels of the signals must differ from each other, typically by 10 dB or more thereby resulting in relatively poor power efficiency.

In Increased Capacity Communication Links with spectrum Sharing, U.S. Pat. No. 8,767,845, Jul. 1, 2014, Kumar teaches a method of increasing the capacity of a single carrier link by about 30%. The method takes advantage of the skirt in the spectrum of the digital signal filtered by a band limiting filter with a raised cosine filtering characteristics. The skirt represents an increase in the bandwidth over that the minimum required bandwidth arrived at by the Nyquist criteria. This increased bandwidth is exploited in Kumar for the increase in the capacity of the communication link. In traditional OFDM systems, the bandwidth allocated to the various subcarriers is equal to the minimum Nyquist bandwidth.

Existing methods for increasing the capacity of the wireless communication networks suffer from high costs, high power requirements, and the limited availability of bandwidth. For example, in wireless communication systems to increase the bandwidth by a factor of two may require doubling the number of base stations that may result in an enormous increase in cost associated with the infrastructure of the base stations including the cell towers, etc. Another alternative method for increasing the capacity both for single links and multiple access networks involves use of higher order modulation. For an increase in the capacity by a factor of two this requires squiring the order of modulation M. For example, it may mean changing M from 4 to 16 or from 16 to 256. Such an increase in the order of modulation M requires relatively high energy to bit energy to noise spectral density ratio (E_{b}/N₀) and highly linear power amplifiers. Achieving linearity of power amplifiers requires high output power back off and reduced power efficiency of the power amplifier. Both the increased requirements on the (E_{b}/N₀) and linearity of power amplifiers result in decreased power efficiency of the communication system that is often unsatisfactory.

In addition, when the OFDM signals experience multipath fading channels, it may not be even possible to use high order modulation techniques with traditional receivers due to the amplitude fading. Use of adaptive receiver taught by Kumar in Adaptive Receiver for High-Order Modulated Signals Over Fading Channels, U.S. Pat. No. 8,233,568, Jul. 31, 2012 solves the latter problem at possibly some increased cost, however, the question of a very significant reduction in the power efficiency with the use of high order modulation poses a more fundamental constraint. For example, increasing the order of modulation from 4 to 16 in quadrature amplitude modulation (QAM) results in about 6 dB increase in the energy requirement per bit of transmitted data or an increase in the transmitted power by a factor of four for the same data rate.

The high capacity OFDM (HCOFDM) transmitter of the invention is comprised of a transmitter wherein two OFDM signals with a relatively small offset among their center frequencies are transmitted over the same transmission bandwidth thereby sharing the spectrum. The number of subcarriers in the HCOFDM transmitted signal is two times the number of subcarriers in the traditional OFDM signal while occupying approximately the same transmission bandwidth wherein the symbol rate of the modulation symbols modulating the individual subcarrier is same as in the traditional OFDM signal. The HCOFDM system of the invention increases the aggregate symbol rate of the transmitted signal by a factor of two over that in the traditional OFDM system without any increase in the transmission bandwidth.

In a mobile wireless communication network, in the downlink from the base station to the mobile user stations, the first group of subcarriers comprising the first OFDM signal in the HCOFDM system of the invention may have relatively higher average transmitted power compared to those in the second OFDM signal comprised of the second group of subcarriers. The subcarriers in the first group may be assigned to the mobile users that are relatively far from the base station with the ones in the second group assigned to the mobile users that are close to the base station such that both groups of users may satisfy the requirements on the probability of error of the detected user data.

The modulated subcarrier signals in each of the two groups of the modulated subcarrier signals, also referred to as the subcarrier signals or also as subcarriers, in the HFOFDM system of the invention are mutually orthogonal and do not cause any mutual interference within the group. However, there is a significant interference among any pair of modulated subcarrier signals belonging to different groups of subcarrier signals with the magnitude of the mutual interference decreasing with the increase in the separation among the center frequencies of the two modulated subcarrier signals.

The receiver in the HFOFDM system of the invention is comprised of a symbol detection subsystem that processes both groups of subcarrier signals for mitigating the mutual interference among the two groups of subcarrier signals and providing the interference mitigated detected modulation symbols. Simulation examples employing QPSK (Quadrature Phase Shift Keying) modulation show the HCOFDM system provides a probability of bit error Pₑ in the range of 10⁻³-10⁻⁴ for both groups of mobile users with an effective average bit energy to noise spectral density (E_{b}/N₀) that is about 3 dB higher compared to the ideal case of no interference with a 100% increase in capacity compared to the traditional OFDM system. Similar results may be expected for other modulation techniques and order of modulation. The QPSK modulation is relatively most robust against various channel imperfection such as fading and amplifier nonlinearities and is efficient in terms of the required (E_{b}/N₀).

In various embodiments of the invention, the available transmission bandwidth may be divided into a number of segments wherein each of the segment may transmit an HCOFDM signal with a relatively small number M of subcarriers in each of the two groups of subcarriers with a relatively small band gap among the spectrum of the various HCOFDM signals wherein the receiver may independently process the various received HCOFDM signals. For example, M may be equal to 32 and the band gap among the HCOFDM signals may be equal to one or an appropriate multiple of a subcarrier signal bandwidth.

The transmitter in the HFOFDM system of the invention may be further comprised of an error correction code encoder associated with each of the two groups of the subcarrier signals. The error correction code encoder may be inputted with the data bit streams from the corresponding group of some Mᵤ<M users and encode consecutive blocks of Mᵤ data bits into code blocks of length M_{I}≦M wherein M_{I} is equal to Mᵤ plus the number of redundancy bits introduced by the error correction code encoder. The multiplicity M_{I} bit streams at the encoder output may be inputted into a group of M_{I} baseband modulators for the generation of M_{I} streams of modulation symbols. The error correction encoder associated with a group of the subcarrier signals may be in addition to and transparent to the pre encoding of the individual users' data with various error correction coding techniques.

The receiver in the HFOFDM system may be further comprised of an error correction decoder that forms an integral part of the symbol detection subsystem for providing the interference mitigated detected modulation symbols. Simulation examples of the HCOFDM system of the invention comprised of relatively simple error correction code encoder/decoder and employing QPSK modulation show a net increase in capacity by 55-85% with an increase in the effective average (E_{b}/N₀) of about 1-2.5 dB compared to the traditional OFDM system. More efficient error correction codes may result in a further increase of capacity of the HCOFDM system of the invention. These and various other advantages of the HCOFDM system will be further evident from the following specifications.

### SUMMARY OF THE INVENTION

Various embodiments of the invention are directed to methods and systems for high capacity OFDM transmitters and receivers. For example, various embodiments of the transmitter may utilize an architecture comprised of a multiplicity two of baseband modulation subsystems for receiving and modulating the user input data from the respective groups of users providing the, in general complex valued, weighted modulation symbols vector of dimension M_{I}.

In various embodiments of the invention the baseband modulation subsystem may be comprised of one or more baseband modulators blocks. The baseband modulator block may comprise of the modulator such as the MQAM (M—Quadarture Amplitude Modulation), the MPSK (M—Phase Shift Keying), or the ASK (M—Phase Shift Keying) modulator, the error correction coding, and interleaving operations generating the information modulation symbols.

The first and second baseband modulation subsystems may further comprise of multipliers for weighting the information modulation symbols by a set of weighting coefficient for providing weighted information modulation symbols wherein the weighting coefficients may determine the relative transmit power allocated to various information modulation symbols. The baseband modulation subsystem may further comprise of a scalar to vector converter for multiplexing the pilot symbols with the M_{I} information modulation symbols providing the first and second weighted modulation symbols vector of dimension M.

Various embodiments of the high capacity OFDM transmitter may further comprise of a dummy symbol generator for providing a number of dummy symbols that are multiplexed along with the information modulation symbols and the pilot symbols in the baseband modulation subsystem. The dummy symbols may be selected from the signal constellation diagram of the baseband modulator so as to minimize the peak to average power ratio of the HCOFDM signal.

Various embodiments of the increased capacity OFDM transmitter may further comprise of the in general time varying orthonormal transforms selected for further minimizing the peak to average power ratio of the OFDM signal and generating a first and a second transformed symbol vector corresponding to the first and the second of the multiplicity two weighted modulation symbols vectors. The orthonormal transforms may be selected, for example, from the group of transforms comprised of the Walsh Hadamard transform (WHT), discrete cosine transform (DCT), and the discrete Hartley transform (DHT) or the more general composite orthonormal transforms. The composite orthonormal transforms and various architectures for the minimization of the peak to average power ratio of the OFDM signal are taught by Kumar in U.S. Pat. No. 8,995, included by reference with the present application, and may be employed with the various embodiments of the invention for the minimization of the peak to average power ratio. An appropriate selection of the orthonormal transforms may also minimize the mutual interference among the two OFDM signals comprising the HCOFDM signal and thereby further increasing the capacity of the HCOFDM system of the invention.

In various embodiments of the OFDM transmitter of the invention, the spacing among the subcarriers may be one half of the update rate for the modulation symbol vector that is equal to the OFDM symbol rate with the guard interval set to 0, and is one half of the spacing used in the traditional OFDM systems resulting in nearly doubling of the capacity of the HCOFDM system of the invention compared to the traditional OFDM systems.

Various embodiments of the high capacity OFDM transmitter of the invention may be further comprised of a multi carrier modulator unit for modulating the components of the first and second transformed modulation symbol vectors onto the subcarriers that may be spaced by one half of the modulation symbol rate. In various embodiments of the invention the components of the first transformed modulation symbol vector may modulate the first group of subcarriers that are spaced by the modulation symbol rate. The components of the second transformed modulation symbol vector may modulate the second group of subcarriers wherein the subcarrier frequencies of the second group have an offset f₀ equal to one half of the modulation symbol rate relative to the subcarriers of the first group.

In various embodiments of the high capacity OFDM transmitter of the invention, the multicarrier modulator may be implemented using the Fast Fourier transform techniques and may be further comprised of a first IFFT block inputted with the first transformed symbol vector for providing a first OFDM signal vector and a second IFFT block inputted with the second transformed symbol vector for providing a second OFDM signal vector, a frequency shifter for providing a frequency shifted second OFDM signal vector, and an adder for adding the first OFDM signal vector and the frequency shifted second OFDM signal vector for providing the transformed OFDM signal vector.

Various embodiments of the high capacity OFDM transmitter of the invention may further comprise a parallel to serial converter for arranging the elements of the OFDM signal vector into the serial OFDM signal, and a baseband to RF conversion subsystem further comprised of the cascade of a guard interval insertion unit providing the digital OFDM signal, a band limiting filter for spectral shaping providing the analog baseband OFDM signal, a carrier modulator, for providing the band pass OFDM signal, an RF bandpass filter and amplifier, and a transmit antenna.

In various embodiments of the increased capacity OFDM transmitter of the invention, the multicarrier modulator may be implemented using the Fast Fourier transform techniques and may be further comprised of a vector collator for collating the components of the first transformed symbol vector and a signed second transformed symbol vector of dimensions M into a modified transformed symbol vector of dimension N=2M, an N point IFFT block, and a vector splitter for providing the transformed OFDM signal vector.

In various alternative embodiments of the high capacity OFDM transmitter, the multicarrier modulator may comprise of a vector collator for collating the components of the first and second transformed symbol vectors of dimension M into a transformed symbol vector of dimension N=2M, a time multiplexed direct digital frequency synthesizer (TMDDFS) and a bank of multiplicity N digital modulators for a more direct implementation of the multicarrier modulator, wherein the N components of the transformed symbol vector may be directly modulated in a bank of N digital modulators by the N digital frequency signals generated by the TMDDFS providing the components of the transformed OFDM signal vector, an adder for providing the serial OFDM signal vector, and a scalar to vector converter for providing the transformed OFDM signal vector.

In various embodiments of the invention the baseband modulation subsystem may be comprised of a parallel to serial converter multiplexing a multiplicity M_{I} users' data into a single serial data, a baseband modulator generating information modulation symbols, and a serial to parallel converter for multiplexing the pilot symbols with the information modulation symbols providing the modulation symbol vector of dimension M, and a vector multiplier for weighting the components of the modulation symbol vector by a set of weighting coefficient that are components of a weight vector for providing weighted modulation symbol vector wherein the weighting coefficients may determine the relative transmit power allocated to various information modulation symbols. The baseband modulator block may comprise of the modulator such as the MQAM or the MPSK modulator. The multiplicity M_{I} users' data may be pre encoded by various error correction coding, and interleaving operations.

In various embodiments of the invention the baseband modulation subsystem may be comprised of a block error correction code encoder unit, a multiplicity M_{I} baseband modulator blocks, M_{I} scalar multipliers, and a scalar to vector converter providing the weighted modulation symbol vector. The block error correction code encoder unit is inputted with a multiplicity Mᵤ users' data for generating a code block of length M_{I} at the output of the unit wherein in a systemic code the first Mᵤ outputs are the users' data with the (M_{I}−Mᵤ) outputs being the parity or redundancy bits introduced by the encoder. In various embodiments of the invention the encoder unit may employ one of the various error correction codes including the Hamming code, BCH code, cyclic code, etc. The M_{I} code bits at the output of the block error correction code encoder unit are inputted to the multiplicity M_{I} baseband modulator units. The baseband modulator block may comprise of the modulator such as the MQAM or the MPSK modulator. The various users' data may be pre encoded using various error correction coding, and interleaving operations. The error correction codes employed in the pre coding of the users' data may be independent of the block error correction code encoder unit.

Various embodiments of the high capacity OFDM receiver of the invention may utilize an architecture comprised of a receive antenna for receiving the bandpass OFDM signal, an RF to baseband conversion subsystem for providing the received serial OFDM signal, a multicarrier demodulator for providing the received transformed symbol vector from the received serial OFDM signal, an inverse transform unit providing the received first and second modulation vectors, a symbol detection subsystem for providing interference mitigated detected information modulation symbols, and baseband demodulator for providing the detected user data.

The RF to baseband conversion subsystem may further comprise of an RF band pass filer and amplifier block for filtering and amplifying the bandpass OFDM signal, an RF to complex baseband converter block that may comprise of an RF to baseband converter and a band limiting filter for shaping the spectrum of the baseband signal, and a guard interval deletion block, for providing the received serial OFDM signal.

In various embodiments of the receiver of the invention, the multicarrier demodulator may be comprised of a time multiplexed direct digital frequency synthesizer (TMDDFS); a bank of multiplicity N correlator units; and a scalar to vector converter.

In various embodiments of the invention, the multicarrier demodulator may be further comprised of a serial to parallel converter for providing a received OFDM signal vector; an odd FFT block for providing an odd component vector; a frequency shifter for providing the frequency shifted received OFDM signal vector; an even FFT block for providing an even component vector; and a collator for collating the first M components each of the odd component vector and the even component vector multiplied by a sign function and providing the received transformed symbol vector.

In various embodiments of the OFDM receiver the inverse transform unit may be comprised of a time varying inverse orthonormal transform operation that is inverse of the orthonormal transform performed at the OFDM transmitter for providing the estimate of the transmitted modulation symbol vector.

In various embodiments of the OFDM receiver of the invention, the symbol detection sub system inputted with the first and second received modulation symbol vectors, may be comprised of a symbol estimate update subsystem providing the interference mitigated detected first and second modulation symbol vectors, and a vector to scalar converter for providing the detected modulation symbols. The symbol estimate update subsystem may be comprised of a means of recursively providing an updated linear estimate of the previous detected second modulation symbol vector and the first and second received modulation symbol vectors, a symbol detector for providing an updated detected first modulation symbol vector, and with a similar means for providing an updated detected second modulation symbol vector from the detected first modulation symbol vector. In various embodiments of the invention, the updated linear estimates of the linear first and second modulation symbol vectors may be based on least squares estimation algorithm.

In various embodiments of the OFDM receiver of the invention, the symbol detection sub system inputted with the first and second received modulation symbol vectors, may be comprised of a symbol estimate update subsystem providing an intermediate detected first and second modulation symbol vectors, a symbol error correction subsystem for mitigating any symbol errors on the basis of error correction code encoder employed at the OFDM transmitter providing an updated error corrected detected first and second modulation symbol vectors, and a vector to scalar converter for providing the detected modulation symbols. In various embodiments of the symbol detection sub system the symbol error correction sub system may be comprised of a symbol to bit stream converter, an error correction code decoder, an error correction code encoder, and a bit stream to symbol converter unit.

In various embodiments of the OFDM receiver of the invention wherein the modulation type is such that the inphase and quadrature components of the modulation symbols may be detected independently as, for example, is the case with with QAM (quadrature amplitude modulation), the symbol detection sub system may operate on the real and imaginary parts of the first and second received modulation symbol vectors for providing the error corrected detected real and imaginary parts of the first and second modulation symbol vectors. The various update operations in the symbol detection sub system for such modulation types may involve only real quantities instead of the complex quantities in the more general case of modulation types.

The various architectures and advantages of the HCOFDM system of the invention will be further evident from the following specifications.

### BRIEF DESCRIPTIONS OF THE DRAWINGS

Various embodiments of the present invention are described here by way of examples in conjunction with the following figures, wherein:

FIG. 1A shows a diagram of a cellular communication system.

FIG. 1B shows plots of the spectrum of an illustrative embodiment of the high capacity OFDM signal with relatively small number of subcarriers.

FIG. 1(B)(a) shows a plot of the spectrum of one embodiment of OFDM group1 subcarrier signals.

FIG. 1(B)(b) shows a plot of the spectrum of one embodiment of OFDM group2 subcarrier signals.

FIG. 1(B)(c) shows a plot of the spectrum of one embodiment of the high capacity OFDM signal.

FIG. 1(B)(d) shows a plot of the spectrum of one embodiment of a multiplicity of high capacity OFDM signals with a band gap among their spectrum.

FIG. 2 shows a block diagram of one embodiment of high capacity OFDM transmitter system.

FIG. 2A shows a block diagram of one embodiment of the IFFT based multi carrier modulation subsystem.

FIG. 2B shows a block diagram of one embodiment of the multi carrier modulation subsystem based on time multiplexed direct digital frequency synthesizer (TMDDFS).

FIG. 2C shows a block diagram of one embodiment of the baseband modulation subsystem.

FIG. 2D shows a block diagram of one embodiment of the baseband modulation subsystem based on a multi user block error correction encoder.

FIG. 3 shows a block diagram of one embodiment of high capacity OFDM receiver system.

FIG. 4 shows a block diagram of one embodiment of the symbol detection subsystem.

FIG. 5A shows a block diagram of one embodiment of the symbol detection subsystem with a symbol error correction unit.

FIG. 5B shows a block diagram of one embodiment of the symbol detection subsystem with a symbol error correction unit operating on real and imaginary parts of the received inverse transformed symbol vectors.

FIG. 6 shows a block diagram of one embodiment of the FFT based multi carrier demodulator.

FIG. 7 shows a plot of the probability of bit error of one embodiment of the high capacity OFDM system.

FIG. 8 shows a plot of the probability of bit error of one embodiment of the high capacity OFDM system wherein group 2 users' data is group encoded with Hamming code.

FIG. 9 shows a plot of the probability of bit error of one embodiment of the high capacity OFDM system wherein both group 1 and 2 users' data are group encoded with Hamming code.

FIG. 10 shows a plot of the probability of bit error of one embodiment of the high capacity OFDM system wherein group 1 and 2 users' data are group encoded with BCH codes with one and two errors correction capability respectively.

FIG. 11 shows a plot of the probability of bit error of one embodiment of the high capacity OFDM system wherein group 1 and 2 users' data are group encoded with BCH codes with one and two errors correction capability respectively.

FIG. 12 shows a plot of the probability of bit error of one embodiment of the high capacity OFDM system wherein both group 1 and 2 users' data are group encoded with BCH codes with two errors correction capability.

FIG. 13 shows a plot of the probability of bit error of one embodiment of the high capacity OFDM system wherein both group 1 and 2 users' data are group encoded with BCH codes with two errors correction capability.

FIG. 14 shows a plot of the probability of bit error of one embodiment of the high capacity OFDM system wherein none of group 1 and 2 users' data are group encoded with any error correction code.

FIG. 15 shows one embodiment of an example computer device.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide systems and methods for high capacity orthogonal frequency multiple accessing (HCOFDM) communication systems.

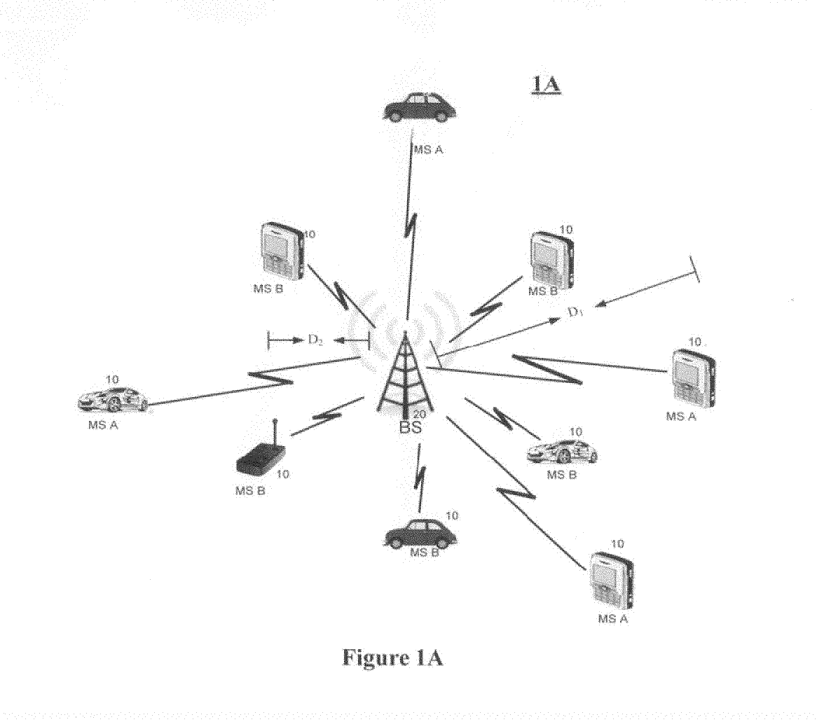

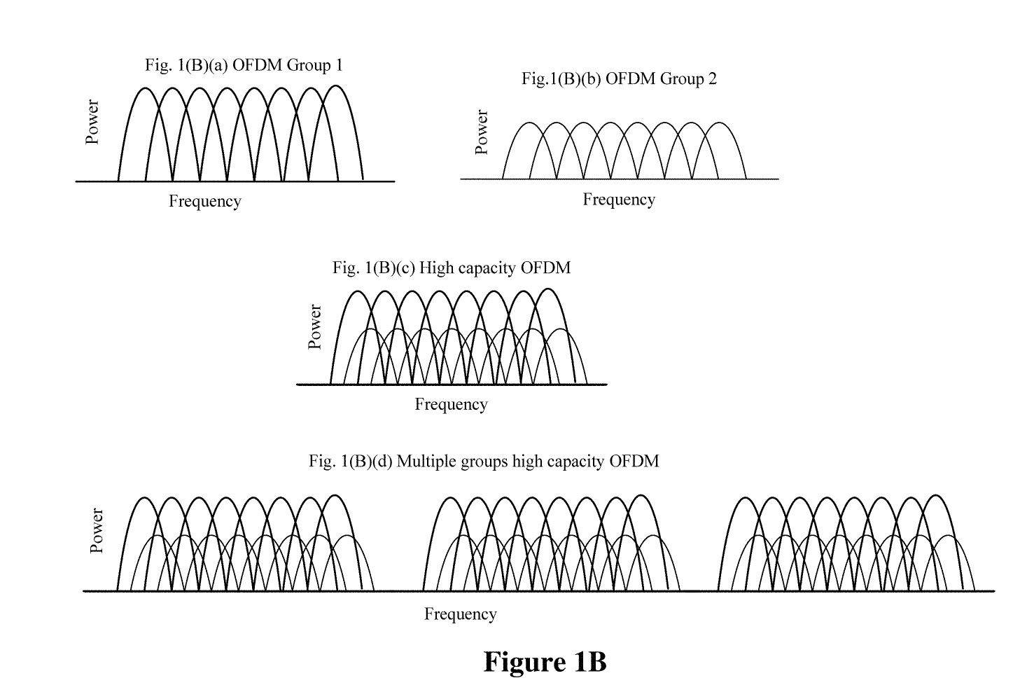

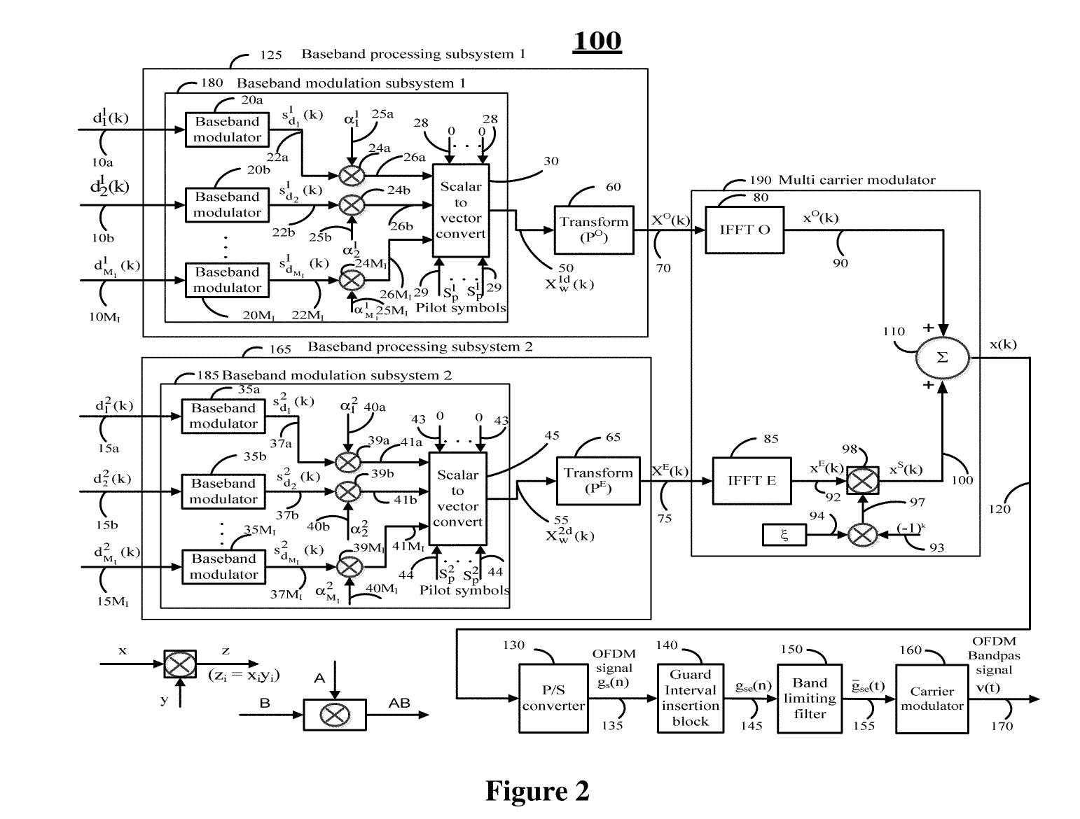

FIG. 1A shows a simplified diagram of a mobile communication network 1. Referring to FIG. 1A, the mobile communication network is comprised of a BS (base station) 20 and a number Nᵤ of mobile subscriber units (MS) 10. The mobile communication network of FIG. 1A may operate in a HCOFDM multiple access mode wherein each of the MSs 10 may be equipped with a HCOFDM transmitter 100 shown in FIG. 2 and a HCOFDM receiver 300 shown in FIG. 3. The base station may be comprised of a multiplicity Nᵤ of the HCOFDM transmitters and receivers that may share a common RF stage and a transmit and receive antenna wherein a multiplicity Nᵤ of the baseband HCOFDM signals are added for providing a composite baseband HCOFDM signal that is inputted to the RF stage for providing the bandpass OFDM signal.

FIG. 1B shows plots of the spectrum of an illustrative embodiment of the high capacity OFDM signal with relatively small number of subcarriers. FIG. 1(B)(a) shows a plot of the spectrum of OFDM group1 subcarrier signals with FIG. 1(B)(b) showing a plot of the spectrum of OFDM group2 subcarrier signals wherein the subcarrier signals of the OFDM group 2 may have relatively smaller power compared to the subcarrier signals of the OFDM group 1. FIG. 1(B)(c) shows a plot of the spectrum of the high capacity OFDM signal obtained by overlaying the spectrum of OFDM group1 and OFDM group 2 subcarrier signals wherein the spectrum of the OFDM group 2 subcarrier signals is shifted relative to the OFDM group 1 subcarrier signals by one half of a subcarrier signal bandwidth. FIG. 1(B)(d) shows a plot of the spectrum of one embodiment of a multiplicity of high capacity OFDM signals with a band gap among their spectrum.

FIG. 2 shows the block diagram of one of the various embodiments of the OFDM (Orthogonal Frequency Division Multiple Accessing) transmitter of the invention. Referring to the OFDM transmitter 100 block diagram in FIG. 2, the group1 users' data 10a through 10 M_{I} d₁¹(k), d₂¹(k), . . . d_{M}_{_{I}}¹(k), that may be binary valued taking possible values 0 and 1, wherein k denotes the discrete time, are inputted to the baseband processing subsystem 125 comprised of a cascade of the baseband modulation subsystem 180 and transform unit 60 for providing the first transformed weighted modulation symbol vector 70 X^{O}(k). Referring to FIG. 2, the group1 users' data 10a through 10 M_{I} are inputted to the baseband modulation subsystem 180 for providing the first weighted modulation symbol vector 50 X_{w}^{1d} to the transform block 60. Throughout this application, the notations 1, 2, . . . , N, or a, b, . . . , N, or a through N are all equivalent and denote the enumeration of integers 1 to N for any integer N. Referring to FIG. 2, the group1 users' data 10a through 10 M_{I} d₁¹(k), d₂¹(k), . . . d_{M}_{_{I}}¹(k) are inputted to the respective baseband modulators 20a through 20M_{I} for providing the information modulation symbols 22a through 22M_{I} s_{d}_{₁}¹, . . . ,

$${s}_{{d}_{{M}_{1}}}^{1}$$

at the outputs of the respective baseband modulators 20a through 20M_{I}.

The baseband modulator 20n for n equal to 1 through M_{I} may segment the input data 10n dₙ¹(k) into groups of m binary valued data bits and map each of the groups of the m binary data bits into one of the [symbol] =2^{m}, in general complex valued, information baseband symbols 22n s_{d}_{ₙ}¹ with m selected equal to an integer greater than or equal to 1. The one to one mapping of the groups of m binary valued data bits into the corresponding baseband symbols may be based on any of the baseband modulation techniques, selected, for example, from the set of the MQAM (M—Quadrature Amplitude Modulation), the MPSK (M—Phase Shift Keying), and the MASK (M—Amplitude Shift Keying) modulation techniques. The BPSK (binary shift keying) and QPSK (quadrature shift keying) modulation techniques constitute the special cases of both the MQAM and the MPSK modulation techniques with W) equal to 2 and 4 respectively. The baseband modulator 20n may be comprised of a pulse shaping or band limiting filter selected, for example, from a group comprised of a raised cosine filter and the square root raised cosine filter.

The baseband modulator 20n may also include various other operations on the user input data 10n dₙ¹(k) such as interleaving and error correction coding before the process of complex baseband modulation comprised of segmentation of the resulting data stream into groups and mapping the groups into the corresponding baseband symbol. In various embodiments of the invention the baseband modulator 20n may comprise of the convolutional codes for error correction.

In various embodiments of the invention the baseband modulators 20n for n equal to 1 through M_{I} may use different order of modulation [symbol] wherein [symbol] =2^{m} for different integer values m with possibly different data rates of the user data 10n such that the symbol period of the modulation symbol 22n are integer multiple of a common symbol period.

Referring to FIG. 2, the information modulation symbols 22a through 22M_{I} are inputted to the multipliers 24a through 24M_{I} respectively for multiplying the information modulation symbols 22a through 22M_{I} by the respective coefficients 25a through 25M_{I} α₁¹(k), α₂¹(k), . . . α_{M}_{_{I}}¹(k) providing the respective scaled information modulation symbols 26a through 26M_{I} to the multiplexer unit 30 wherein the coefficients 25a through 25M_{I} are for adjusting the relative power levels of the respective information modulation symbols s_{d}_{₁}¹, . . .

$${s}_{{d}_{{M}_{1}}}^{1}$$

of the M_{I} users. In various embodiment of the invention the M_{I} coefficients α₁¹(k), α₂¹(k), . . . α_{M}_{_{I}}¹(k) may all be equal to a constant α¹.

Referring to FIG. 2, the output of the multiplexer unit 30 is the weighted modulation symbol vector X_{w}^{1d}(k) wherein the M_{I}≦M elements of the weighted modulation symbol vector X_{w}^{1d}(k) are made equal to the M_{I} weighted information modulation symbols 26. An integer M_{z} elements of the weighted modulation symbol vector may be selected equal to 0 with an Mₚ elements may be set equal to the pilot symbols Sₚ¹. The pilot signals may provide for the synchronization of the phase and frequency of various subcarriers in the OFDM receiver.

A number M_{D} equal to (M−M_{I}−M_{z}−Mₚ) elements of the vector X_{w}^{1d}(k) may be made equal to some dummy symbols, not shown in FIG. 2. The dummy symbols may be used for reducing the peak to average power ratio of the OFDM signal as is taught, for example, in Kumar, U.S. Pat. No. 8,995,542. The weighted modulation symbol vector X_{w}^{1d}(k) may be expressed by X_{w}^{1d}(k)= [symbol] ¹[s_{d}_{₁}¹(k) s_{d}_{₂}¹(k) . . . d_{d}_{_{M}}¹(k)]^{T} where T denotes the matrix transpose and [symbol] ¹ is a diagonal matrix with the diagonal elements given by the elements of the weight vector α¹=[a₁¹ α₂¹ . . . α_{d}_{_{M}}¹]^{T} and where the M_{I} elements of the modulation symbol vector X^{1d}(k)=[s_{d}_{₁}¹(k) s_{d}_{₂}¹(k) . . . d_{d}_{_{M}}¹(k)]^{T} are the modulation symbols at the output of the baseband modulators 20a through 20M_{I}. Some of the elements of the weight vector α¹ may be set equal to 1.

Referring to FIG. 2, the group2 users' data 15a through 15M_{I} are inputted to the baseband processing subsystem 165 comprised of a cascade of the baseband modulation subsystem 185 and transform unit 65 for providing the second transformed weighted modulation symbol vector 75 X^{E}(k). Referring to FIG. 2, the group1 users' data 15a through 15 M_{I} are inputted to the baseband modulation subsystem 185 for providing the second weighted modulation symbol vector 55 X_{w}^{2d}(k) to the transform block 65. Referring to FIG. 2, the group 2 users' data 15a through 15M_{I} d₁²(k), d₂²(k), . . . d_{M}_{_{I}}²(k) are inputted to the respective baseband modulators 35a through 35M_{I} for providing the information modulation symbols 37a through 37M_{I} s_{d}_{₁}², . . . ,

$${s}_{{d}_{{M}_{1}}}^{2}$$

at the outputs of the respective baseband modulators 35a through 35M_{I}.

The operation of baseband modulators 35a through 35M_{I} are similar to those of the baseband modulators for the group 1 users' data. The baseband modulator 35n for n equal to 1 through M_{I} may segment the input data 15n dₙ²(k) into groups of m binary valued data bits and map each of the groups of the m binary data bits into one of the [symbol] =2^{m}, in general complex valued, information baseband symbols 37n s_{d}_{ₙ}² with m is selected equal to an integer greater than or equal to 1. The one to one mapping of the groups of m binary valued data bits into the corresponding baseband symbols may be based on any of the baseband modulation techniques, selected, for example, from the set of the MQAM (M—Quadrature Amplitude Modulation), the MPSK (M—Phase Shift Keying), and the MASK (M—Amplitude Shift Keying) modulation techniques. The BPSK (binary shift keying) and QPSK (quadrature shift keying) modulation techniques constitute the special cases of both the MQAM and the MPSK modulation techniques with [symbol] equal to 2 and 4 respectively.

The baseband modulator 35n may also include other operations on the user input data 15n dₙ²(k) such as interleaving and error correction coding before the process of complex baseband modulation comprised of segmentation of the resulting data stream into groups and mapping the groups into the corresponding baseband symbol. In various embodiments of the invention the baseband modulator 20n may comprise of the convolutional codes for error correction.

In various embodiments of the invention the baseband modulators 35n for n equal to 1 through M_{I} may use different type and order of modulation [symbol] wherein [symbol] =2^{m} for different integer values m with possibly different data rates of the user data 15n such that the symbol period of the modulation symbol 37n are integer multiple of a common symbol period. The type and order of modulation used in baseband modulators 35 may be different than that used in the baseband modulator 20.

Referring to FIG. 2, the information modulation symbols 37a through 37M_{I} are inputted to the multipliers 39a through 39M_{I} respectively for multiplying the information modulation symbols 37a through 37M_{I} by the respective coefficients 40a through 40M α₁²(k), α₂²(k), . . . α_{M}_{_{I}}²(k) providing the respective scaled information modulation symbols 41a through 41M_{I} to the multiplexer unit 45 wherein the coefficients 40a through 40M_{I} are for adjusting the relative power levels of the respective information modulation symbols s_{d}_{₁}², . . . ,

$${s}_{{d}_{{M}_{1}}}^{2}$$

of the M_{I} users.

In various embodiment of the invention the M_{I} coefficients α₁²(k), α₂²(k), . . . α_{M}_{_{I}}²(k) may all be equal to a constant α². In various embodiments of the invention the coefficients α₁¹(k), α₂¹(k), . . . α_{M}_{_{I}}¹(k) in the baseband modulation subsystem 180 may be significantly smaller than the coefficients α₁²(k), α₂²(k), . . . α_{M}_{_{I}}²(k) in the baseband modulation subsystem 185.

Referring to FIG. 2, the output of the multiplexer unit 45 is the weighted modulation symbol vector X_{w}^{2d}(k) given by X_{w}^{2d}(k)= [symbol] ²[s_{d}_{₁}²(k) s_{d}_{₂}²(k) . . . d_{d}_{_{M}}²(k)]^{T} where [symbol] ² is a diagonal matrix with the diagonal elements given by the elements of the weight vector α²=[a₁² α₂² . . . α_{d}_{_{M}}²]^{T}. The M_{I} elements of the modulation symbol vector X^{2d}(k)=[s_{d}_{₁}²(k) s_{d}_{₂}²(k) . . . d_{d}_{_{M}}²(k)]^{T} are the modulation symbols at the output of the baseband modulators 35a through 35M_{I} wherein some of the M−M_{I} elements of the modulation symbol vector may be equal to a number of auxiliary symbols such as the 0s, the pilot symbols, and the dummy symbols. The a coefficients corresponding to the M−M_{I} elements of the modulation symbol vector may be set equal to 1.

Referring to FIG. 2, the weighted modulation symbol vector X_{w}^{1d}(k) is inputted to the transform block 60. The transform block 60 transforms the weighted modulation symbol vector X_{w}^{1d}(k) providing the transformed symbol vector X^{O}(k) with

X^{O}(k)=P^{O}X_{w}^{1d}(k);k=0,1,2, . . . (1)

In (1) P^{O} is some M×M nonsingular matrix appropriately selected so as to reduce the peak to average power ratio of the OFDM signal. In various embodiments of the invention the transform matrix P^{O} may also reduce the effective mutual interference between the two OFDM signals that occupy the same bandwidth. In various embodiments of the invention, the matrix P^{O} may be selected to be some orthonormal matrix. For example, P^{O} may be selected from the set of matrices comprised of the Walsh-Hadamard transform (WHT) matrix P^{W}, the discrete cosine transform (DCT) matrix P^{C}, and the discrete Hartley transform (DHT) matrix pH or may be equal to the identity matrix I_{N} corresponding to the case of no transform. In various embodiments of the invention, the transform matrix P^{O} may be selected from a group of orthonormal matrices to minimize the peak to average signal power ratio of the OFDM signal and may be different for different time index k.

The three transform matrices are given in terms of their (m,n)^{th} element; m, n=1, 2, . . . , M by (2)-(5).

$$\begin{matrix}{P}_{m , n}^{H} = \frac{1}{\sqrt{M}} \{ cos [ 2 π ( m - 1 ) ( n - 1 ) \text{/} M ] + sin [ 2 π ( m - 1 ) ( n - 1 ) \text{/} M ] \} & ( 2 ) \\ {P}_{m , n}^{C} = \sqrt{\frac{2}{M}} cos [ π ( m - 0.5 ) ( n - 0.5 ) \text{/} M ] & ( 3 )\end{matrix}$$

with the Walsh-Hadamard transform matrix P^{W} with its elements equal to +1 or −1 defined recursively in terms of the matrices W, n=2^{m}, m=2, 3, . . . by

$$\begin{matrix}{W}_{{2}^{m}} = [ \begin{matrix}{W}_{{2}^{m - 1}} & {W}_{{2}^{m - 1}} \\ {W}_{{2}^{m - 1}} & - {W}_{{2}^{m - 1}}\end{matrix} ] ; {W}_{2} = [ \begin{matrix}1 & 1 \\ 1 & - 1\end{matrix} ] ; m = 2 , 3 , … & ( 4 ) \\ {P}^{W} = \frac{1}{\sqrt{M}} {W}_{{2}^{{m}_{0}}} ; M = {2}^{{m}_{0}} & ( 5 )\end{matrix}$$

The use of scalar 1/\sqrt{M} in (2)-(5) makes these matrices orthonormal with PP^{H}=I_{M} or P⁻¹=P^{H} for any of the transform matrices P in (2)-(5) with H denoting the matrix conjugate transpose and I_{M} denoting the M×M identity matrix. Due to symmetry, the matrices P^{H}, P^{W}, and P^{C} are also unitary with P⁻¹=P. In some embodiments of the invention, the normalizing scalar that is a multiple of 1/\sqrt{M} may be dropped in (2)-(5) leaving the transform matrices to be orthogonal but not orthonormal.

The use of the orthogonal or orthonormal matrices permits the use of Fast transform techniques permitting the matrix vector multiplication in order M log₂(M) operation instead of requiring order M² operations for obtaining the transformed symbol vector X^{O}(k).

The M×M transform matrix P^{O} may be a partitioned matrix such as the one shown in (5b) such that the pilot symbols or symbols in any specified set are not altered by the transform process. For example, for the case of the number of pilot symbols Mₚ in the modulation symbol vector ^{X1d}(k) being the first symbol of the vector X^{1d}(k), the partitioned matrix P^{O} may be given by (5b).

$${P}^{O} = [ \begin{matrix}1 & \overline{0} \\ {\overline{0}}^{T} & {\overline{P}}^{O}\end{matrix} ] \qquad ( 5 b )$$

In (5b) 0̅ denotes a row vector of zeros of length (M−1) and P̅^{O} is the (M−1)×(M−1) orthonormal transform matrix.

Referring to FIG. 2, the weighted modulation symbol vector X_{w}^{2d}(k) is inputted to the transform block 65. The transform block 65 transforms the weighted modulation symbol vector X_{w}^{2d}(k) providing the transformed symbol vector X^{E}(k) with

x^{E}(k)=P^{E}X_{w}^{2d}(k);k=0,1,2, . . . (6)

In (6) P^{E} is an M×M non singular matrix that may be equal to an M×M orthonormal matrix. The matrix P^{E} may be selected equal to the matrix P^{O}. In various embodiments of the invention the orthonormal transform matrix p may be different from the matrix P^{O}.

Referring to FIG. 2, the first and second transformed symbol vector 70 X^{O}(k) and 75 X^{E}(k) are inputted to the multi carrier modulator unit 190. Referring to FIG. 2, the first transformed symbol vector 70 X^{O}(k) is inputted to the IFFT blocks 80 that provides the first OFDM signal vector 90 x^{O}(k) that is the M point inverse Fourier transform of X^{O}(k) with the n^{th} component xₙ^{O}(k) of the first OFDM signal vector 90 x^{O}(k) given by equation (7).

$${x}_{n}^{O} ( k ) = {\sum }_{m = 1}^{M} {X}_{m}^{O} ( k ) exp ( j 2 π ( m - 1 ) ( n - 1 ) \text{/} M ) ; \\ j = \sqrt{- 1} ; n = 1 , 2 , … M \qquad ( 7 )$$

In a likewise manner the second transformed symbol vector 75 X^{E}(k) is inputted to the IFFT blocks 85 that provides the second OFDM signal vector 92 x^{E}(k) that is the M point inverse Fourier transform of X^{E}(k) given by equation (8).

$${x}_{n}^{E} ( k ) = {\sum }_{m = 1}^{M} {X}_{m}^{E} ( k ) exp ( j 2 π ( m - 1 ) ( n - 1 ) \text{/} M ) ; \\ j = \sqrt{- 1} ; n = 1 , 2 , … M \qquad ( 8 )$$

Referring to FIG. 2, the second signal vector 75 x^{E}(k) is inputted to the frequency shifter comprised of the vector multiplier 98. Referring to FIG. 2, the shift vector 97 ξ(k) is inputted to the vector multiplier 98 wherein the shift vector 97 ξ(k) is given by (9).

τ(k)=(−1)^{k}ξ (9a)

ξ=[1 exp(jπ/M)exp(j2π/M) . . . exp[j(M−1)π/M]^{T} (9b)

The vector multiplier 98 component wise multiplies the second OFDM signal vector 92 x^{E}(k) by the shift vector 97 (k) providing the frequency shifted second OFDM signal vector 100 x^{S}(k) at the output of the vector multiplier 98 given by (10).

xₙ^{S}(k)=(−1)^{k}exp[j(n−1)π/M]xₙ^{E}(k);n=1,2, . . . ,M;k=0,1, . . . (10)

Substitution for xₙ^{E}(k) from (8) in (10) results in the expression for the frequency shifted second OFDM signal vector 100 x^{S}(k) given by (11).

$${x}_{n}^{S} ( k ) = {( - 1 )}^{k} {\sum }_{m = 1}^{M} {X}_{m}^{E} ( k ) exp [ j 2 π ( n - 1 ) ( 2 m - 1 ) \text{/} ( 2 M ) ] ; \\ n = 1 , 2 , … M \qquad ( 11 )$$

Referring to FIG. 2, the first OFDM signal vector 90 x^{O}(k) and the frequency shifted second OFDM signal vector 100 x^{S}(k) are inputted to the adder 110 for providing the transformed OFDM signal vector 120 x(k) given by (12).

$${x}_{n} ( k ) = {\sum }_{m = 1}^{M} [ {X}_{m}^{O} ( k ) + {( - 1 )}^{k} {X}_{m}^{E} ( k ) exp ( j π ( m - 1 ) \text{/} M ] exp ( j 2 π ( m - 1 ) ( n - 1 ) \text{/} M ) \qquad ( 12 )$$

Referring to FIG. 2, the transformed OFDM signal vector 120 x(k) is inputted to the parallel-to-serial converter 130. The parallel to serial converter 130 arranges the elements of the transformed OFDM signal vector x(k) into a serial stream generating the serial OFDM signal 135 gₛ(n). The serial OFDM signal 135 gₛ(n) may be expressed as the sum of N=2M sinusoidal subcarriers with a frequency separation among the subcarrier frequencies equal to 1/(2T₀) modulated by modulation symbols wherein T₀ is the period of the modulation symbols.

The first transformed signal vector x^{O}(k) in equation (7) may be rewritten in the form given by (13).

$${x}_{n}^{O} ( k ) = {\sum }_{i = 1}^{M} {X}_{2 i - 1} ( k ) exp ( j 2 π ( n - 1 ) ( 2 i - 2 ) \text{/} ( 2 M ) ) ; \\ n = 1 , 2 , … M \qquad ( 13 )$$

In (13) X(k) is a vector of dimension N=2M with its elements with odd indices given by the elements of the first transformed symbol vector 70 X^{O}(k) and the elements with even indices given by the elements of the second transformed symbol vector 75 X^{E}(k), with X₂ᵢ₋₁=Xᵢ^{O}; X₂ᵢ=Xᵢ^{E}; i=1, 2, . . . , M.

The frequency shifted second transformed signal vector x^{S}(k) in (11) may be expressed in an alternative form given by

$${x}_{n}^{s} ( k ) = {( - 1 )}^{k} {\sum }_{i = 1}^{M} {X}_{2 i} ( k ) exp [ j 2 π ( n - 1 ) ( 2 i - 1 ) / ( 2 M ) ] ; \\ n = 1 , 2 , … , M \qquad ( 14 )$$

From equations (13), (14), the OFDM signal gₛ(n) may be expressed as

$${g}_{s} ( n ) = {\sum }_{i = 1}^{M} {( - 1 )}^{k ( i - 1 )} {X}_{i} ( k ) exp [ j 2 π ( m - 1 ) ( i - 1 ) / N ] ; \\ n = kM + m ; k = 0 , 1 , … \qquad ( 15 )$$

The expression for gₛ(n) in (15) may be expressed as a sum of N=2M signals g_{s,i}(n) as

$${g}_{s} ( n ) = {\sum }_{i = 1}^{M} {g}_{s , i} ( n ) \qquad ( 16 )$$

wherein the signal g_{s,i}(n) is given by

g_{s,i}(n)=(−1)^{k(i-1)}Xᵢ(k)exp[j2π(m−1(i−1)/N];i=1,2, . . . ,N;n=kM+m;k=0,1, . . . (17)

The serial OFDM signal component g_{s,i}(n) is the sampled version of the continuous time signal gᵢ(t) given by

$${g}_{i} ( t ) = {\sum }_{k = 0}^{∞} {X}_{i} ( k ) {p}_{T} ( t - {kT}_{0} ) exp [ j 2 π {f}_{i} t ] \qquad ( 18 )$$

In (18) fᵢ=(i−1)Δf, i=1, 2, . . . , N, Δf=(½T₀) with T₀=MTₛ, Tₛ is the sampling period, and p(t) is the rectangular pulse of duration T₀ given by

p(t)=1;0<t≦T₀ (19)

The sampled version of gᵢ(t) in (18) with sampling rate equal to (1/Tₛ) may be written as

gᵢ(nT_{S})=Xᵢ(k)exp[j2π(n−1)(i−1)/N];i=1,2, . . . ,N;k=└(n−1)/M┘ (20)

In (20) └x┘ for any real x denotes the highest integer less than or equal to x. With n=kM+m, gᵢ(nT_{S}) in (20) may be expressed as in (21).

$$\begin{matrix}{g}_{i} ( {nT}_{s} ) = {X}_{i} ( k ) exp [ j 2 π ( m - 1 ) ( i - 1 ) / N ] exp [ j π k ( i - 1 ) ] \\ = {( - 1 )}^{k ( i - 1 )} {X}_{i} ( k ) exp [ j 2 π ( m - 1 ) ( i - 1 ) / N ] ; \\ k = 0 , 1 , …\end{matrix} \qquad ( 21 )$$

The expression on the right hand side of (21) is identical to that on the right hand side of (16). The signal 135 gₛ(n) is the sampled version of the sum of N modulated subcarriers with the i^{t} modulated subcarrier gᵢ(t) given by (18), with the frequency spacing Δf equal to one half of that in the traditional OFDM system thereby increasing the capacity of the OFDM system by a factor of two compared to the traditional OFDM system.

Referring to FIG. 2, the serial OFDM signal 135 gₛ(n) is inputted to the guard interval insertion block 140 that introduces a guard band of M_{G} samples between each block of M samples of gₛ(n) to protect against multipath distortion, by the cyclic extension of the M samples block of gₛ(n) generating the digital OFDM signal 145 gₛₑ(n) given by (22).

$${g}_{se} ( n ) = {\sum }_{i = 1}^{N} {( - 1 )}^{k ( i - 1 )} {X}_{i} ( k ) exp [ j 2 π ( m - 1 ) ( i - 1 ) / N ] ; \\ n = k ( M + {M}_{G} ) + m ; m = - {M}_{G} + 1 , … , M ; k = 0 , 1 , … \qquad ( 22 )$$

Referring to FIG. 2, the digital OFDM signal 145 gₛₑ(n) is inputted to the band limiting filter block 150. The band limiting filter block may comprise of convolving the signal gₛₑ(n) with a discrete time band limiting filter impulse response. For example, the band limiting filter may be a square root raised cosine filter. The resulting band limited discrete time signal is converted into the analog form by a digital to analog converter that may be component of the band limiting filter block 150 generating the analog baseband OFDM signal 155 g̅ₛₑ(t). For the specific case of no band limiting filtering, the analog baseband OFDM signal g̅_{g}(t) is given by

$${\overline{g}}_{se} ( t ) = {\sum }_{k = 0}^{∞} {p}_{{T}_{0 e}} ( t - {kT}_{0 e} ) \{ {\sum }_{i = 1}^{N} {X}_{i} ( k ) exp [ j 2 π {f}_{i} t ] \} ; \\ {T}_{oe} = ( M + {M}_{G} ) {T}_{s} ; k = ⌊ t / {T}_{0 e} ⌋ \qquad ( 23 )$$

In (23) the frame period T₀ₑ=(M+M_{G})T_{S} with T_{S} denoting the OFDM sampling period of the digital OFDM signal 145 gₛₑ(n), fₘ=(m−1)Δf, m=1, 2, . . . , N and Δf=½T₀ with T₀=MT_{S}. From (23) the m^{th} element of the transformed symbol vector X(k) modulates the subcarrier exp[j2πfₘt] for m=1, 2, . . . , N with the frequency spacing among the subcarriers equal to Δf=½T₀.

Referring to FIG. 2, the analog baseband OFDM signal 155 g̅ₛₑ(t) is inputted to the RF stage comprised of the carrier modulator block 160 that modulates the signal g̅ₛₑ(t) by the carrier signal generating the band pass OFDM signal 170 v(t) given by

v(t)=Re{g̅ₛₑ(t)exp[j2πf_{c}t]} (24)

In (24) f_{c} denotes the carrier frequency and Re denotes operator that takes the real part of its argument.

The band pass OFDM signal v(t) may be amplified by an RF (radio frequency) power amplifier unit of the RF stage and transmitted by a transmit antenna not shown in FIG. 2. In various other embodiments of the invention, the analog baseband OFDM signal 155 g̅ₛₑ(t) may be first modulated by an intermediate frequency (IF) carrier with the IF modulated signal up converted to the desired RF carrier frequency f_{c} in the carrier modulator unit 160. In various other embodiments of the invention, the carrier modulator unit 160 may comprise of the conversion of the digital OFDM signal 145 gₛₑ(n) to a digital IF signal by digital implementation followed by conversion to an analog IF OFDM signal.

Addition of both sides of equations (13) and (14) results in

$${x}_{n} ( k ) = {\sum }_{i = 1}^{N} {\tilde{X}}_{i} ( k ) exp ( j 2 π ( n - 1 ) ( i - 1 ) / ( N ) ) ; n = 1 , 2 , … M \qquad ( 25 )$$

where in (25) \tilde{X}(k) is an N dimension modified transformed symbol vector with its elements given by (26).

\tilde{X}₂ᵢ₋₁(k)=X₂ᵢ₋₁(k);\tilde{X}₂ᵢ(k)=(−1)^{k}X₂ᵢ(k);i=1,2, . . . M (26)

Referring to FIG. 2, the OFDM signal vector 120 x(k) is equal to the M dimensional sub vector comprised of the first M elements of the IFFT of the vector \tilde{X}(k). In various embodiments of the invention, the transformed OFDM signal vector 120 x(k) may be obtained from the IFFT \tilde{x}(k) of the vector \tilde{X}(k).

FIG. 2A shows an alternative embodiment of the multicarrier modulator of FIG. 2. Referring to FIG. 2A, the second modulation symbol vector 75 X^{E}(k) is inputted to the multiplier 62. The multiplier 62 multiplies the modulation symbol vector X^{E}(k) by (−1)^{k} providing the product 63 (−1)^{k} X^{E}(k) to the vector collator 66. Referring to FIG. 2A, the first modulation symbol vector 70 X^{O}(k) is inputted to the vector collator 66. The vector collator 66 arranges the elements of the two input vectors X^{O}(k) and (−1)^{k} X^{E}(k) into the modified transformed symbol vector 67 \tilde{X}(k) wherein the elements of \tilde{X}(k) with odd indices are equal to the respective elements of the vector X^{O}(k) and wherein the elements of \tilde{X}(k) with even indices are equal to the respective elements of the vector (−1)^{k} X^{E}(k).

Referring to FIG. 2A, the modified transformed symbol vector 67 \tilde{X}(k) is inputted to the N=2M point IFFT block 76 for providing the inverse Fourier transform 77 \tilde{x}(k) of the input vector 67 \tilde{X}(k). The extended signal vector 77 \tilde{x}(k) is inputted to the vector splitter 86. The vector splitter 86 provides the OFDM signal vector 120 x(k) comprised of the first M elements of the extended signal vector 77 \tilde{x}(k).

FIG. 2B shows an alternative embodiment of the multicarrier modulator of FIG. 2. Referring to the multicarrier modulator 190B of FIG. 2B, the first transformed symbol vectors 70 X^{O}(k) and the second transformed symbol vectors 75 X^{E}(k) are inputted to the vector to scalar converter/collator 270 for collating the components of the first and second transformed symbol vectors of dimensions M into components 272a through 272N X₁(k), . . . , X_{N}(k) of a transformed symbol vector X(k) of dimension N=2M, wherein X₂ᵢ₋₁(k)=Xᵢ^{O}(k), X₂ᵢ(k)=Xᵢ^{E}(k); i=1, 2, . . . , M. Referring to FIG. 2B, the components 272a through 272N X₁(k), . . . , X_{N}(k) of a transformed symbol vector X(k) are inputted o the digital modulators 274a through 274N respectively.

Referring to FIG. 2B, the TMDD (Time Multiplexed Direct Digital) Frequency Synthesizer unit 340 generates the N digital frequency signals given by exp(jnΩₘ) with Ωₘ=[2π(m−1)/(N)], m=1, 2, . . . , N; n=0, 1, . . . , (M−1). The TMDD frequency synthesizer is taught in Kumar, Frequency Hopped Frequency Modulation Spread Spectrum (FHFMSS) Multiple Accessing Communication Systems and Methods, U.S. patent application Ser. No. 14/735,532, Jun. 10, 2015, included here by reference. The TMDD frequency synthesizer may be comprised of a single read only memory (ROM) unit that may store N samples of a single period of the sine wave of the fundamental frequency f₀=Δf=½T₀. With the sampling rate selected equal to 1/Tₛ=M/T₀; the sampled sine wave of the fundamental frequency may be given by sin(πn/(M)), n=0, 1, . . . , N. The memory locations in the ROM may be configured to store samples of both the sine and cosine waves of the fundamental frequency f₀. The TMDDFS (TMDD Frequency Synthesizer) may be configured to generate samples of both the sine and cosine waves of the N frequencies (m−1) f₀, m=1, 2, . . . , N.

Referring to FIG. 2B, the TMDDFS unit 340 generates the digital cosine waves 341 a through 341N cos(Ω₁n), . . . , cos(ΩNn) of the N frequencies (m−1) f₀, m=1, 2, . . . , N and the digital sine waves 342 a through 342N sin(Ω₁n), . . . , sin(ΩNn). Referring to FIG. 2B, the digital cosine waves 341 a through 341N and the digital sine waves 342 a through 342N are inputted to the real to complex converter 347 for the generation of the complex exponential waveforms 273a through 273N exp(Ω₁n), . . . , exp(ΩNn) by combining the sine and cosine waveforms wherein exp(jΩₘn)=cos(Ωₘn)+j sin(Ωₘn); m=1, 2, . . . , N; j=\sqrt{−1}.

Referring to FIG. 2B, the complex exponential waveforms 273a through 273N exp(Ω₁n), . . . , exp(ΩNn) are inputted to the digital modulators 274a through 274N modulating the components X₁(k), . . . , X_{N}(k) providing the components 278a through 278N \tilde{x}₁(n), . . . , \tilde{x}_{N}(n) of the serial OFDM signal \tilde{x}(n) to the adder 280. The adder provides the sum 282 \tilde{x}(n) of the components 278a through 278N \tilde{x}₁(n), . . . , \tilde{x}_{N}(n) to the scalar to vector converter 285. Referring to FIG. 2B, the scalar to vector converter 285 converts the serial scalar signal 282 \tilde{x}(n) into the vector 120 x(k) wherein the components of x(k) are comprised of the first M samples of the signal 282 \tilde{x}(n).

FIG. 2C shows an alternative embodiment of baseband modulation subsystem of the OFDM transmitter of the invention wherein all the users' data of group1 users use a common modulation scheme. Referring to the baseband modulation subsystem 180A in FIG. 2C, the multiplicity M_{I} group 1 users' data d₁¹(k), d₂¹(k), . . . d_{M}_{_{I}}¹(k) are inputted to the parallel to serial converter 205. The parallel to serial converter 205 multiplexes group1 M_{I} users' data d₁¹(k), d₂¹(k), . . . d_{M}_{_{I}}¹(k) providing the multiplexed data d¹(k) to the input of the baseband modulator 220.

Referring to FIG. 2C, the baseband modulator block 220 may segment the input data into groups of m binary valued data bits and maps each of the groups of the m binary data bits into one of the [symbol] =2^{m}, in general complex valued, information baseband symbols 222 s_{d}¹(k) with m selected equal to an integer greater than or equal to 1. The one to one mapping of the groups of m binary valued data bits into the corresponding baseband symbols may be based on any of the baseband modulation techniques, selected, for example, from the set of the MQAM (M—Quadrature Amplitude Modulation), the MPSK (M—Phase Shift Keying), and the MASK (M—Amplitude Shift Keying) modulation techniques. The BPSK (binary shift keying) and QPSK (quadrature shift keying) modulation techniques constitute the special cases of both the MQAM and the MPSK modulation techniques with [symbol] equal to 2 and 4 respectively. The group 1 users' data may be pre encoded with various error correction codes and interleaving operations.

Referring to FIG. 2C, the information baseband symbols 222 s_{d}¹(k) is inputted to the serial to parallel converter unit 230. The serial to parallel converter unit 230 is inputted with Mₚ pilot symbols that may be used for providing time and frequency synchronization and may also insert a number M_{z} of zeros. The unit 230 may also introduce M_{D} dummy symbols, not shown in the Figure for the purpose of minimizing the peak to average power ratio of the OFDM signal.

The serial to parallel converter unit 230 provides provides the first modulation symbol vector 224 M X^{1d}(k) with elements of the vector 224 comprised of the subsequences {sₘ¹(k)} with M=(M_{I}+M_{z}+Mₚ+M_{D}) wherein M_{I} of these subsequences are comprised of the information baseband symbols s_{d}¹(k) with M_{z} of the subsequences having all the elements equal to zero. For example, for the case wherein the first M_{I} subsequences are comprised of the information baseband symbols s_{d}¹(k) 222, sₘ¹(k)=s_{d}¹(n), n=kM_{I}+m−1, m=1, 2, . . . , M_{I}; k=0, 1, 2 . . . .

Referring to FIG. 2C, the first modulation symbol vector 224 X^{1d}(k) at the output of the serial to parallel converter unit 230 is inputted to the vector multiplier 226. The vector multiplier 226 component wise multiplies the first modulation symbol vector 224 X^{1d}(k) by a coefficient vector 225 α¹ for adjusting the relative power level of the first modulation symbol vector 224. Referring to FIG. 2C, the vector multiplier 226 outputs the first weighted modulation symbol vector 227 X_{w}^{1d}(k) at the output.

Referring to the baseband modulation subsystem 185A in FIG. 2C, the input data 240 d²(k) that may be obtained by multiplexing group 2 M_{I} users' data 15a through M_{I} d₁²(k), d₂²(k), . . . d_{M}_{_{I}}²(k) by a parallel to serial converter 235, is inputted to the baseband modulator 250. Referring to FIG. 2C, the information baseband symbols 252 s_{d}²(k) at the output of the baseband modulator 250 are inputted to the serial to parallel converter 260 providing the second modulation symbol vector 254 X^{2d}(k) at the output of the unit 260. The second modulation symbol vector 254 X^{2d}(k) is multiplied by a coefficient vector 255 α² by the vector multiplier 256 for adjusting the relative power level of the components of the second modulation symbol vector 254 X^{2d}(k). Referring to FIG. 2C, the vector multiplier 256 provides the second weighted modulation symbol vector 55 X^{2d}(k) at the output.

The operation of the subsystem comprised of the baseband modulator 250, the serial to parallel converter 260, the vector multiplier 256 is similar to the subsystem comprised of the baseband modulator 220, the serial to parallel converter 230, and the vector multiplier 256.

FIG. 2D shows an alternative embodiment of the baseband modulation subsystem 180B. Referring to FIG. 2D, the group1 users' data 5a through 5Mᵤ_{₁}(k),d₂¹(k), . . .

$${d}_{{M}_{{u}_{1}}}^{1} ( k ) ,$$

that may be binary valued taking possible values 0 and 1, wherein k denotes the discrete time, are inputted to the block error correction code encoder unit 250. The block error correction code encoder unit 250 generates a code block of length M_{I} at the output of the unit 250 comprised of the M_{I} outputs 10a through 10M_{I} d₁¹(k), d₂¹(k), . . . d_{M}_{_{I}}¹(k) wherein in a systemic code the first Mᵤ_{₁} outputs 10a through 10 Mᵤ_{₁}d₁¹(k),d₂¹(k), . . .

$${d}_{{M}_{{u}_{1}}}^{1} ( k )$$

are the input data with the (M_{I}−Mᵤ_{₁}) outputs 10Mᵤ_{₁}₊₁ through 10M_{I} dᵤ_{₁}₊₁¹(k), d₂¹(k), . . . d_{M}_{_{I}}¹(k) being the parity or redundancy bits introduced by the error correction code encoder. In FIG. 2D, the suffix 1 on Mᵤ has been dropped for brevity.

In various embodiments of the invention the encoder unit 250 may employ one of the various error correction codes including the Hamming code, BCH code, cyclic code, and the identity code, etc. The selection of identity code corresponds to no error correction coding with the output of the encoder unit 250 being identical to the input. The selection of the integer values for M_{I} and Mᵤ_{₁} may depend upon the specific code selected and the error correction capability of the code in terms of the number of code bit errors that the code can correct. For example, the Hamming code is a single error correction code wherein the integer M_{I} is equal to 2^{m}−1 wherein n may be an integer greater than equal to 3 with Mᵤ_{₁}=2ⁿ−b−1 wherein n is the number of parity bits. For example, with n=6, M_{I}=63, Mᵤ_{₁}=57 and the number of parity bits is equal to 6 with code rate=57/64.

The block codes such as the BCH code and the cyclic code are more efficient in terms of higher code rate and their capability in correcting higher number of code bit errors. A primitive narrow-sense BCH code, for example, has the code length M_{I} equal to 2ⁿ−1 wherein n is an integer and code distance d≦2ⁿ−1 with the number of error that can be corrected equal to └d/2┘ where └x┘ for any real x denotes the highest integer that is less than or equal to x. The error correction codes are described in numerous text books on the subject, for example in Error Control Coding by Shu Lin and Daniel Costello, published by Pearson, 2005, ISBN 0130426725. The BCH block code may be described by the triplet (n_{c}, k_{c}, t_{c}) wherein n_{c} is the code block length, k_{c} is the number of information bits and t_{c} is the maximum number of errors that can be corrected by the code.

The Table 1 lists a selected number of possible values of the triplets (n_{c}, k_{c}, t_{c}).

TABLE 1
BCH code parameters (n_{c}, k_{c}, t_{c})

| n_{c} | k_{c} | t_{c} |
|---|---|---|
| 31 | 26 | 1 |
| 31 | 21 | 2 |
| 63 | 57 | 1 |
| 63 | 51 | 2 |
| 63 | 45 | 3 |
| 127 | 120 | 1 |
| 127 | 113 | 2 |
| 127 | 106 | 3 |
| 255 | 247 | 1 |
| 255 | 239 | 2 |
| 255 | 231 | 3 |

Referring to FIG. 2D, each of the user data dₙ¹ for n equal to 1 through Mᵤ_{₁} may be the result of pre encoding of the user data by an interleaver, an error correction encoder, etc., not shown in the Figure, operating on the user information bit streams wherein the error correction coder works independently of the unit 250 that works jointly on the user data of the multiplicity Mᵤ_{₁} group 1 users. The error correction code encoder unit 250 is transparent to the error correction code employed in pre encoding of the individual user data. The error correction encoder operating on the individual user information bit streams may differ from user to user and is, in general, different from the code employed in encoder unit 250. The error correction encoder operating on the individual user information bit streams may, for example, be a block code or a convolution code or a concatenation thereof.

Referring to FIG. 2D, the coded data bits 10a through 10M_{I} d₁¹(k), d₂¹(k), . . . d_{M}_{_{I}}¹(k) are inputted to the respective baseband modulators 20a through 20M_{I} for providing the information modulation symbols 22a through 22M_{I} s_{d}_{₁}¹, . . . ,

$${s}_{{d}_{{M}_{I}}}^{1}$$

at the outputs of the respective baseband modulators 20a through 20M_{I}.

The baseband modulator 20n for n equal to 1 through M_{I} may segment the input data 10n dₙ¹(k) into groups of m binary valued data bits and map each of the groups of the m binary data bits into one of the [symbol] =2^{m}, in general complex valued, information baseband symbols 22n s_{d}_{ₙ}¹ with m selected equal to an integer greater than or equal to 1. The one to one mapping of the groups of m binary valued data bits into the corresponding baseband symbols may be based on any of the baseband modulation techniques, selected, for example, from the set of the MQAM, the MPSK, and the APSK modulation techniques. The BPSK and QPSK modulation techniques constitute the special cases of both the MQAM and the MPSK modulation techniques with [symbol] equal to 2 and 4 respectively.

In various embodiments of the invention the baseband modulators 20n for n equal to 1 through M_{I} may use different order of modulation [symbol] wherein [symbol] =2^{m} for different integer values m with possibly different data rates of the user data 10n such that the symbol period of the modulation symbol 22n are integer multiple of a common symbol period.

Referring to FIG. 2D, the information modulation symbols 22a through 22M_{I} are inputted to the multipliers 24a through 24M_{I} respectively for multiplying the modulation symbols 22a through 22M_{I} by the respective coefficients 25a through 25M_{I} α₁¹(k), α₂¹(k), . . . α_{M}_{_{I}}¹(k) providing the respective scaled modulation symbols 26a through 26M_{I} to the scalar to vector converter unit 30 wherein the coefficients 25a through 25M_{I} are for adjusting the relative power levels of the respective modulation symbols 22a through 22M_{I} s_{d}_{₁}¹, . . . ,

$${s}_{{d}_{{M}_{I}}}^{1} .$$

In various embodiment of the invention the M_{I} coefficients α₁¹(k), α₂¹(k), . . . α_{M}_{_{I}}¹(k) may all be equal to a constant α¹.

Referring to FIG. 2D, the output of the scalar to vector converter unit 30 is the weighted modulation symbol vector X_{w}^{1d}(k) wherein the M_{I}≦M elements of the weighted modulation symbol vector X_{w}^{1d} (k) are made equal to the M_{I} weighted modulation symbols 26. An integer M_{z} elements of the weighted modulation symbol vector may be selected equal to 0 with an Mₚ elements may be set equal to the pilot symbols. The pilot signals may provide for the synchronization of the phase and frequency of various subcarriers in the OFDM receiver. The M_{D}=M−M_{I}−M_{z}−Mₚ elements of the vector X_{w}^{1d}(k) may be made equal to some dummy symbols, not shown in FIG. 2D.

Referring to FIG. 2, the serial OFDM signal gₛ(n) is the sum of N=2M signals g_{s,i}(n) as is in (16) with the signal g_{s,i}(n) for i equal to 1 through N given by (17). With g̅_{s,i}(n)g_{s,i}(n)/Xᵢ(k); kM≦n<(k+1)M, i=1, 2, . . . , N, the signals \tilde{g}_{s,κ}(n) and \tilde{g}_{s,l}(n) with κ=(2i−1); l=(2m−1); 1≦i, m≦M are uncorrelated with the correlation coefficient given by

$$\begin{matrix}{ρ}_{κ , 1} = \frac{1}{M} {\sum }_{n = 1}^{M} {\tilde{g}}_{s , κ}^{*} ( {nT}_{s} ) {\tilde{g}}_{s , 1} ( {nT}_{s} ) \\ = \frac{1}{M} {\sum }_{n = 1}^{M} exp [ - j 2 π ( n - 1 ) ( i - 1 ) / M ] exp [ j 2 π ( n - 1 ) ( m - 1 ) / M ] \\ = \frac{1}{M} {\sum }_{n = 1}^{M} exp [ j 2 π ( n - 1 ) ( m - i ) / M ]\end{matrix} \qquad ( 27 )$$

where * in (27) denotes the complex conjugate and the sum of the geometric series in the right hand side of (27) is zero for i≠m.

The correlation coefficient of the signals \tilde{g}_{s,κ}(n) and \tilde{g}_{s,l}(n) with κ=2i; l=2m; 1≦i, m≦M is given by

$$\begin{matrix}{ρ}_{κ , 1} = \frac{1}{M} {\sum }_{n = 1}^{M} exp [ - j 2 π ( n - 1 ) ( 2 i - 1 ) / N ] exp [ j 2 π ( n - 1 ) ( 2 m - 1 ) / N ] \\ = \frac{1}{M} {\sum }_{n = 1}^{M} exp [ j 2 π ( n - 1 ) ( m - i ) / M ]\end{matrix} \qquad ( 28 )$$

The sum in the right hand side of (28) is zero for i≠m whereby the signals \tilde{g}_{s,κ}(n) and \tilde{g}_{s,l}(n) with k and l even are uncorrelated.

The correlation coefficient of the signals \tilde{g}_{s,i}(n) and \tilde{g}_{s,l}(n) with m=(l−i) equal to an odd integer is given by

$$\begin{matrix}{ρ}_{i , 1} = \frac{1}{M} {\sum }_{n = 1}^{M} exp [ - j 2 π ( n - 1 ) ( i - 1 ) / N ] exp [ j 2 π ( n - 1 ) ( l - 1 ) / N ] \\ = \frac{1}{M} {\sum }_{n = 1}^{M} exp [ j π ( n - 1 ) m / M ] ; m = 1 - i ; k \text{:} even\end{matrix} \qquad ( 29 )$$

The expression on the right hand side of (29) may be computed as

$$\begin{matrix}{ρ}_{k , 1} = \frac{exp ( - j θ )}{sin ( πθ ) / πθ} \frac{2 j}{π m} \approx \frac{2 j}{π m} ; θ = ( π m / N ) j = \sqrt{- 1} ; k \text{:} even & ( 30 a ) \\ {ρ}_{k , 1} \approx \frac{- 2 j}{π m} ; k \text{:} odd & ( 30 b )\end{matrix}$$

From the expression in (2) for the continuous waveform \tilde{g}ᵢ(t)=gᵢ(t)/Xᵢ(t), Xᵢ(t)=Xᵢ(k); (k−1)T₀≦t<kT₀, the correlation coefficient between the any two waveform \tilde{g}ᵢ(t) and \tilde{g}ₗ(t) with m=(l−i) equal to an odd integer may be computed as

$${ρ}_{i , 1} = \frac{1}{{T}_{0}} {\int }_{0}^{{T}_{0}} exp [ j π ( 1 - i ) t / {T}_{0} ] dt = \frac{2 j}{π m} ; m = 1 - i ; k \text{:} odd \qquad ( 31 )$$

With the vectors \tilde{g}^{O} and \tilde{g}^{E} defined in (32)

\tilde{g}^{O}=[\tilde{g}₁\tilde{g}₃ . . . \tilde{g}_{N-1}]^{T};\tilde{g}^{E}=[\tilde{g}₂\tilde{g}₄ . . . \tilde{g}_{N}]^{T} (32)

The cross correlation matrix Ψ_{1,2} between the two vectors may be obtained from (30)-(31) and for even time index k may be given by

$${Ψ}_{1 , 2} = \frac{1}{M} {\sum }_{n = 1}^{M} {\tilde{g}}^{OH} ( n ) {\tilde{g}}^{E} ( n ) = ( j 2 / π ) [ \begin{matrix}1 & 1 / 3 & 1 / 5 & … & 1 / ( N - 1 ) \\ - 1 & 1 & 1 / 3 & … & 1 / ( N - 3 ) \\ - 1 / 3 & - 1 & 1 & … & 1 / ( N - 5 ) \\ ⋮ & ⋮ & ⋮ & ⋮ & ⋮ \\ - 1 / ( N - 1 ) & - 1 / ( N - 3 ) & - 1 / ( N - 5 ) & … & 1\end{matrix} ] ; \\ j = \sqrt{- 1} ; {Ψ}_{N}^{H} = {Ψ}_{N} \qquad ( 33 )$$

The matrix Ψ_{1,2} in (33) is a Hermitian symmetric Toeplitz matrix. The correlation matrix Ψ_{N} of the vector \tilde{g}=[\tilde{g}^{OT} \tilde{g}^{ET}]^{T} is given in terms of the matrix Ψ_{1,2} by

$${Ψ}_{N} = [ \begin{matrix}{I}_{M} & {Ψ}_{12} \\ {Ψ}_{21} & {I}_{M}\end{matrix} ] ; {Ψ}_{2 , 1} = {Ψ}_{1 , 2}^{H} \qquad ( 34 )$$

In (34) H denotes complex conjugate transpose and I_{M} is an M×M identity matrix. For the even time index k the Ψ_{1,2} matrix is multiplied by −1. The matrix Ψ_{N} in (34) is an N×N Hermitian symmetric matrix.

FIG. 3 shows the block diagram of one of the various embodiments of the high capacity OFDM receiver 300 of the invention. Referring to FIG. 3, the band pass OFDM signal is received by the receive antenna 300 providing the output 302 to the RF to baseband conversion subsystem 306. Referring to FIG. 3, the received band pass signal 302 is inputted to the RF band pass filter (BPF)/amplifier block 305. The RF BPF/amplifier block filters out any out of band signal and noise and amplifies the OFDM signal to an appropriate power level. The signal r(t) 310 at the output of the RF band pass filter (BPF)/amplifier block 305 is comprised of the band pass OFDM signal v(t) and the noise n(t) that may arise from various sources with r(t) given by

r(t)=v(t)+n(t) (35a)

r(t)=Re{g̅ₛₑ(t)exp[j2πf_{c}t]}+Re{n_{b}(t)exp[j2πf_{c}t]} (35b)

In (35) n(t) is the band pass white noise with one-sided power spectral density [symbol] ₀ and in the absence of the square root raised cosine filters at the transmitter and receiver, n_{b} is the complex baseband noise with two-sided power spectral density [symbol] ₀.

Referring to FIG. 3, the output r(t) 310 of the RF BPF/amplifier block 305 is provided to the RF to complex baseband converter 315. The RF to complex baseband converter 315 block down converts the RF signal r(t) to complex baseband, may filter the down converted signal by a band limiting filter such as the square root raised cosine filter, and converts the filtered signal to the digital form by an analog to digital converter providing the resulting received digital OFDM signal 320 hₛₑ(n) to the guard interval deletion block 325. In the absence of the square root raised cosine filter, the output 320 hₛₑ(n) is the sampled version of received analog OFDM signal ((g̅ₛₑ(t)+n_{b}(t)). In the presence of the band limiting filter, the signal g̅ₛₑ(t) is modified by the filter response of the band limiting filter and the power spectral density [symbol] ₙ(f) of the noise n_{b}(t) is [symbol] a function of the frequency response of the band limiting filter.

The sampling rate for the analog to digital converter contained in the RF to complex baseband converter block 315 is selected to be K₀ times the sampling rate used in the OFDM signal 145 gₛₑ(n) at the output of the guard interval insertion block 140 in the OFDM transmitter 100 block diagram of FIG. 1 wherein K₀ is an even integer greater than or equal to 2.

Referring to FIG. 3, the received digital OFDM signal 320 hₛₑ(n) is inputted to the guard interval deletion block 325. The guard interval deletion block 325 removes the guard interval from each of the OFDM frame of length by deleting K₀M_{G} samples from the OFDM frame of length K₀(M+M_{G}) samples of the received digital OFDM signal 320 hₛₑ(n) wherein M_{G} is the number of samples in the guard interval at the transmitter 100 and provides the received serial OFDM signal 330 hₛ(n) to the multi carrier demodulator block 385.

Referring to FIG. 3, the received serial OFDM signal 330 hₛ(n) is inputted to the bank of N correlators 335a, through N. Throughout the description of this invention, the notations a, b, . . . , N and 1, 2, . . . , N for any integer N are equivalent and both refer to the enumeration between 1 and N. Referring to FIG. 3, the cascade of the TMDD (Time Multiplexed Direct Digital) Frequency Synthesizer unit 340 and the real to complex converter 343 generates the N digital frequency signals given by exp(−jnΩₘ) with Ωₘ=[2π(m−1)/(MK₀)], m=1, 2, . . . , N; n=0, 1, . . . .

The TMDD frequency synthesizer may be comprised of a single read only memory (ROM) unit that stores Nₛ samples of a single period of the sine wave of the fundamental frequency f₀=Δf=½T₀. With the sampling rate selected equal to 1/tₛ=K₀/Tₛ=MK₀/T₀; the sampled sine wave of the fundamental frequency may be given by sin(πn/(MK₀)), n=0, 1, . . . , Nₛ, wherein Nₛ=2MK₀. The constant K₀ needs to be at least 2 and may be selected to be equal to 4. The memory locations in the ROM may be configured to store samples of both the sine and cosine waves of the fundamental frequency f₀. The TMDDFS may be configured to generate samples of both the sine and cosine waves of the N frequencies (m−1) f₀, m=1, 2, . . . , N.

Referring to FIG. 3, the TMDDFS unit 340 generates the digital sine waves 341 a through 341N sin(Ω₁n), . . . , sin(ΩNn) of the N frequencies (m−1) f₀, m=1, 2, . . . , N and the digital cosine waves 342 a through 342N cos(Ω₁n), . . . , cos(ΩNn). Referring to FIG. 3, the digital cosine waves 341 a through 341N and the digital sine waves 342 a through 342N are inputted to the real to complex converter 343 for the generation of the complex exponential waveforms 344a through 344N exp(−Ω₁n), . . . , exp(−ΩNn) by combining the sine and cosine waveforms wherein exp(−Ωₘn)=cos(Ωₘn)−j sin(Ωₘn); m=1, 2, . . . , N; j=\sqrt{−1}.

Referring to FIG. 3, the digital frequency signal 344m exp(−jnΩₘ) is inputted to the correlator 335m for m=1, 2, . . . , N. The outputs 345a through N of the correlator 335 are inputted to the respective integrate and dump blocks 346a through N. The integrate and dump block 346m averages out the input 345m over consecutive periods of N₀=MK₀ samples providing the output 348m Zₘ(k) for m=1, 2, . . . , N. The integrate and dump block 345 m output Zₘ(k) is comprised of a signal component Yₘ(k) and a noise component ηₘ(k) with

Zₘ(k)=Yₘ(k)+ηₘ(k) (36)

$${Y}_{m} ( k ) = \frac{1}{{N}_{0}} {\sum }_{\vert = 0}^{{N}_{0}} {\sum }_{i = 1}^{N} {X}_{i} ( k ) exp [ j π ( \vert - 1 ) ( i - 1 ) / {N}_{0} ] exp [ - j {Ω}_{m} ( \vert - 1 ) ] ; \\ n = {kN}_{0} + \vert ; \qquad ( 37 )$$

Substitution of Ωₘ=[π(m−1)/(N₀)] in (37) results in

$${Y}_{m} ( k ) = {\sum }_{i = 1}^{N} {X}_{i} ( k ) \frac{1}{{N}_{0}} {\sum }_{\vert = 1}^{{N}_{0}} exp [ j π ( \vert - 1 ) ( i - m ) / {N}_{0} ] ; \\ n = k ( {N}_{0} ) + \vert ; k = 0 , 1 , … \qquad ( 38 )$$

The inner summation in (38) is zero for (i−m) even with (i−m)≠0 and for (i−m) odd may be evaluated as

$$\begin{matrix}\begin{matrix}\frac{1}{{N}_{0}} {\sum }_{\vert = 0}^{{N}_{0}} exp [ j π ( \vert - 1 ) i / {N}_{0} ] = \frac{1}{{N}_{0}} \frac{[ 1 - exp ( j π i ) ]}{[ 1 - exp ( j π i / {N}_{0} ) ]} \\ = \frac{2 j}{π i} {c}_{i} , i \text{:} odd ; k \text{:} even\end{matrix} & ( 39 ) \\ {c}_{i} = \frac{{θ}_{i}}{sin ( {θ}_{i} )} exp ( - j {θ}_{i} ) ; {θ}_{i} = \frac{π i}{2 {N}_{0}} & ( 40 )\end{matrix}$$

For odd values of the time index k, the expression in (39) is multiplied by −1. For K₀ much higher than 2, cᵢ≅1 for i odd and i in the range −(N−1) to (N−1) and Y(k)=[Y₁(k) Y₂(k) . . . Y_{N}(k)]^{T} may be approximated as

Y(k)=\tilde{Ψ}_{N}X(k) (41)

where \tilde{Ψ}_{N} in (41) is an N×N matrix with its (m,n) element given by

$${\tilde{Ψ}}_{N} ( m , n ) = \{ \begin{matrix}1 ; n - m = 0 \\ 0 ; n - m \neq 0 and ( n - m ) even \\ 2 {jc}_{n - m} / [ π ( n - m ) ] ≅ 2 j / [ π ( n - m ) ] ; j = \sqrt{- 1} ; ( n - m ) odd\end{matrix} \qquad ( 42 )$$

From (42) the \tilde{Ψ}_{N} is an Hermitian symmetric Toeplitz matrix.

In various embodiments of the invention comprised of the band limiting filter in the OFDM transmitter 100 of FIG. 2 with a frequency response H_{T}(f) and a band limiting filter in the RF to complex baseband converter block 315 in the OFDM receiver 300 of FIG. 3 with a frequency response H_{R}(f), the filtering effect of the band limiting filters may be compensated for by replacing the matrix \tilde{Ψ}_{N} by a modified matrix \tilde{Ψ}_{N}^{m} given by

\tilde{Ψ}_{N}^{m}=\tilde{Ψ}_{N}H_{F} (43a)

In (43a) H_{F} is a diagonal matrix with the mm diagonal element given by

H_{F}(m,m)=H_{b}(mΔf);H_{b}(f)=H_{T}(f)H_{R}(f);m=1,2, . . . N (43b)

In various embodiments of the invention wherein both the band limiting filters in the OFDM transmitter and receiver are square root raised cosine filters with roll off factor α,

H_{b}(f)=H_{rc}(f−B₀);B₀=MΔf=1/(2Tₛ) (44a)

With H_{rc}(f) given by

$${H}_{rc} ( f ) = \{ \begin{matrix}1 ; \vert f \vert \leq ( 1 - α ) {B}_{0} \\ 0.5 \{ 1 + cos [ π \frac{\vert f \vert - ( 1 - α ) {B}_{0}}{2 α {B}_{0}} ] \} ( 1 - α ) {B}_{0} < \vert f \vert \leq ( 1 + α ) {B}_{0} ; \\ 0 ; \vert f \vert > ( 1 + α ) {B}_{0}\end{matrix} \qquad ( 44 b )$$

For relatively large value of K₀, the averaging operation in the integrate and dump 346m may be replaced by integration with the noise component ηₘ(k) of the output Zₘ(k) in (36) given by

$${η}_{m} ( k ) = \frac{1}{{T}_{0}} {\int }_{{kT}_{0}}^{( k + 1 ) {T}_{0}} {n}_{b} ( t ) exp [ - j 2 π {f}_{m} t ] dt ; {f}_{m} = ( m - 1 ) Δ f ; \\ Δ f = \frac{1}{2 {T}_{0}} \qquad ( 45 )$$

From (45) the cross covariance between ηₘ(k) and ηₗ(k) for m≠l is given by

$$E [ {η}_{m} ( k ) ] {η}_{\vert}^{*} ( k ) ] = \frac{1}{{T}_{0}^{2}} {\int }_{t = 0}^{{T}_{0}} {\int }_{τ = 0}^{{T}_{0}} E [ {n}_{b} ( t ) {n}_{b}^{*} ( τ ) ] exp ( - j 2 π {f}_{m} t ) exp ( j 2 π {f}_{\vert} τ ) dtd τ \qquad ( 46 )$$

The expression on the right hand side of (46) may be simplified resulting in

$$E [ {η}_{m} ( k ) ] {η}_{\vert}^{*} ( k ) ] = \frac{1}{{T}_{0}^{2}} {\int }_{ϛ = 0}^{{T}_{0}} {\int }_{ϛ = t}^{t - {T}_{0}} {R}_{n} ( ϛ ) exp ( - j 2 π ( {f}_{m} - {f}_{\vert} ) t ] exp ( - j 2 π {f}_{\vert} ϛ ) dtd ϛ \qquad ( 47 )$$

In (47) Rₙ( ) is the autocorrelation function of the noise n_{b}(t). Changing the order of integration in (47) results in

$$\begin{matrix}E [ {η}_{m} ( k ) ] {η}_{\vert}^{*} ( k ) ] = \frac{1}{{T}_{0}^{2}} {\int }_{ϛ = 0}^{{T}_{0}} {R}_{n} ( ϛ ) exp ( - j 2 π {f}_{\vert} ϛ ) {\int }_{t = ϛ}^{{T}_{0}} exp [ - j 2 π ( {f}_{m} - {f}_{\vert} ) t ] dtd ϛ + \frac{1}{{T}_{0}^{2}} {\int }_{- {T}_{0}}^{0} {R}_{n} ( ϛ ) exp ( - j 2 π {f}_{\vert} ϛ ) {\int }_{t = 0}^{ϛ + {T}_{0}} exp [ - j 2 π ( {f}_{m} - {f}_{\vert} ) t ] dtd ϛ & ( 48 ) \\ E [ {η}_{m} ( k ) ] {η}_{\vert}^{*} ( k ) ] = \frac{1}{j 2 π {f}_{d} {T}_{0}^{2}} {\int }_{ϛ = 0}^{{T}_{0}} {R}_{n} ( ϛ ) exp ( - j 2 π {f}_{\vert} ϛ ) [ exp [ j 2 π {f}_{d} {T}_{0} ] - exp [ j 2 π {f}_{d} ( ϛ ) ] d ϛ + \frac{1}{j 2 π {f}_{d} {T}_{0}^{2}} {\int }_{ϛ = - {T}_{0}}^{ 0} {R}_{n} ( ϛ ) exp ( - j 2 {πf}_{\vert} ϛ ) [ exp [ j 2 π {f}_{d} ( ϛ + {T}_{0} ) ] - 1 ] d ϛ ; \\ {f}_{d} = {f}_{1} - {f}_{m} & ( 49 )\end{matrix}$$

For the case when f_{d}T₀ is an integer, the expression on the right hand side of equation (49) may be simplified resulting in

$$E [ {η}_{m} ( k ) ] {η}_{\vert}^{*} ( k ) ] = \frac{1}{j π ( \vert - m ) {T}_{0}} {\int }_{ϛ = 0}^{{T}_{0}} {R}_{n} ( ϛ ) exp ( - j 2 π {f}_{\vert} ϛ ) [ 1 - exp [ j 2 π {f}_{d} ϛ ] d ϛ + \frac{1}{j π ( \vert - m ) {T}_{0}} {\int }_{ϛ = - {T}_{0}}^{ 0} {R}_{n} ( ϛ ) exp ( - j 2 {πf}_{\vert} ϛ ) [ exp ( j 2 π {f}_{d} ϛ ) - 1 ] d ϛ \qquad ( 50 )$$

Replacing ζ by −ζ in the second integral in (50), and in view of the fact that Rₙ(ζ) is a real even function of ζ, the two integral terms in (50) may be combined resulting in

$$\begin{matrix}E [ {η}_{m} ( k ) ] {η}_{\vert}^{*} ( k ) ] = \frac{- 2}{π ( \vert - m ) {T}_{0}} {\int }_{ϛ = 0}^{{T}_{0}} {R}_{n} ( ϛ ) [ sin ( 2 π {f}_{\vert} ϛ ) - sin ( 2 π {f}_{m} ϛ ) ] d ϛ & ( 52 ) \\ E [ {η}_{m} ( k ) ] {η}_{\vert}^{*} ( k ) ] = \frac{2}{π ( \vert - m )} \frac{{ℜ}_{0}}{{T}_{0}} ɛ ( m , \vert ) & ( 53 )\end{matrix}$$

In (53) ε(m,l) is 0 for the case of white noise and is relatively insignificant in magnitude compared to 1 for the case of band limited noise. For example, for M=256, (l−m)=5, and m in the range of about −100 to +100, e(l, m)≅−0.01.

For the case when 2f_{d}T₀ is an odd integer, the expression on the right hand side of equation (49) may be simplified resulting in

$$E [ {η}_{m} ( k ) ] {η}_{\vert}^{*} ( k ) ] = \frac{- 1}{( j 2 π {f}_{d} {T}_{0}^{2} )} {\int }_{ϛ = - {T}_{0}}^{ {T}_{0}} {R}_{n} ( ϛ ) exp ( - j 2 π {f}_{\vert} ϛ ) [ 1 + exp ( j 2 {πf}_{d} ϛ ) ] d ϛ \qquad ( 54 )$$

In (54) the noise correlation function is nearly zero outside the interval of integration and the application of Wiener Khintchine theorem results in

$$E [ {η}_{m} ( k ) ] {η}_{\vert}^{*} ( k ) ] = \frac{2 j}{π ( \vert - m )} \frac{1}{2 {T}_{0}} [ {𝒫}_{n} ( {f}_{\vert} ) + {𝒫}_{n} ( {f}_{m} ) ] ; ( \vert - m ) odd \qquad ( 55 )$$

where in (55) [symbol] ₙ(f) denotes the noise power spectral density of the noise n_{b}(t).

For the case of band limited white noise, one obtains

$$E [ {η}_{m} ( k ) ] {η}_{\vert}^{*} ( k ) ] = \frac{2 j}{π ( \vert - m )} \frac{{ℜ}_{0}}{{T}_{0}} ; ( \vert - m ) odd \qquad ( 56 )$$

For the case of m=l it follows from (48) that

$$E [ {\vert {η}_{l} ( k ) \vert}^{2} ] = \frac{1}{{T}_{0}} {\int }_{ϛ = - {T}_{0}}^{{T}_{0}} {R}_{n} ( ϛ ) exp ( - j 2 π {f}_{l} ϛ ) [ 1 - \vert ϛ \vert / {T}_{0} ] d ϛ \qquad ( 57 )$$

In (57) the noise correlation function is nearly zero outside the interval of integration (−T₀, T₀) and the limits of integration may be extended to (−∞, ∞) resulting in

$$E [ {\vert {η}_{l} ( k ) \vert}^{2} ] = \frac{{P}_{n} ( {f}_{l} )}{{T}_{0}} = \frac{{0}_{}}{{T}_{0}} \qquad ( 58 )$$

In (58), the second equality is for the case of band limited white noise.

From (53), (56) and (58) the noise covariance matrix R_{η} of the noise vector η(k)=[η₁(k) η₂(k) . . . η_{N}(k)]^{T} for the case of band limited white noise n_{b}(t) may be approximated by

$${R}_{η} ( m , l ) = \{ \begin{matrix}{0}_{} / {T}_{0} ; m - l = 0 \\ 0 ; m - l \neq 0 and ( m - l ) even \\ \{ 2 j / [ π ( l - m ) ] \} {0}_{} / {T}_{0} ; ( m - l ) odd\end{matrix} \qquad ( 59 )$$

with the normalized noise covariance matrix of η(k) given by

\tilde{Ψ}_{N}ⁿ≡( [symbol] ₀/T₀)⁻¹R_{η} (60)

Comparison of (60) with (29) shows that for the case of band limited white noise, the normalized covariance matrix \tilde{Ψ}_{N}ⁿ=\tilde{Ψ}_{N}. For the case wherein the band limiting filter in the RF to complex baseband converter block 315 of FIG. 3, is different from the rectangular filter, for example, the square root raised cosine filter, the covariance matrix R_{η} may be modified by changing the elements (l, m) with (l−m) odd and l=m according to (55) and (58) respectively, with [symbol] ₙ(f) given by

[symbol]

ₙ(f)=|H_{R}(f)|² [symbol] ₀=H_{rc}(f−B₀) [symbol] ₀ (61)

In (61) H_{R}(f) denotes the frequency response of the band limiting filter in the RF to complex baseband converter block 315 of FIG. 3.

Referring to FIG. 3, the received symbol vector 352 Z(k) comprised of elements Zₘ(k) given by (4) is inputted to the vector splitter 355. The vector splitter 355 splits the vector 352 Z(k) into a first received symbol vector 356 Z^{O}(k) comprised of the elements of Z(k) with odd indices and the second received symbol vector 358 Z^{E}(k) comprised of the elements of Z(k) with even indices. Referring to FIG. 3, the vector 356 Z^{O}(k) is inputted to the inverse transform block 360 that multiplies the vector 356 Z^{O}(k) by the matrix (P^{O})⁻¹=P^{OH} wherein H denotes the Hermitian transpose and the matrix P^{O} is an orthonormal matrix. The first inverse transformed symbol vector 364 Z¹(k) at the output of the inverse transform unit 360 is inputted to the symbol detector unit 370. The second received symbol vector 358 Z^{E}(k) is inputted to the inverse transform block 362 that multiplies the vector 358 Z^{E}(k) by the matrix (P^{E})=p^{EH} wherein the matrix P^{E} is an orthonormal matrix. The second inverse transformed symbol vector 366 Z²(k) at the output of the inverse transform unit 362 is inputted to the symbol detector unit 370.

The N dimensional composite vector Z_{c}(k)=[Z^{1T}(k) Z^{2T}(k)] may be expressed as

Z_{c}(k)=Y_{c}(k)+η_{c}(k) (62)

wherein the signal component vector Y_{c}(k) may be expressed in terms of the weighted modulation symbol vector X_{w}^{d}(k) as in (63).

$$\begin{matrix}{Y}_{c} ( k ) = {P}_{c}^{H} {Ψ}_{N} P Λ {X}_{w}^{d} ( k ) = {P}_{c}^{H} {Ψ}_{N} P β {X}^{d} ( k ) ; = Λ & ( 63 a ) \\ {X}_{w}^{d} ( k ) = {[ {( {X}_{w}^{ld} ( k ) )}^{T} {( {X}_{w}^{2 d} ( k ) )}^{T} ]}^{T} & ( 63 b ) \\ {P}_{c} = [ \begin{matrix}{P}^{O} & {0}_{M} \\ {0}_{M} & {P}^{E}\end{matrix} ] & ( 63 c ) )\end{matrix}$$

The matrix Ψ_{N} in (63a) is given in (34), the matrix Λ is a diagonal matrix with the diagonal elements λᵢ's are equal to the respective channel gains for the N=2M subcarriers wherein the communication channel transmitting the OFDM signal is a frequency selective channel and [symbol] is a diagonal matrix with the diagonal elements equal to the coefficients α₁¹, . . . α_{M}¹, α₁², . . . α_{M}². The sub matrix 0_{M} in (63c) is an M×M matrix of zeros.

For band limited white noise the noise component vector η_{c}(k) in (62) has its covariance matrix given by

$$E [ {η}_{c} ( k ) {η}_{c}^{H} ( k ) ] = \frac{{0}_{}}{{T}_{0}} {P}^{H} {Ψ}_{N} P \qquad ( 64 )$$

The inverse transformed outputs 364 Z¹(k) and 366 Z²(k) may be expressed as in (65) wherein both the matrices P^{O} and P^{E} are selected equal to an orthonormal matrix P.

Z²(k)= [symbol] ₁X^{1d}(k)+P^{H}Ψ₁₂P [symbol] ₂X^{2d}(k)+η_{c}¹(k) (65a)

Z²(k)= [symbol] ₂X^{2d}(k)+P^{H}Ψ₁₂^{H}P [symbol] ₁X^{1d}(k)+η_{c}²(k) (65b)

In (65a) the matrix Ψ₁₂ is the M×M sub matrix of Ψ_{N} given by (33) and [symbol] ₁ and [symbol] ₂ are the M×M diagonal sub matrices of [symbol] . The matrices [symbol] ₁ and [symbol] ₂ are henceforth referred to as the channel gain matrices for brevity of terminology.

Referring to FIG. 3, the inverse transformed vectors 364 Z¹(k) and 366 Z²(k) are inputted to the symbol detection subsystem 370. The symbol detection subsystem 370 simultaneously detects the modulation symbols s̅_{d}_{₁}¹, . . . ,

$${\overline{s}}_{{d}_{{M}_{I}}}^{1}$$

and s̅_{d}_{₁}², . . . ,

$${\overline{s}}_{{d}_{{M}_{I}}}^{2}$$

while mitigating the mutual interference among the elements of the inverse transformed vectors 364 Z¹(k) and 366 Z²(k). Referring to FIG. 3, the symbol detector unit outputs the pilot symbols Sₚ¹, and Sₚ² that are included in the modulation symbol vectors X^{1d}(k) and X^{2d}(k) respectively at the transmitter in FIG. 1.

Referring to FIG. 3, the modulation symbols 372a through 372M_{I} s̅_{d}_{₁}¹, . . . ,

$${\overline{s}}_{{d}_{{M}_{I}}}^{1}$$

are inputted to the baseband demodulators 375a through 375 M_{I}. The modulation symbols 374a through 374M_{I} s̅_{d}_{₁}², . . . ,

$${\overline{s}}_{{d}_{{M}_{I}}}^{2}$$

are inputted to the baseband demodulators 376a through 376 M_{I}.

The baseband demodulator block 375n for n equal to 1 through M_{I} may map the detected baseband symbols s̅_{d}_{ₙ}¹ into groups of m binary digits, wherein m=log₂ ( [symbol] ) assumed to be an integer, using the inverse of the map from group of m binary digits into 1 out of [symbol] possible information baseband symbols used in the baseband modulator block 20n at the OFDM transmitter. The baseband demodulator block 375n may finally concatenate the groups of m binary digits into the serial stream 380n \hat{d}ₙ¹(k) that constitutes the detected user input data 10n dₙ¹(k) at the OFDM transmitter 100 in FIG. 1.

The baseband demodulator block 375n may perform operations including the error correction decoding, de interleaving, etc., constituting the inverse of the respective operations of error correction encoding, interleaving etc., when the baseband modulator block 20n includes such operations.

In a likewise manner the baseband demodulator block 376n for n equal to 1 through Mi may map the detected baseband symbols s̅_{d}_{ₙ}² into groups of m binary digits, wherein m=log₂ ( [symbol] ) assumed to be an integer, using the inverse of the map from group of m binary digits into 1 out of [symbol] possible information baseband symbols used in the baseband modulator block 35n at the OFDM transmitter. The baseband demodulator block 376n may finally concatenate the groups of m binary digits into the serial stream 385n \hat{d}ₙ²(k) that constitutes the detected user input data 15n dₙ²(k) at the OFDM transmitter 100 in FIG. 1.

The baseband demodulator block 376n may perform operations including the error correction decoding, de interleaving, etc., constituting the inverse of the respective operations of error correction encoding, interleaving etc., when the baseband modulator block 20n includes such operations.

In those scenarios wherein the HCOFDM receiver is located at the mobile subscriber (MS) unit, only the detected symbols s̅_{d}_{ₙ}¹ and s̅_{d}_{ₙ}² corresponding to the subcarriers allocated to that MS may be made available at the output of the symbol detection subsystem 370 under control of the base station, not shown in the FIG. 3.

From (65a), (65b), the symbol detection subsystem 370 may estimate the modulation symbol vector X^{1d}(k) iteratively as

\hat{X}_{i,a}^{1d}(k)= [symbol] ₁⁻¹[Z¹(k)−P^{H}Ψ₁₂P [symbol] ₂X̅ᵢ₋₁^{2d}(k)] (66a)

\hat{X}_{i,b}^{1d}(k)= [symbol] ₁⁻¹Q₁P^{H}Ψ₁₂P[Z²(k)− [symbol] ₂Xᵢ₋₁^{2d}(k)] (66b)

\hat{X}ᵢ^{1d}=05(\hat{X}_{i,a}^{1d}+\hat{X}_{i,b}^{1d});X̅ᵢ^{1d}=q(\hat{X}ᵢ^{1d});i=1,2, . . . (66c)

Q₁=[P^{H}Ψ₁₂Ψ₁₂^{H}P+σₙ²I]⁻¹ (66d)

In (66a)-(66c) the suffix i refers to the iteration number, X̅ᵢ₋₁^{2d}(k) refers to the detected modulation symbol vector X^{2d}(k) at the iteration number i−1, \hat{X}ᵢ^{1d} is the linear estimate of X^{1d}(k) at the i^{th} iteration, X̅ᵢ^{1d} is the detected version of X^{1d}(k) at the i^{th} iteration, q( ) denotes the detection operation, and σₙ² is an estimate of the noise variance equal to ( [symbol] ₀/T₀). The modulation symbol vector X^{2d}(k) may be similarly estimated iteratively from the following eqn. (67).

\hat{X}_{i,a}^{2d}(k)= [symbol] ₂⁻¹[Z²(k)−P^{H}Ψ₁₂^{H}P [symbol] ₁X̅ᵢ^{1d}(k)_{┘}^{┐} (67a)

\hat{X}_{i,b}^{2d}(k)= [symbol] ₂⁻¹Q₂P^{H}Ψ₁₂^{H}P[Z¹(k)− [symbol] ₁Xᵢ^{1d}(k)] (67b)

\hat{X}ᵢ^{2d}=05(\hat{X}_{i,a}^{2d}+\hat{X}_{i,b}^{2d});X̅ᵢ^{2d}=q(\hat{X}ᵢ^{2d});i=1,2, . . . (67c)

Q₂=[P^{H}Ψ₁₂^{H}Ψ₁₂P+σₙ²I]⁻¹ (67d)

Equations (66) and (67) may be solved iteratively wherein X̅₀^{2d}(k) may be selected to be some appropriate value, for example, a vector with 0 elements.

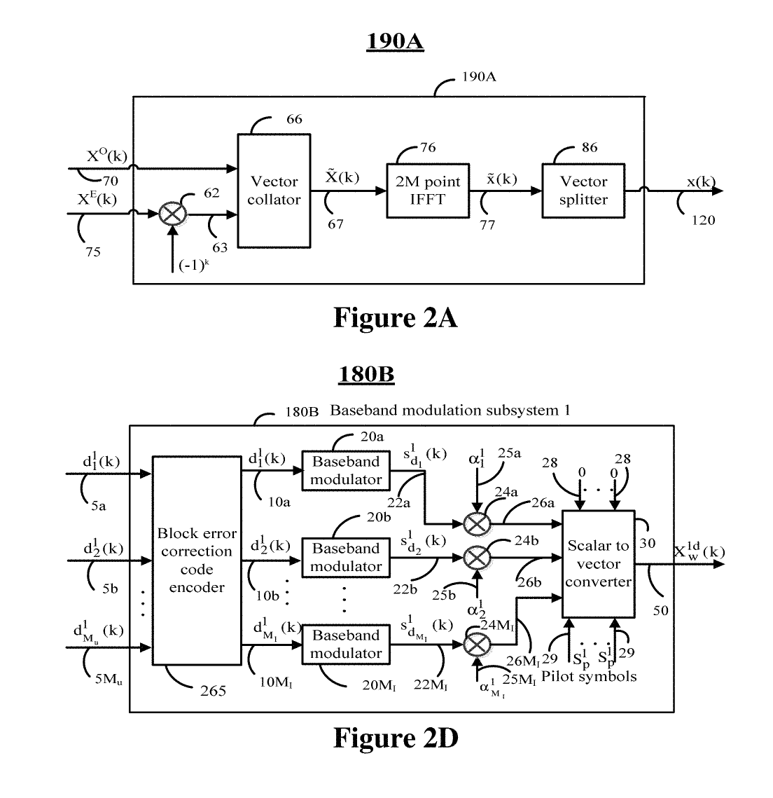

FIG. 4 shows an embodiment of the symbol detection subsystem 370 of the OFDM receiver 300 of the invention. Referring to FIG. 4, the inverse transformed vectors 364 Z¹(k) and 366 Z²(k) are inputted to the symbol estimate update subsystem 440. The subsystem 440 is inputted with the matrices 425 C₁=P^{H}Ψ₁₂P, 441 Q_{c1}=Q₁C₁, and 439 Q_{c2}=Q₂C₁.

Referring to FIG. 4, the detected modulation symbol vector 415 X̅ᵢ₋₁^{2d}(k) at the iteration (i−1) is inputted to the matrix multiplier 418. The initial estimate for X̅ᵢ₋₁^{2d}(k) at i=0 may be set to some appropriate values, for example, to an all zero vector. Referring to FIG. 4, the matrix multiplier 418 multiplies the vector 415 X̅ᵢ₋₁^{2d}(k) by the channel gain matrix [symbol] providing the output 420 [symbol] ₂X̅ᵢ₋₁^{2d}(k) to the matrix multiplier 422. The matrix multiplier 422 is inputted with the matrix C₁ for providing the product 427 C₁ [symbol] ₂ X̅ᵢ₋₁^{2d}(k) to the adder 410. Referring to FIG. 4, the adder 410 is inputted with the inverse transformed output vectors 364 Z¹(k) and subtracts the product 427 C₁ [symbol] ₂X̅ᵢ₋₁^{2d}(k) from the vector 364 Z¹(k) providing the difference 430 to the matrix multiplier 432. The matrix multiplier 432 multiplies the input 430 by the inverse channel gain matrix [symbol] ₁⁻¹ providing the first linear estimate of the first modulation symbol vector 435 \hat{X}ᵢₐ^{1d}(k) weighted by a weighting coefficient equal to 0.5 to the first input of the adder 446.

Referring to FIG. 4, the second inverse transformed vector 366 Z²(k) is inputted to the adder 436. The output 420 [symbol] ₂X̅ᵢ₋₁^{2d}(k) of the matrix multiplier 418 is subtracted from the vector 366 Z²(k) by the adder 436 providing the difference 437 to the matrix multiplier 438. The matrix multiplier 438 is inputted by the matrix 441 Q_{c1} and multiplies the difference 437 by the matrix 441 Q_{c1} providing the product 442 to the matrix multiplier 444. Referring to FIG. 4, the matrix multiplier 444 multiplies the input 442 by the inverse channel gain matrix 434 [symbol] ₁⁻¹ providing the second linear estimate of the first modulation symbol vector 445 \hat{X}_{ib}^{1d}(k) weighted by a weighting coefficient equal to 0.5 to the second input to the adder 446. The adder 446 provides the weighted linear estimate 448 \hat{X}ᵢ^{1d}(k) to the symbol detector 450.

Referring to FIG. 4, the symbol detector 450 is comprised a vector operator q( ) operating on the linear estimate of the first modulation symbol vector 448 \hat{X}ᵢ^{1d} wherein the i^{th} component operator qᵢ( ) of the operator q( ) detects the i^{th} component ŝ_{d}_{ᵢ}¹ of 448 \hat{X}ᵢ^{1d} for i equal to 1 through M_{I}. The i^{th} component operator qᵢ( ) detects the information baseband symbol s_{d}_{ᵢ}¹ on the basis of the signal constellation diagram of the baseband modulator block 20i at the OFDM transmitter 100 of FIG. 2 by mapping the linear estimate ŝ_{d}_{ᵢ}¹ into one of the points of the signal constellation diagram of the baseband modulator in the two dimensional signal space. For example, the baseband modulator may employ one of the MQAM, MPSK or MASK modulation techniques. The size of signal constellation may be, for example, equal to 16.

The detection of the information baseband symbols may be based on, for example, the maximum likelihood criteria or the minimum distance criteria in the two dimensional signal space. Referring to FIG. 4, the symbol detector 450 provides the first detected modulation symbol vector 452 X̅ᵢ^{1d} to the vector to scalar converter unit 495. Referring to FIG. 4, the first detected modulation symbol vector 452 X̅ᵢ^{1d} is inputted to the matrix multiplier 458

Referring to FIG. 4, the first detected modulation symbol vector 452 X̅ᵢ^{d}(k) at the iteration i is inputted to the matrix multiplier 458. Referring to FIG. 4, the matrix multiplier 458 pre multiplies the vector 442 X̅ᵢ^{d}(k) by the channel gain matrix 457 [symbol] ₁ providing the output 455 [symbol] ₁X̅ᵢ^{d}(k) to the matrix multiplier 459. The matrix multiplier 459 is inputted with the matrix 426 C₁^{H} for providing the product 456 C₁^{H} [symbol] ₁X̅ᵢ^{d}(k) to the adder 462. Referring to FIG. 4, the adder 462 is inputted with the second inverse transformed vector 366 Z²(k) and subtracts the product 456 C₁^{H} [symbol] ₁X̅ᵢ^{d}(k) from the vector 366 Z²(k) providing the difference 470 to the matrix multiplier 472. The matrix multiplier 472 multiplies the input 470 by the second inverse channel gain matrix [symbol] ₂⁻¹ providing the first linear estimate of the second modulation symbol vector 475 \hat{X}ᵢₐ^{2d}(k) weighted by a weighting coefficient equal to 0.5 to the first input of the adder 486.

Referring to FIG. 4, the first inverse transformed vector 364 Z¹(k) is inputted to the adder 476. The output 455 [symbol] X̅ᵢ^{d}(k) of the matrix multiplier 458 is subtracted from the vector 364 Z¹(k) by the adder 476 providing the difference 477 to the matrix multiplier 478. The matrix multiplier 478 is inputted by the matrix 439 Q_{c2} and multiplies the difference 477 by the matrix 439 Q_{c2} providing the product 482 to the matrix multiplier 484. Referring to FIG. 4, the matrix multiplier 484 multiplies the input 482 by the second inverse channel gain matrix 474 [symbol] ₂⁻¹ providing the second linear estimate of the second modulation symbol vector 485 \hat{X}_{ib}^{2d}(k) weighted by a weighting coefficient equal to 0.5 to the second input to the adder 486. The adder 486 provides the weighted linear estimate 488 \hat{X}ᵢ^{2d}(k) to the symbol detector 490.

Referring to FIG. 4, the symbol detector 490 provides the second detected modulation symbol vector 492 X̅ᵢ^{2d}(k) to the vector to scalar converter unit 495. The operation of the symbol detector 490 is similar to that of the symbol detector 452. Referring to FIG. 4, a decision unit 494 compares the iteration number i with the number of requisite iterations Nᵣ and provides a signal 496 to the unit 495 once the iteration number i is equal to Nᵣ. In various embodiments of the invention Nr may be selected equal to 2.

Referring to FIG. 3, the vector to scalar converter unit 495 provides the estimates of the modulation symbols of the first group of users 372a through M_{I} s̅_{d}_{₁}¹, . . . ,

$${\overline{s}}_{{d}_{{M}_{I}}}^{1}$$

that are elements of the first detected modulation symbol vector 452 X̅ᵢ^{1d}(k) to the baseband demodulators 375a through M_{I} of the OFDM receiver 300 of FIG. 3. The vector to scalar converter unit 495 provides the estimates of the modulation symbols of the second group of users 374a through M_{I} s̅_{d}_{₁}², . . . ,

$${\overline{s}}_{{d}_{{M}_{I}}}^{2}$$

that are elements of the second detected modulation symbol vector 492 X̅ᵢ^{2d}(k) to the baseband demodulators 376a through M_{I} of the OFDM receiver.

The estimation of the diagonal channel gain matrices [symbol] ₁ and [symbol] ₂ may be performed on the basis of the pilot symbols during the initialization phase. The known pilot symbols may be transmitted over a number of selected subcarriers and may be limited to the group 1 sub carriers. The receiver may estimate the OFDM channel gains for the pilot sub carriers on the basis of the pilot symbols. The OFDM channel gains for the subcarriers other than the pilot subcarriers may be obtained by known appropriate interpolation techniques. Alternatively, the pilot symbols may be transmitted over one or more OFDM symbols in an OFDM frame comprised of a relatively large number of OFDM symbols in all of or a relatively large number of subcarriers from which the OFDM channel gains for the subcarriers may be estimated during the OFDM symbols carrying the pilot symbols. The OFDM channel gains for the subcarriers other than the pilot subcarriers may be obtained by known appropriate interpolation techniques. During the OFDM symbols in any OFDM frame carrying the users' data the channel gains may be updated in a decision directed manner.

Replacing the modulation symbol vectors X^{1d}(k) and X^{2d}(k) by their estimates X̅^{1d}(k) and X̅^{2d}(k) respectively, (65 a, b) may be arranged in the following form

χ¹(k)≡Z¹(k)−P^{H}Ψ₁₂P [symbol] ₂X̅^{2d}(k)= [symbol] ₁X̅^{1d}(k)+ξ¹(k) (68a)

χ²(k)≡Z²(k)−P^{H}Ψ₁₂^{H}P [symbol] ₁X̅^{1d}(k)= [symbol] ₂X̅^{2d}(k)+ξ²(k) (68b)

In (68a,b) ξ¹(k) and ξ²(k) are the noise terms that are sums of the respective receiver noise terms η_{c}¹(k) and η_{c}²(k), and any error arising due to the symbol estimation errors due to the symbol estimation.

An ERLS (exponentially data weighted recursive least squares) estimates for the i^{th} components bᵢ¹ and bᵢ² of the channel gain matrices [symbol] ₁ and [symbol] ₂ respectively for i in the range of 1 to M may be obtained as

\hat{b}ᵢ¹(k)=\hat{b}ᵢ¹(k−1)+pᵢ¹(k)s̅_{di}¹*(k)(χᵢ¹(k)−s̅_{di}¹(k)\hat{b}ᵢ¹(k−1)) (69a)

pᵢ¹(k)=pᵢ¹(k−1)/(λ+s̅_{di}¹(k)pᵢ¹(k−1)s̅_{di}¹*(k));i=1,2, . . . ,M;k=1,2, . . . (69b)

\hat{b}ᵢ²(k)=\hat{b}ᵢ²(k−1)+pᵢ²(k)s̅_{di}²*(k)(χᵢ²(k)−s̅_{di}²(k)\hat{b}ᵢ²(k−1)) (70a)

pᵢ²(k)=pᵢ²(k−1)/(λ+s̅_{di}²(k)pᵢ²(k−1)s̅_{di}²*(k));i=1,2, . . . ,M;k=1,2, . . . (70b)

In (69) and (70) s̅_{di}¹(k) and s̅_{di}²(k) are the estimates of the modulation symbols s_{di}¹(k) and s_{di}²(k) respectively and λ is the exponential data weighting factor with 0<λ<1. In the estimation equations (69) and (70) λ may be selected between 0.992 and 0.995 depending upon the channel fading time constants. In (69) pᵢ¹(k) provides an estimate of the error variance in the estimate of the gain bᵢ¹. The initial estimate \hat{b}ᵢ¹(0) may be provided by the pilot symbols whereas the initial value pᵢ¹(0) may be set equal to an estimate of or an upper bound on the error variance in the estimate \hat{b}ᵢ¹(0) provided by the pilot symbols. Similar estimates may be obtained for \hat{b}ᵢ²(0) and pᵢ²(0) in (70). Estimates obtained from the pilot symbols over the subsequent intervals may be combined with the estimates in (69)-(70) using well known maximal ratio combining method.

Referring to FIG. 4, the channel gain matrices [symbol] ₁ and [symbol] ₂ and their inverses in FIG. 4 may be replaced by their respective estimates given recursively by (69)-(70). In turn the modulation symbol estimates 372 s̅_{d}_{₁}¹, . . . ,

$${\overline{s}}_{{d}_{{M}_{I}}}^{1}$$

and 374 s̅_{d}_{₁}², . . . ,

$${\overline{s}}_{{d}_{{M}_{I}}}^{2}$$

are provided to the channel gain estimation algorithm (69)-(70) in a decision directed manner.

During the OFDM symbols in any OFDM frame not carrying any pilot symbols M_{I} may be equal to M.

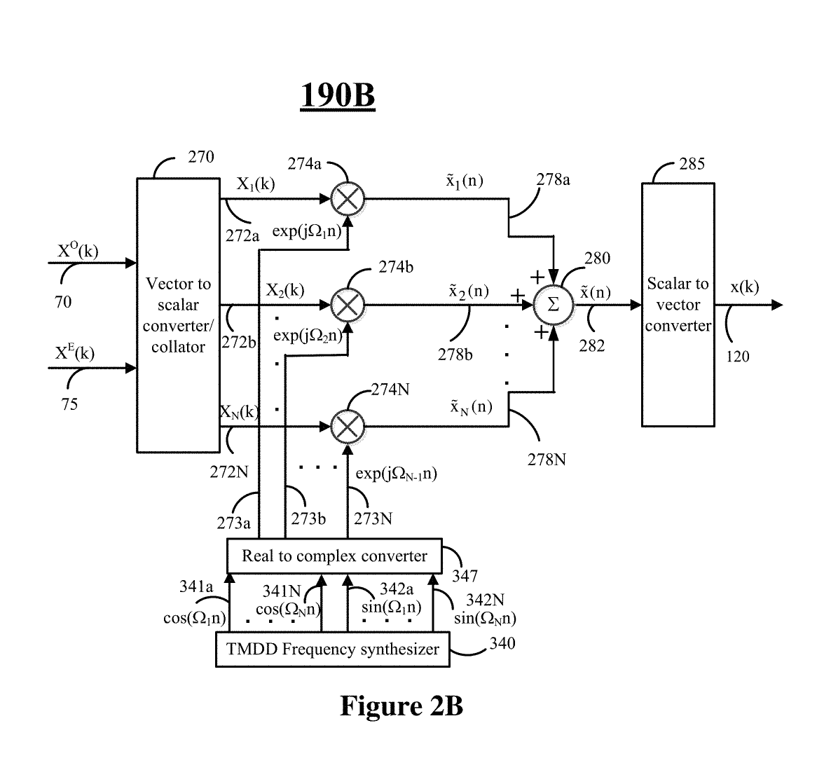

FIG. 5A shows an alternative embodiment of the symbol detection subsystem 370A of the OFDM receiver 300 for receiving the OFDM signal from the the transmitter 100 in FIG. 2 wherein the baseband modulation subsystem 180B shown in FIG. 2D includes a block error correction code encoder 250.

Referring to FIG. 5A, the first and second inverse transformed output vectors 364 Z¹(k) and 366 Z²(k) are inputted to the symbol estimates update subsystem 440 detailed in FIG. 4. Referring to Figure SA, the matrices C₁, Q_{c1}, and Q_{c2} are inputted to the inputs 425, 441, and 439 respectively of the symbol estimates update subsystem 440. Referring to FIG. 5A, the symbol estimates update subsystem 440 provides an intermediate detected version of the first modulation symbol vector \hat{X}ᵢ^{1d}(k) at the output 452a and an intermediate detected version of the second modulation symbol vector \hat{X}ᵢ^{2d}(k) at the output 492a of the unit 440 at the i^{th} iteration.

Referring to FIG. 5A, the intermediate detected version of the first modulation symbol vector 452a \hat{X}ᵢ^{1d}(k) is inputted to the symbol error correction subsystem 460a for mitigating any errors incurred in the intermediate detected first modulation symbol vector 452a \hat{X}ᵢ^{1d}(k) on the basis of the block error correction code employed in unit 250 of the baseband modulation subsystem 180B in FIG. 2D.

Referring to FIG. 5A, the intermediate detected version of the first modulation symbol vector 452a \hat{X}ᵢ^{1d}(k) is inputted to the symbol to bit stream converter unit 401. The unit 401 extracts the pilot symbols 408a and the zeros 408b that are not included in the error correction code employed at the OFDM transmitter 100. The unit 401 maps each of the information modulation symbols that constitute the M_{I} elements of the vector 452a \hat{X}ᵢ^{1d}(k) into a group of m=log₂ [symbol] binary bits and converts the group of binary bits into a serial stream where [symbol] is the order of modulation employed in the baseband modulators 20a through M_{I} at the OFDM transmitter.

In various embodiments of the invention the order of modulation used by different baseband modulators 20a through Mᵢ may be a different such that the number of bits per modulation symbol m=log₂( [symbol] ) for different elements of the modulation symbol vector is an integer multiple of a common integer m₀. In this case different elements of the vector 452a \hat{X}ᵢ^{1d}(k) may result in a multiplicity (m/m₀) of bit streams of length m₀ in each of the OFDM symbol duration.

Referring to FIG. 5A, the estimated code bits 402a through ĉ_{i,1}¹, . . . , ĉ_{i,M}_{_{I}}¹ in the i^{th} iteration at the output of the symbol to bit stream converter unit 401 are inputted to the error correction code decoder 403. The error correction code decoder 403 corrects any errors in the user data bits within the capability of the error correction code and provides the error corrected user data bits 404a through 404Mᵤ \hat{d}_{i,1}¹, . . . , \hat{d}_{i,M}_{ᵤ}¹ to the error correction code encoder 405. The error correction code encoder 405 generates the error corrected code bits 406a through M_{I} c̅_{i,1}¹, . . . , c̅_{i,M}_{_{I}}¹ that are inputted to the bit stream to symbols converter unit 407.

Referring to FIG. 5A, The pilot symbols 408a and any zeros 408b extracted for the symbol to bit streams converter that may be present in the transmitted modulation symbol vector X^{1d}(k) are inputted to the unit 407, not shown in the Figure. The bit stream to symbols converter unit 407 collects m groups of error corrected code bits 406a through M_{I} c̅_{i,1}¹, . . . , c̅_{i,M}_{_{I}}¹ and maps them into M_{I} modulation symbols comprising the M_{I} elements of the error corrected detected first modulation symbol vector 452 X̅ᵢ^{1d}(k) using the inverse of the binary bits to modulation symbol maps that are employed in the baseband modulators 20a through M_{I} at the transmitter 100 of the invention and appends the vector 452 with (M−M_{I}) pilot and zero symbols.

Referring to FIG. 5A, the error corrected detected first modulation symbol vector 452 X̅ᵢ^{1d}(k) is provided to the input 452 of the symbol estimates update subsystem 440.

Referring to FIG. 5A, the intermediate detected version of the second modulation symbol vector 492a \hat{X}ᵢ^{2d}(k) is inputted to the symbol error correction subsystem 460b for mitigating any errors incurred in the intermediate detected first modulation symbol vector 492a \hat{X}ᵢ^{2d}(k) on the basis of the block error correction code employed in unit 250 of the baseband modulation subsystem 180B in FIG. 2D. The unit 460b operates in a manner similar to the unit 460a and provides an error corrected detected second modulation symbol vector 492 X̅ᵢ^{2d}(k) at the output.

Referring to FIG. 5A, the error corrected detected second modulation symbol vector 492 X̅ᵢ^{2d}(k) is delayed by the delay unit 453 with the delayed error corrected detected second modulation symbol vector 415 X̅ᵢ₋₁^{2d}(k) provided to the input 415 of the symbol estimates update subsystem 440.

Referring to FIG. 5A, the symbol error correction subsystem 460a provides the error corrected detected first modulation symbol vector 452 X̅ᵢ^{1d}(k) to the vector to serial converter 495. The symbol error correction subsystem 460b provides the error corrected detected second modulation symbol vector 492 X̅ᵢ^{2d}(k) to the vector to serial converter 495.

Referring to FIG. 5A, a decision unit 494 compares the iteration number i with the number of requisite iterations Nᵣ and provides a signal 496 to the unit 495 once the iteration number i is equal to Nᵣ. At the receipt of the affirmative signal 496, the vector to scalar converter unit 495 provides the estimates of the modulation symbols of the first group of users 372a through M_{I} s̅d₁¹, . . . ,

$${\overline{s}}_{{d}_{{M}_{I}}}^{1}$$

that are elements of the first error corrected detected modulation symbol vector 452 X̅ᵢ^{1d}(k) to the baseband demodulators 375a through M_{I} of the OFDM receiver 300 of FIG. 3. The vector to scalar converter unit 495 provides the estimates of the modulation symbols of the second group of users 374a through M_{I} s̅d₁², . . . ,

$${\overline{s}}_{{d}_{{M}_{I}}}^{2}$$

that are elements of the second error corrected detected modulation symbol vector 492 X̅ᵢ^{2d}(k) to the baseband demodulators 376a through M_{I} of the OFDM receiver 300.

In various embodiments of the invention employing, for example, MQAM modulation technique, the real and imaginary parts of the modulation symbol may be detected independently. Taking the real part on both sides of (65a) and the imaginary part on both sides of (65b) results in equations (71a) and (71b).

Z_{R}¹(k)= [symbol] ₁X^{1R}(k)+P^{H}Φ₁₂P [symbol] ₂X^{2I}(k)+η_{R}¹(k);Φ₁₂=jΨ₁₂;j=\sqrt{−1} (71a)

Z_{I}²(k)= [symbol] ₂X^{2I}(k)+P^{H}Φ₁₂^{H}P [symbol] ₁X^{1R}(k)+η_{I}²(k) (71b)

In (71a, b) the subscripts and superscripts R and I on any entity denote the real and imaginary part respectively of the entity. In (71) the matrix P may be selected to be a real orthonormal matrix and the diagonal matrices [symbol] ₁ and [symbol] ₂ are real. From (71) the real and imaginary parts of X¹(k) and X²(k) respectively may be estimated iteratively as

\hat{X}_{i,a}^{1R}(k)= [symbol] ₁⁻¹[Z_{R}¹(k)−C₂ [symbol] ₂X̅ᵢ₋₁^{2I}(k)];C₂=P^{H}Φ₁₂P (72a)

\hat{X}_{i,b}^{1R}(k)= [symbol] ₁⁻¹Q_{c}_{₃}[Z_{I}²(k)− [symbol] ₂X̅ᵢ₋₁^{2I}(k)];Q_{c}_{₃}=Q₃C₂ (72b)

\hat{X}ᵢ^{1R}=05(\hat{X}_{i,a}^{1R}+\hat{X}_{i,b}^{1R});X̅ᵢ^{1R}=q(\hat{X}ᵢ^{1R});i=1,2, . . . (72c)

Q₃=[P^{H}Φ₁₂Φ₁₂^{H}P+(σₙ²/2)I]⁻¹ (72d)

\hat{X}_{i,a}^{2I}(k)= [symbol] ₂⁻¹[Z_{I}²(k)−C^{H} [symbol] ₁X̅ᵢ^{1R}(k)] (73a)

\hat{X}_{i,b}^{2I}(k)= [symbol] ₂⁻¹Q_{c}_{₄}[Z_{R}¹(k)− [symbol] ₁X̅ᵢ^{1R}(k)];Q_{c}_{₄}=Q₄C₂^{H} (73b)

\hat{X}ᵢ^{2I}=05(\hat{X}_{i,a}^{2I}+\hat{X}_{i,b}^{2I});X̅ᵢ^{2I}=q(\hat{X}ᵢ^{2I});i=1,2, . . . (73c)

Q₄=[P^{H}Φ₁₂^{H}Φ₁₂P+(σₙ²/2)I]⁻¹ (73d)

Taking the imaginary part on both sides of (65a) and the real part on both sides of (65b) results in equations (74a) and (74b).

Z_{I}¹(k)= [symbol] ₁X^{1I}(k)−C₂ [symbol] ₂X^{2R}(k)+η_{I}¹(k) (74a)

Z_{R}²(k)= [symbol] ₂X^{2R}(k)−C₂^{H} [symbol] ₁X^{1I}(k)+η_{R}²(k) (74b)

From (74) the imaginary and real parts of X¹(k) and X²(k) respectively may be estimated from (75)-(76).

\hat{X}_{i,a}^{1I}(k)= [symbol] ₁⁻¹[Z_{I}¹(k)+C₂ [symbol] ₂X̅ᵢ₋₁^{2R}(k)] (75a)

\hat{X}_{i,b}^{1I}(k)= [symbol] ₁⁻¹Q_{c}_{₃}[Z_{R}²(k)− [symbol] ₂X̅ᵢ₋₁^{2R}(k)] (75b)

\hat{X}ᵢ^{1I}=05(\hat{X}_{i,a}^{1I}+\hat{X}_{i,b}^{1I});X̅ᵢ^{1I}=q(\hat{X}ᵢ^{1I});i=1,2, . . . (75c)

\hat{X}_{i,a}^{2R}(k)= [symbol] ₂⁻¹[Z_{R}²(k)−C₂^{H} [symbol] ₁X̅ᵢ^{1I}(k)_{┘}^{┐} (76a)

\hat{X}_{i,b}^{2R}(k)= [symbol] ₂⁻¹Q_{c}_{₄}[Z¹(k)− [symbol] ₁X̅ᵢ^{1I}(k)] (76b)

\hat{X}ᵢ^{2R}=05(\hat{X}_{i,a}^{2R}+\hat{X}_{i,b}^{2R});X̅ᵢ^{2R}=q(\hat{X}ᵢ^{2R});i=1,2, . . . (76c)

In (72)-(76) i denotes the iteration number.

FIG. 5B shows one of the various embodiments of the symbol detection subsystem 370B of the OFDM transmitter 300 of the invention. Referring to FIG. 5B, the first and second inverse transformed output vectors 364 Z¹(k) and 366 Z²(k) are inputted to the complex to real converters 510 and 515 respectively. The complex to real converters 510 provides the real and imaginary parts 512 Z_{R}¹(k) and 514 Z_{I}¹(k) respectively at the output. The complex to real converters 515 provides the real and imaginary parts 516 Z_{R}²(k) and 518 Z_{I}²(k) respectively at the output of 515.

Referring to FIG. 5B, the real part 512 Z_{R}¹(k) and the imaginary part 518 Z_{I}²(k) are inputted to the symbol estimates update subsystem 440a. Referring to FIG. 5B, the matrices C₂, Q_{c3}, and Q_{c4} are inputted at the inputs 425a, 441a, and 439a respectively of the symbol estimates update subsystem 440a. Referring to Figure SB, the symbol estimates update subsystem 440a provides an intermediate detected real part of the first modulation symbol vector \hat{X}ᵢ^{1R}(k) at the output 522 and an intermediate detected imaginary part of the second modulation symbol vector \hat{X}ᵢ^{2I}(k) at the output 524 of the unit 440a at the i^{th} iteration.

Referring to Figure SB, the intermediate detected version of the real part of the first modulation symbol vector 522 \hat{X}ᵢ^{1R}(k) is inputted to the symbol error correction unit 460a. The operation of the symbol error correction unit 460a is similar to that of the unit 460a in FIG. 5A. The symbol error correction unit 460a mitigates any errors incurred in the intermediate detected real party of the first modulation symbol vector 522 \hat{X}ᵢ^{1R}(k) on the basis of the block error correction code employed in unit 250 of the baseband modulation subsystem 180B in FIG. 2D. Referring to FIG. 5B, the error corrected detected real party of the first modulation symbol vector 526 X̅ᵢ^{1R}(k) is inputted to the real to complex converter 561.

Referring to FIG. 5B, the intermediate detected imaginary part of the second modulation symbol vector 524 \hat{X}ᵢ^{2I}(k) is inputted to the symbol error correction unit 460b. The symbol error correction unit 460b mitigates any errors incurred in the intermediate detected imaginary part of the second modulation symbol vector 524 \hat{X}ᵢ^{2I}(k) and provides the error corrected detected imaginary party of the second modulation symbol vector 528 X̅ᵢ^{2I}(k) to the real to complex converter 562.

Referring to Figure SB, error corrected detected real party of the first modulation symbol vector 526 X̅ᵢ^{1R}(k) and the delayed version of the error corrected detected imaginary party of the second modulation symbol vector 532 X̅ᵢ₋₁^{2I}(k) are fed back to the symbol estimates update subsystem 440a for the next iteration of the symbol estimation.

Referring to FIG. 5B, the imaginary part 514 Z_{I}¹(k) and the real part 516 Z_{R}²(k) are inputted to the symbol estimates update subsystem 440b. Referring to FIG. 5B, the matrices −C₂, −Q_{c3}, and −Q_{c4} are inputted at the inputs 425b, 441b, and 439b respectively of the symbol estimates update subsystem 440b. Referring to FIG. 5B, the symbol estimates update subsystem 440b provides an intermediate detected imaginary part of the first modulation symbol vector \hat{X}ᵢ^{1I}(k) at the output 535 and an intermediate detected real part of the second modulation symbol vector \hat{X}ᵢ^{2R}(k) at the output 536 of the unit 440b at the i^{th} iteration.

Referring to FIG. 4 showing an embodiment of the symbol estimates update subsystem, the symbol detectors in the symbol estimates update subsystems 440a and 440b may be comprised of a vector operator q( ) wherein the n^{th} component qₙ( ) of the vector operator q( ) may be comprised of a quantizer operating on the n^{th} component of the input to the symbol detector.

In various embodiments of the invention wherein the baseband modulator 20n in the OFDM transmitter 100 of FIG. 2 employs MQAM modulation techniques with the order of modulation [symbol] with [symbol] =2^{m} for an integer values m, the quantizer may have [symbol] = [symbol] number of threshold levels given by ±V_{Ti}=±2iA; i=0, 1, . . . , ( [symbol] /2−1) with A equal to some positive constant. For the MQAM modulation both the real and imaginary parts of the modulation symbol may take values ±V_{Li}=±(2i−1)A; i=1, . . . , [symbol] /2. The function qᵢ(x) for any real x may be given by

$$\begin{matrix}{q}_{n} ( x ) = {V}_{Li} sgn ( x ) ; {V}_{Ti - 1} \leq \vert x \vert < {V}_{Ti} ; & ( 77 a ) \\ sgn ( x ) = \{ \begin{matrix}1 ; x > 0 \\ - 1 ; x \leq 0\end{matrix} & ( 77 b )\end{matrix}$$

For the QPSK modulation the quantizer reduces to the sgn(x) function given by (77b).

Referring to FIG. 5B, the intermediate detected imaginary part of the first modulation symbol vector 535 \hat{X}ᵢ^{1I}(k) is inputted to the symbol error correction unit 460c. The symbol error correction unit 460c mitigates any errors incurred in the intermediate detected imaginary part of the first modulation symbol vector 535 \hat{X}ᵢ^{1I}(k) and provides the error corrected detected imaginary party of the first modulation symbol vector 542 X̅ᵢ^{1I}(k) to the real to complex converter 561. In a like manner the symbol error correction unit 460d inputted with the intermediate detected real part of the second modulation symbol vector 536 \hat{X}ᵢ^{2R}(k) provides the error corrected detected real part of the second modulation symbol vector 544 X̅ᵢ^{2R}(k) to the real to complex converter 562.

Referring to FIG. 5B, error corrected detected imaginary party of the first modulation symbol vector 526 X̅ᵢ^{1I}(k) and the delayed version of the error corrected detected real party of the second modulation symbol vector 546 X̅ᵢ₋₁^{2R}(k) are fed back to the symbol estimates update subsystem 440b for the next iteration of the symbol estimation.

Referring to FIG. 5B, the real to complex converter 561 converts the real part 526 X̅ᵢ^{1R}(k) and the imaginary part 528 X̅ᵢ^{1I}(k) into the detected symbol vector 452 X̅ᵢ^{1d}(k) at iteration i. The detected symbol vector 452 X̅ᵢ^{1d}(k) is inputted to the vector to scalar converter unit 495. In a likewise manner the real to complex converter 562 converts the real part 544 X̅ᵢ^{2R}(k) and the imaginary part 528 X̅ᵢ^{2I}(k) into the detected symbol vector 492 X̅ᵢ^{2d}(k) at iteration i. The detected symbol vector 492 X̅ᵢ^{2d}(k) is inputted to the vector to scalar converter unit 495.

Referring to FIG. 5B, a decision unit 494 compares the iteration number i with the number of requisite iterations Nᵣ and provides a signal 496 to the unit 495 once the iteration number i is equal to Nᵣ. The vector to scalar converter unit 495 provides the estimates of the modulation symbols of the first group of users 372a through M_{I} s̅_{d}_{₁}¹, . . . ,

$${\overline{s}}_{{d}_{{M}_{I}}}^{1}$$

that are elements of the first detected modulation symbol vector 452 X̅ᵢ^{1d}(k) to the baseband demodulators 375a through M_{I} of the OFDM receiver 300 of FIG. 3. The vector to scalar converter unit 495 provides the estimates of the modulation symbols of the second group of users 374a through M_{I} s̅_{d}_{₁}², . . . ,

$${\overline{s}}_{{d}_{{M}_{I}}}^{2}$$

that are elements of the second detected modulation symbol vector 492 X̅ᵢ^{2d}(k) to the baseband demodulators 376a through M_{I} of the OFDM receiver.

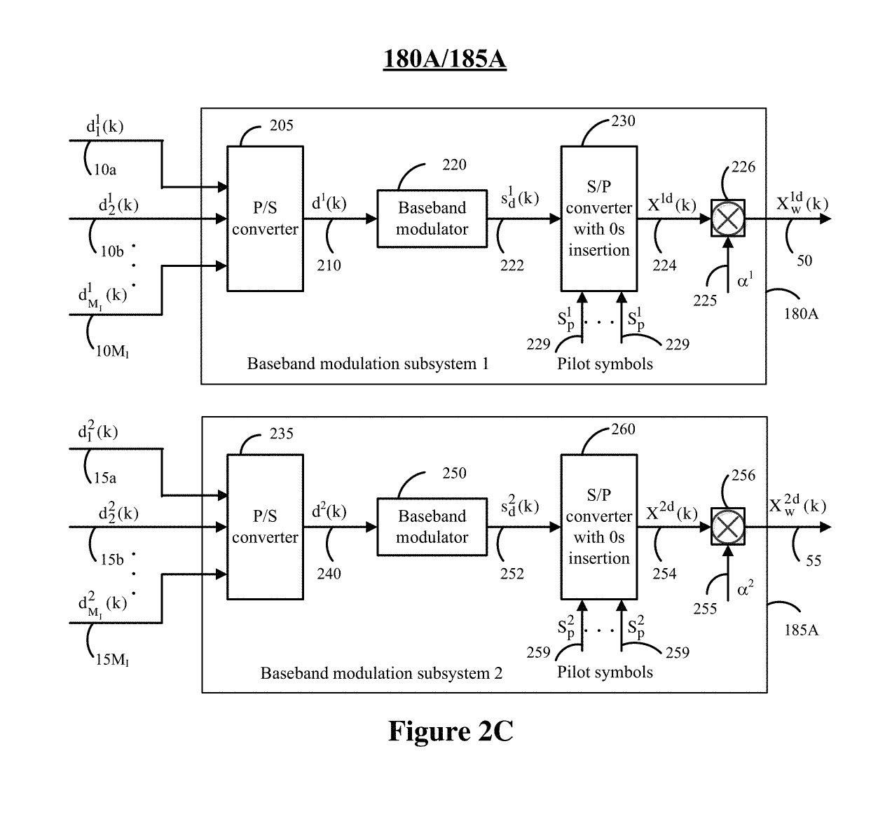

In various embodiments of the invention, the multicarrier demodulator 385 in FIG. 3 may be implemented via the FFT operation. FIG. 6 shows an embodiment of the multicarrier demodulator 385B based on the FFT operation. Referring to FIG. 6, the received serial OFDM signal 330 hₛ(n), sampled at a rate of N₀/T₀=K₀M/T₀ samples per sec., is inputted to the serial to parallel converter 610 that arranges the consecutive N₀ samples of hₛ(n) in to the received signal vector 615 z(k) of dimension N₀=K₀M with the even integer K₀ selected to be greater than or equal to 2, preferably much higher than 2, with the n^{th} element of the vector 615 zₙ(k) given by

zₙ(k)=hₛ[(k−1)N₀+n];n=1,2, . . . ,N₀;k=1,2, . . . (78)

The received signal vector z(k) is composed of the signal vector y(k) and the noise vector n̅_{b}(k), comprised of the No samples of the baseband noise n_{b}(k), with

z(k)=y(k)+n̅_{b}(k) (79)

Following (25), (26) and replacing N by 2N₀, the signal component yₙ(k) may be written in terms of the components of the modified transformed symbol vector \tilde{X}(k) as in (80)-(81).

$$\begin{matrix}{y}_{n} ( k ) = {\sum }_{m = 1}^{N} {\tilde{X}}_{m} ( k ) exp [ j π ( m - 1 ) ( n - 1 ) / {N}_{0} ] ; n = 1 , 2 , … , {N}_{0} & ( 80 ) \\ = {\sum }_{m = 1 \\ m \text{:} odd}^{N} {\tilde{X}}_{m} ( k ) exp [ j π ( m - 1 ) ( n - 1 ) / {N}_{0} ] + & \\ {\sum }_{m = 1 \\ m \text{:} even}^{N} {\tilde{X}}_{m} ( k ) exp [ j π ( m - 1 ) ( n - 1 ) / {N}_{0} ] & ( 81 )\end{matrix}$$

With the substitution of m=(2l+1) in the first summation and m=(2l+2) in the second summation in (81), yₙ(k) may be written as

$$\begin{matrix}{y}_{n} ( k ) = {y}_{n}^{1} ( k ) + {y}_{n}^{2} ( k ) ; n = 1 , 2 , … , {N}_{0} & ( 82 a ) \\ {y}_{n}^{1} ( k ) = {\sum }_{\vert = 1}^{{N}_{0}} {\tilde{X}}_{\vert}^{O e} ( k ) exp [ j 2 π ( \vert - 1 ) ( n - 1 ) / {N}_{0} ] & ( 82 b ) \\ {y}_{n}^{2} ( k ) = {\overline{ξ}}_{n} {\sum }_{\vert = 1}^{{N}_{0}} {\tilde{X}}_{\vert}^{Ee} ( k ) exp [ j 2 π ( \vert - 1 ) ( n - 1 ) / {N}_{0} ] ; \\ {\overline{ξ}}_{n} = exp [ j π ( n - 1 ) / {N}_{0} ] ; & ( 82 c )\end{matrix}$$

In (82) the vectors \tilde{X}^{Oe}(k) and \tilde{X}^{Ee}(k) are of dimension N₀ obtained by appending (N₀−M) zeros to the vectors comprised of the elements of the vector \tilde{X}(k) with odd and even indices respectively with

\tilde{X}^{Oe}(k)=[\tilde{X}₁(k)\tilde{X}₃(k) . . . \tilde{X}_{N-1}(k)0 . . . 0]^{T} (83a)

\tilde{X}^{Ee}(k)=[\tilde{X}₂(k)\tilde{X}₄(k) . . . \tilde{X}_{N}(k)0 . . . 0]^{T} (83b)

The Fourier transform of yₙ(k) in (82) denoted by Yₘ^{Oe}(m) may be expressed as

Yₘ^{Oe}(k)=Yₘ^{O1}(k)+Yₘ^{O2}(k);m=1,2, . . . ,N₀ (84)

In (84) Yₘ^{O1}(k) and Yₘ^{O2}(k) denote the N₀ point discrete Fourier transform of yₙ¹(k) and yₙ²(k) respectively. By inspection of (84b) Yₘ^{O1}(k) is equal to \tilde{X}ₘ^{Oe}, m=1, 2, . . . , N₀. The Fourier transform of yₙ²(k) may be evaluated as

$${Y}_{m}^{O 2} ( k ) = \frac{1}{{N}_{0}} {\sum }_{n = 1}^{{N}_{0}} {y}_{n}^{2} ( k ) exp [ - j 2 π ( n - 1 ) ( m - 1 ) / {N}_{0} ] ; \\ m = 1 , 2 , … , {N}_{0} \qquad ( 85 )$$

Substitution for yₙ²(k) from (82c) in (85), the resulting expression for Yₘ^{O2}(k) may be written as

$$\begin{matrix}{Y}_{m}^{O 2} ( k ) = {\sum }_{\vert = 1}^{{N}_{0}} {𝒮}_{2 i + 1} {\tilde{X}}_{\vert}^{Ee} ; i = \vert - m ; m = 1 , 2 , … , {N}_{0} & ( 86 a ) \\ {𝒮}_{2 i + 1} = \frac{1}{{N}_{0}} {\sum }_{n = 1}^{{N}_{0}} exp [ j π ( n - 1 ) ( 2 i + 1 ) / {N}_{0} ] & ( 86 b )\end{matrix}$$

The summation in (86b) may be evaluated as

$$\begin{matrix}{𝒮}_{2 i + 1} ≅ \frac{2 j}{π ( 2 i + 1 )} {c}_{2 i + 1} & ( 87 a ) \\ {c}_{i} = \frac{{θ}_{i}}{sin ( {θ}_{i} )} exp ( - j {θ}_{i} ) ; {θ}_{i} = \frac{π i}{2 {N}_{0}} & ( 87 b )\end{matrix}$$

From (86) and (87), the expression for Yₘ^{O}(k) given by (88) is obtained.

$$\begin{matrix}{Y}_{m}^{O e} ( k ) = {X}_{m}^{O e} ( k ) + {\sum }_{\vert = 1}^{{N}_{0}} \frac{j 2}{π ( 2 ( \vert - m ) + 1 )} {c}_{( 2 ( \vert - m ) + 1 )} {\tilde{X}}_{\vert}^{Ee} ( k ) ; \\ m = 1 , 2 , … , {N}_{0} & ( 88 a ) \\ {Y}_{m}^{O} ( k ) = {X}_{m}^{O} ( k ) + {( - 1 )}^{k} {\sum }_{\vert = 1}^{M} \frac{j 2}{π ( 2 ( \vert - m ) + 1 )} {X}_{\vert}^{E} ( k ) ; \\ m = 1 , 2 , … , M & ( 88 b )\end{matrix}$$

wherein N₀ is much higher than M in (88a).

The expression in (88b) for Yₘ^{O}(k) for m=1, 2, . . . , M is identical to that given by (41)-(42) for the odd components of Y(k) with the summation term on the right hand side of (88) equal to the mutual interference.

The Fourier transform of yₙ(k) ξ̅ₙ* in (82) denoted by Yₘ^{E}(m) may be expressed as

Yₘ^{Ee}(k)=Yₘ^{E1}(k)+Yₘ^{E2}(k);m=1,2, . . . ,N₀ (89)

where in (89) Yₘ^{E1}(k) and Yₘ^{E2}(k) denote the N₀ point discrete Fourier transform of ξ̅ₙ* yₙ¹(k) and ξ̅ₙ* yₙ²(k) respectively. By inspection of (82c) Yₘ^{E2}(k) is equal to \hat{X}ₘ^{Ee}, m=1, 2, . . . , N₀. The Fourier transform of ξ̅ₙ* yₙ¹(k) denoted by Yₘ^{E1}(k) may be evaluated as

$${Y}_{m}^{E 1} ( k ) = \frac{1}{{N}_{0}} {\sum }_{n = 1}^{{N}_{0}} {\overline{ξ}}_{n}^{*} {y}_{n}^{1} ( k ) exp [ - j 2 π ( n - 1 ) ( m - 1 ) / {N}_{0} ] ; \\ m = 1 , 2 , … , {N}_{0} \qquad ( 90 )$$

Substitution for yₙ¹(k) from (82b) and ξ̅ₙ* from (82c) result in the expression for Yₘ^{E1}(k) given in (91).

$$\begin{matrix}{Y}_{m}^{E 1} ( k ) = \frac{1}{{N}_{0}} {\sum }_{\vert = 1}^{{N}_{0}} {\tilde{X}}_{\vert}^{O e} ( k ) {\sum }_{n = 1}^{{N}_{0}} exp [ j 2 π ( n - 1 ) ( \vert - m - 1 / 2 ) / {N}_{0} ] \\ = {\sum }_{\vert = 1}^{{N}_{0}} {𝒮}_{2 i - 1} {\tilde{X}}_{\vert}^{O e} ; i = \vert - m ; m = 1 , 2 , … , {N}_{0}\end{matrix} \qquad ( 91 )$$

Substituting for [symbol] ₂ᵢ₋₁ from (87) in (89)-(91) results in the expression for Yₘ^{E}(k) given in (92).

$$\begin{matrix}{Y}_{m}^{Ee} ( k ) = {\tilde{X}}_{m}^{Ee} ( k ) + {\sum }_{\vert = 1}^{{N}_{0}} \frac{j 2}{π ( 2 ( \vert - m ) - 1 )} {c}_{( 2 ( \vert - m ) - 1 )} {\tilde{X}}_{\vert}^{O e} ; \\ m = 1 , 2 , … , {N}_{0} & ( 92 a ) \\ {( - 1 )}^{k} {Y}_{m}^{E} ( k ) ≅ {X}_{m}^{E} ( k ) + {( - 1 )}^{k} {\sum }_{\vert = 1}^{M} \frac{j 2}{π ( 2 ( \vert - m ) - 1 )} {X}_{\vert}^{O} ( k ) ; \\ m = 1 , 2 , … , {N}_{0} & ( 92 b )\end{matrix}$$

The expression in (92) for (−1)^{k}Yₘ^{E}(k) for m=1, 2, . . . , M is identical to that given by (41)-(42) for the odd components of Y(k).

The odd components of the noise ηₘ(k) denoted by ηₘ^{Oe}(k) given by the integral in (45) may be obtained by the discrete approximation in terms of the Fourier transform given by (93).

$${η}_{m}^{O e} ( k ) = \frac{1}{{N}_{0}} {\sum }_{n = 1}^{{N}_{0}} {n}_{b} ( k ) exp [ - j 2 π ( n - 1 ) ( m - 1 ) / {N}_{0} ] ; \\ m = 1 , 2 , … , {N}_{0} \qquad ( 93 )$$

Likewise the even components of the noise ηₘ(k) denoted by ηₘ^{Ee}(k) given by the integral in (32) may be obtained by the discrete approximation in terms of the Fourier transform in (94).

$${η}_{m}^{Ee} ( k ) = \frac{1}{{N}_{0}} {\sum }_{n = 1}^{{N}_{0}} {\overline{ξ}}_{n}^{*} {n}_{b} ( k ) exp [ - j 2 π ( n - 1 ) ( m - 1 ) / {N}_{0} ] ; \\ m = 1 , 2 , … , {N}_{0} \qquad ( 94 )$$

From (79), (88b) and (92b), the first M odd components of the N₀ point Fourier transform of z(k) in (79) are equal to the corresponding components of 352 Z(k) at the output of the multicarrier demodulator unit 352 in FIG. 3. Likewise the first M even components of the No point Fourier transform of z(k) in (79) are equal to the corresponding components of 352 Z(k) at the output of the multicarrier demodulator unit 352 except for the multiplication of the mutual interference term by (−1) for odd time indices k.

Referring to FIG. 6, the received signal vector 615 z(k) is inputted to the N₀ point FFT block 620 that provides the N₀ point FFT at the output. Referring to FIG. 6, the output Z^{Oe} is comprised of the vector Z^{O} and Z^{Od}. The vector 645 Z^{O} comprised of the first M=N/2 components of the Fourier transform Z^{Oe}(k) of z(k) is inputted to the collator 660. Referring to FIG. 6, the vector 646 Z^{Od}(k) comprised of the last (N₀−M) components of the Fourier transform Z^{Oe} (k) is discarded.

Referring to FIG. 6, the received signal vector 615 z(k) is inputted to the vector multiplier 625. The vector multiplier component wise multiplies the vector z(k) with the components of the vector 630 ξ̅* made available to the vector multiplier 625 with the n^{th} component ξ̅ₙ* of ξ̅* equal to exp [−jπ(n−1)/N₀]; n=1, 2, . . . , N₀. Referring To FIG. 6, the vector 635 z^{s}(k) at the output of the vector multiplier 625 is inputted to the N₀ point FFT block 640 that provides the N₀ point FFT at the output.

Referring to FIG. 6, the output 650 Z^{ES} comprised of the first M=N/2 components of the Fourier transform Z^{Ee}(k) of z^{s}(k) is multiplied by (−1)^{k} providing the output Z^{E}(k) comprised of the M even components of the vector Z(k) to the collator 660. Referring to FIG. 6, the vector 651 Z^{Ed} comprised of the last (N₀−M) components of the Fourier transform 649 Z^{Ee}(k) is discarded.

Referring to FIG. 6, the collator 660 collates the components of the vector 645 Z^{O}(k) and vector 650 Z^{E}(k) comprised of the odd and even component components respectively of the vector Z(k) providing the size N=2M vector Z(k) at the output 352 of the multicarrier demodulator 385B.

### Performance Results

In the illustrative simulation results on the performance of the high capacity OFDM system of the invention, the number of information baseband symbols M_{I} is selected to be equal to the number of subcarriers M. The selection corresponds to having no known pilot symbols or any zeros in the OFDM signal. In terms of the mutual interference among the two OFDM groups of users, the scenario with no known pilot or zero symbols corresponds to an upper bound on the mutual interference and the simulation results depict a lower bound on the performance of the high capacity OFDM system of the invention. In case when some of the symbols are zeros or the symbols are known pilot symbols, their estimates may be replaced by their known values in the right hand sides of (67)-(68) resulting in a reduction in the noise in the estimation of the unknown symbols.

For simplicity of presentation, in the simulation results presented the channel gain matrix [symbol] ₁ and [symbol] ₂ are selected to be scalar matrices with [symbol] ₁=b₁I and [symbol] ₂=b₂I for some scalars b₁ and b₂. This may be achieved by a feedback power control commonly used in OFDM systems. The received signal power ratio among the two groups of users Pᵣ is equal to 20 log(b₁/b₂) dB. In the simulations, the orthonormal matrices P¹ and P² are selected to be Hadamard matrices. Both groups of users employ QPSK modulation.

In various embodiments of the invention, various other modulation techniques may be used. Different users in any group may use different modulation type. The orthonormal matrices P¹ and P² may be different and may be different from the Hadamard matrices. The channel gain matrix [symbol] ₁ and [symbol] ₂ may not be scalar matrices. The performance results for those cases may be expected to be similar to those for the cases considered in the simulations. With the introduction of zero symbols and known pilot symbols as is done in the traditional OFDM system, the performance is expected to be even better.

The simulation results are presented for both cases corresponding to not employing a block error correction code as in the OFDM transmitter 100 in FIG. 2 and the case with block error correction code employed as in FIG. 2D. The block error correction code selected in the simulations presented is a BCH code or a Hamming code with a capability of correcting one or more bit errors. In some cases only one of the two groups of users may employ an error correction code.

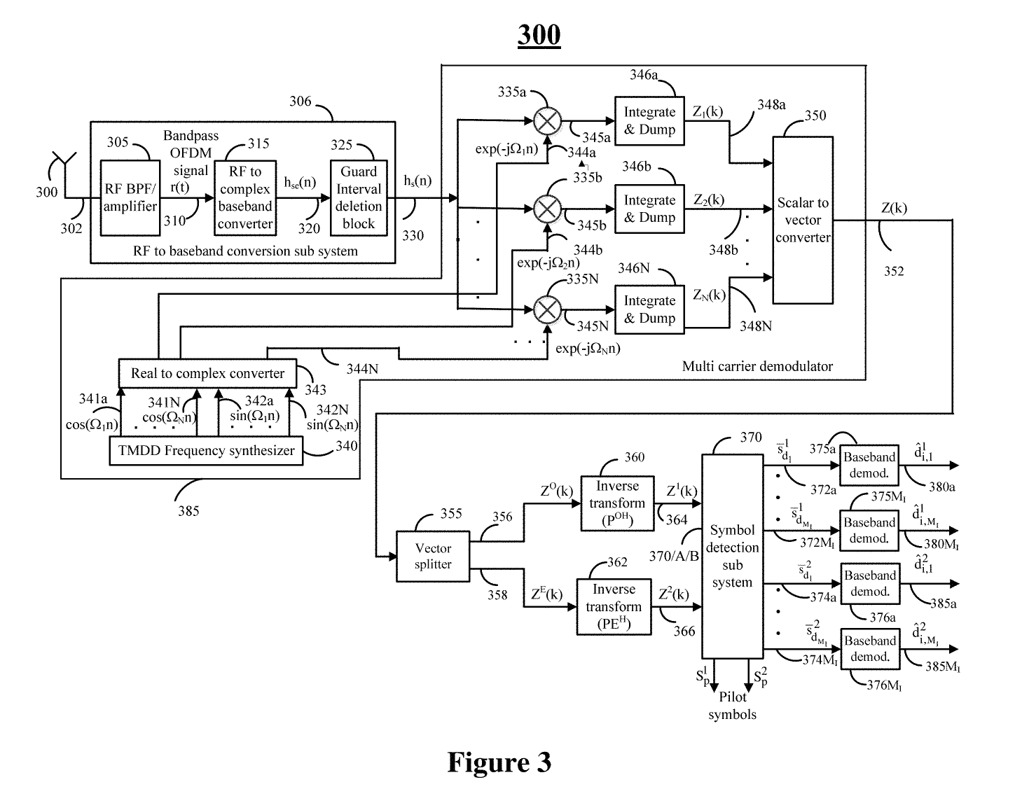

FIG. 7 plots the probability of bit error Pₑ for both group 1 and 2 users versus the effective average bit energy to noise power spectral density ratio (E_{b}/N₀)_{eff} adjusted by 2 dB for clarity of presentation. The (E_{b}/N₀)_{eff} is equal to the group 1 users' bit energy to noise power spectral density ratio is equal to (E_{b}/N₀)₂ plus 10 log [(1+10^{P}^{ᵣ}^{/10})/2] dB wherein Pᵣ is the power ratio. FIG. 7 also includes the probability of bit error versus the bit energy to noise power spectral density ratio (E_{b}/N₀) for the case of traditional OFDM system with the number of subcarriers equal to M. The results of FIG. 7 are for the case of no block error correction code used in the OFDM transmitter 100 of FIG. 2 with N equal to 2M and M equal to 32. Compared to the traditional OFDM system operating at about half the number of subcarriers compared to the high capacity OFDM system of the invention has an effective loss L_{eff} in terms of (E_{b}/N₀) given by L_{eff}=10 log [0.5(10^{L}^{₁}^{/10}+10^{L}^{₂}^{/10})] dB, referred to the loss according to first criteria, may be evaluated for any specified Pₑ, wherein L₁ is the difference in the required (E_{b}/N₀) for the traditional OFDM system and the required (E_{b}/N₀)_{eff} for OFDM group 1 users with L₂ denoting the corresponding difference for the OFDM group 2 users.

In the Figures presenting the simulation results the graphs labeled as OFDM1, OFDM 2, and OFDM correspond to the OFDM group 1 users, OFDM group 2 users, and the traditional OFDM users respectively. In FIG. 7 the power ratio Pᵣ is selected to be 10 dB resulting in an effective loss L_{eff} equal to 5.5 dB for Pₑ=10⁻³. The OFDM system of the invention results in a 100% increase in capacity of the system.

The simulations presented treat all the subcarriers as data subcarriers carrying unknown user data symbols and present an under bound on the performance in terms of (E_{b}/N₀). Allocation of some of the subcarriers to known pilot symbols and some to carry zeros or no signal may not make any difference in terms of the performance of the traditional OFDM system in terms of the (E_{b}/N₀). However, for the high capacity OFDM system of the invention such an allocation of subcarriers to transmit known pilot symbols and zeros will result in a significant reduction in the mutual interference among the two groups of users and thereby in reduction in the required (E_{b}/N₀) and the effective loss L_{eff}.

Referring to FIG. 1A, the group 1 users may be the users located relatively far from the base station at an average distance of D₁ and labeled as M.S. A with the group 2 users located relatively close to the base station at an average distance of D₂ and labeled as M.S. B. The probability of error graphs in FIG. 7 correspond to the average effective (E_{b}/N₀) measured at the location of M.S. A and the graph labeled OFDM1 is relevant at the location of the M. S. A. For the M.S.B located close to the base station the Pₑ graphs labeled OFDM 1 and OFDM 2 are shifted to the left by an amount of the difference in propagation loss L_{diff} for the signal from the base station to M.S. A and M.S. B. The difference in propagation loss L_{diff} is given by 10n log(D₁/D₂) wherein n is the propagation coefficient with a range of possible values between 2 and 4 depending upon various factors such as the terrain and urban versus rural environment in the cell area, etc. For example, with L_{diff} equal to 6 dB, the Pₑ graph labeled as OFDM 2 is shifted to the left by 6 dB at the location of M.S. B and is close to the graph corresponding to the traditional OFDM system labeled as OFDM in FIG. 7.

The simulation results for the OFDM system of the invention may also be compared with the traditional OFDM system wherein half of the mobiles stations corresponding to group1 are located relatively far from the base station and labeled as M.S. A with the other half of the mobiles stations corresponding to group 2 users located relatively close to the base station and labeled as M.S. B. wherein the relative power level among the two groups of users is selected to be 6 dB. In this case the (E_{b}/N₀)_{eff} is smaller than the (E_{b}/N₀)₁ by 2 dB measured at the location of group 1 mobiles. The Pₑ graph for the group 1 users plotted versus the (E_{b}/N₀)_{eff} may be obtained by shifting the graph in FIG. 7 labeled OFDM to the left by 2 dB. For the same effective power in both the traditional OFDM system and the high capacity OFDM system of the invention, the high capacity OFDM system requires about 3.7 dB higher (E_{b}/N₀)_{eff} or 3.7 dB higher average transmitted power at Pₑ=10⁻³ referred to as loss according to the second criteria. At the location of the group2 mobile stations, the graph labeled OFDM 2 in FIG. 7 is shifted to the left by 6 dB and provides the same Pₑ result as for the group 1 mobile stations. For the traditional OFDM system, the Pₑ performance for the group 2 mobile stations will also be same as that for the group 1 mobile stations. For a higher Pₑ generally used in coded systems, the effective loss is smaller. For example, for a Pₑ=0.005, the loss according to the second criteria is approximately 2.7 dB.

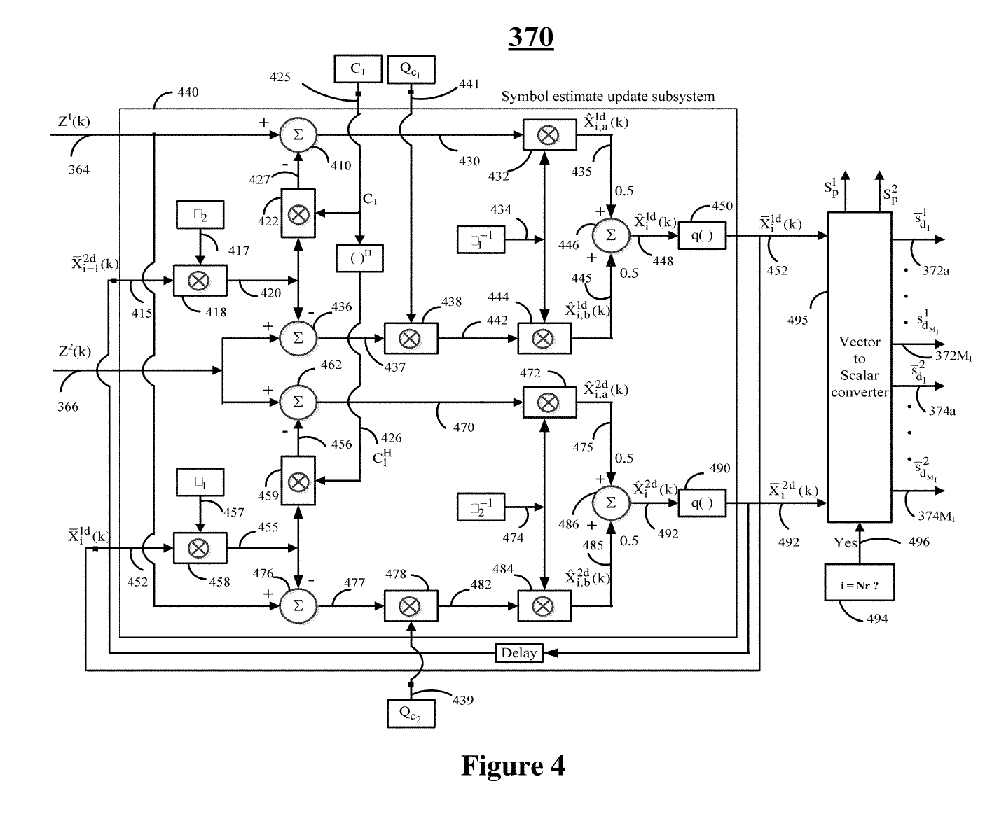

FIG. 8 plots the probability of bit error Pₑ for both group 1 and 2 users versus the effective bit energy to noise power spectral density ratio (E_{b}/N₀)_{eff} adjusted by 2 dB for the case wherein the high capacity OFDM transmitter 100 includes a block error correction code 250 shown in FIG. 2D with the total number of subcarriers equal to 64. In FIG. 8 group 1 users' data is not coded by an error correction code while the group 1 users' data is encoded using Hamming code. For the Hamming code the code block length n is equal to 2^{m}−1 wherein the integer m is selected to be 5 resulting in n=31. With M=N/2=32, one of the data bits may be uncoded. According to the first criteria the effective average loss in term of power is 4 dB. According to the second criteria the effective average loss in term of power is 3.2 dB at Pₑ=10⁻³. The increase in capacity compared to the traditional OFDM system is 84%.

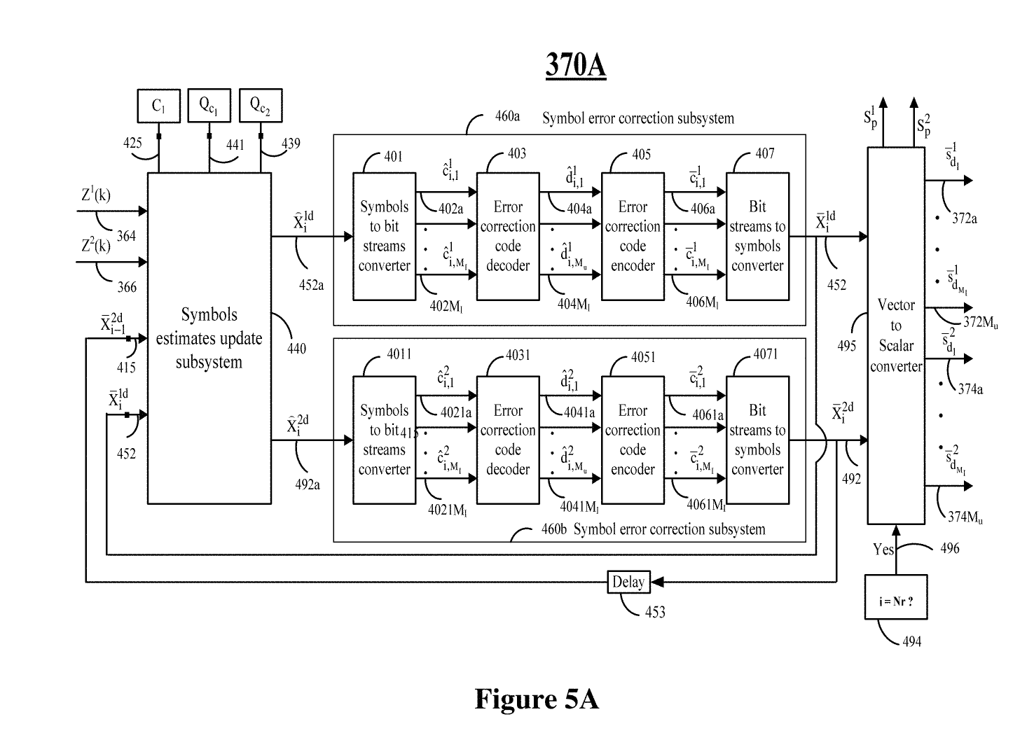

FIG. 9 plots the probability of bit error Pₑ for both group 1 and 2 users versus the effective bit energy to noise power spectral density ratio (E_{b}/N₀)_{eff} adjusted by 2 dB for the case wherein both groups of users' data are encoded by Hamming code with N=64 and Pᵣ=10 dB. From FIG. 9 the effective average loss in term of power is about 1.1 dB according to the second criteria for Pₑ in the range of 10⁻⁵ to 10⁻³. The increase in capacity is about 65%. The relative power level Pᵣ is selected equal to 10 dB in FIGS. 7 to 9.

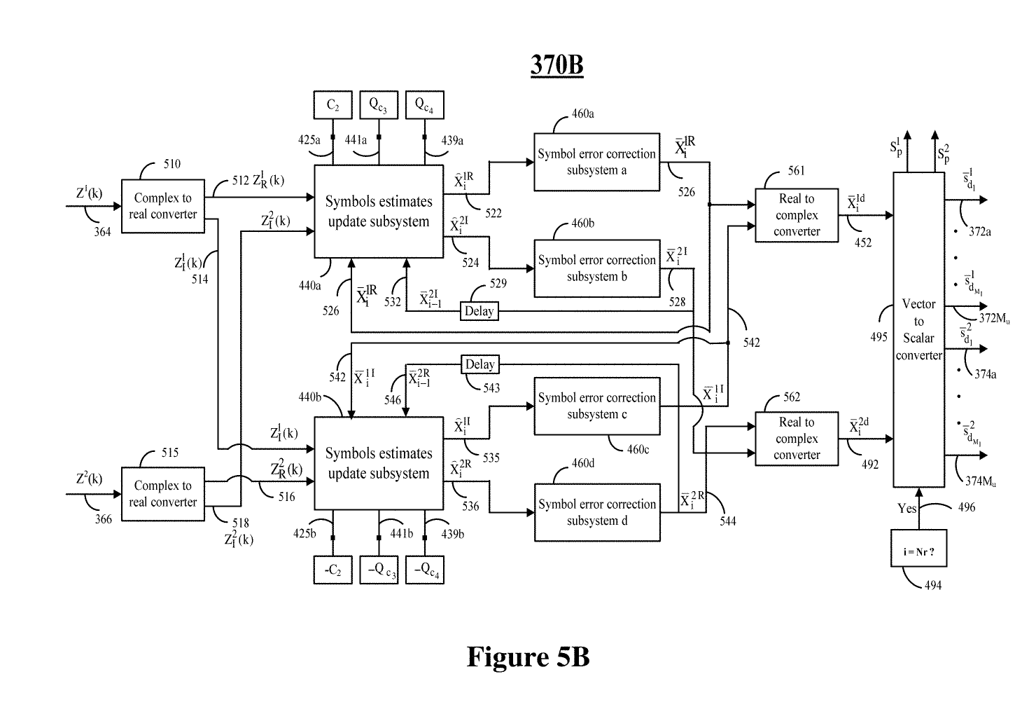

FIG. 10 plots the probability of bit error Pₑ for both group 1 and 2 users versus the effective bit energy to noise power spectral density ratio (E_{b}/N₀)_{eff} adjusted by 2 dB for the case wherein the first groups of users' data are encoded by BCH code with a single error correction capability with the second groups of users' data encoded by BCH code with two errors correction capability. In FIG. 10 the number of subcarriers N is equal to 64 and Pᵣ=8 dB. From FIG. 10 the effective average loss in term of power is about 2.5 dB from either of the two criteria for Pₑ equal to 10⁻³. The increase in capacity relative to traditional OFDM system is about 53%. In FIG. 10, the performance of the two groups of users is closer compared to that in FIGS. 7-9. The FIG. 10 relates to the case when the group 1 users have about 1.5 dB more propagation loss compared to group 2 users or both groups of users have nearly the same propagation loss.

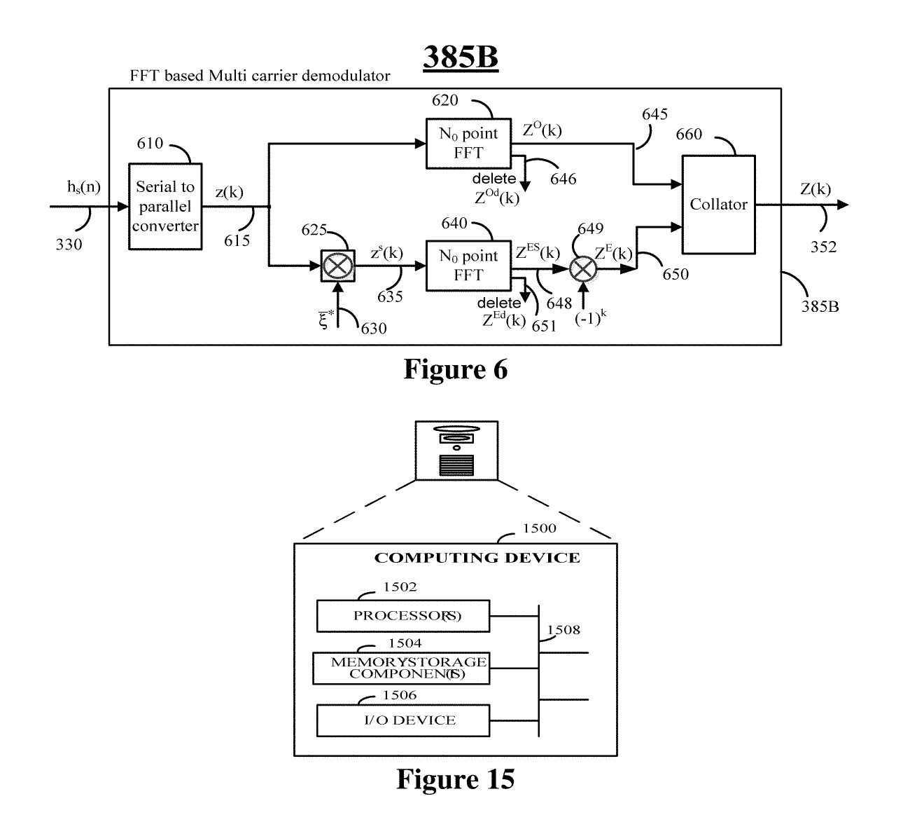

FIG. 11 plots the probability of bit error Pₑ for both group 1 and 2 users versus the effective bit energy to noise power spectral density ratio (E_{b}/N₀)_{eff} adjusted by 2 dB for the case wherein the first groups of users' data are encoded by BCH code with a single error correction capability with the second groups of users' data encoded by BCH code with two errors correction capability. In FIG. 11 the number of subcarriers N is equal to 128 and Pᵣ=8 dB. From FIG. 11 the effective average loss in term of power is about 3.9 dB from the first criteria for Pₑ equal to 10⁻³. The increase in capacity relative to traditional OFDM system is about 72%. In The FIG. 11 relates to the case when the group 1 users have about 1.5 dB more propagation loss compared to group 2 users or both groups of users have nearly the same propagation loss.

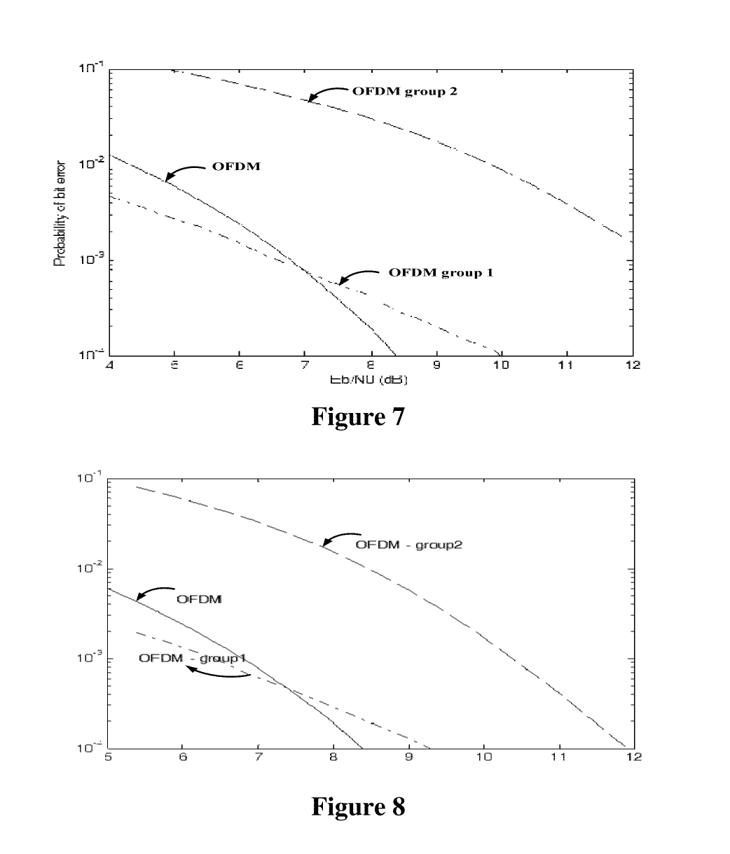

FIG. 12 plots the probability of bit error Pₑ for both group 1 and 2 users versus the effective bit energy to noise power spectral density ratio (E_{b}/N₀) adjusted by 2 dB for the case wherein the both groups of users' data are encoded by BCH code with two errors correction capability. In FIG. 12 the number of subcarriers N is equal to 256 and Pᵣ=10 dB. From FIG. 12 the effective average loss in term of power is about 3.9 dB from the first criteria for Pₑ equal to 10⁻³. The increase in capacity relative to traditional OFDM system is about 84%. The FIG. 12 relates to the case when the group 1 users have about 5 dB more propagation loss compared to group 2 users. Compared to the traditional OFDM the high capacity OFDM of the invention has about 2.5 dB loss according to the second criteria.

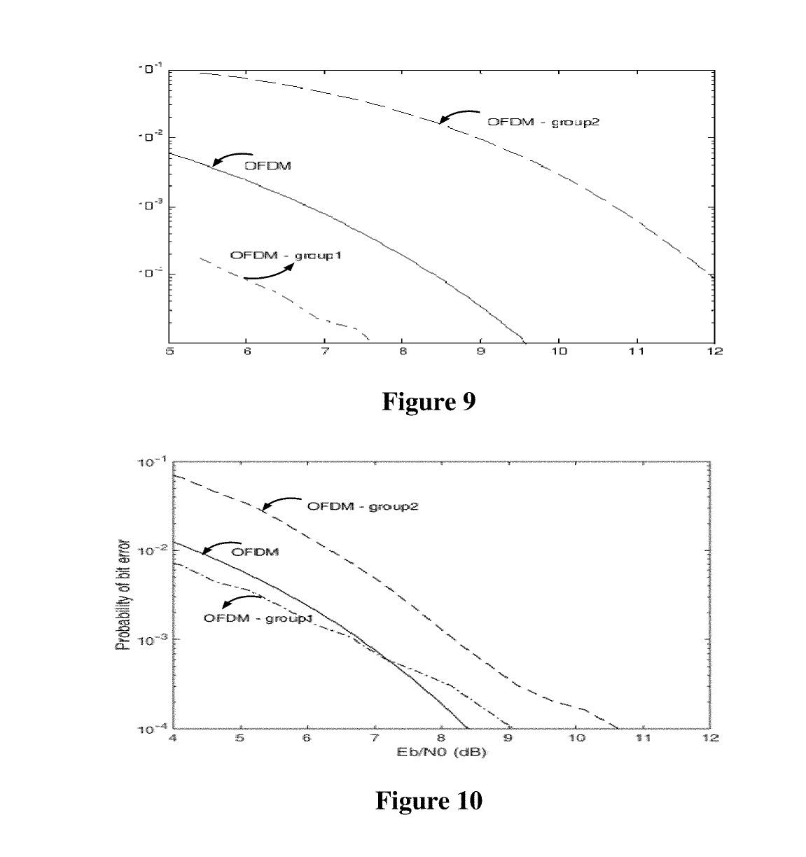

FIG. 13 plots the probability of bit error Pₑ for both group 1 and 2 users versus the effective bit energy to noise power spectral density ratio (E_{b}/N₀)_{eff} adjusted by 2 dB for the case wherein the group 1 and group 2 users' data are encoded by BCH code with correction capability of two and three errors respectively. In FIG. 13 the number of subcarriers N is equal to 256 and Pᵣ=10 dB. From FIG. 13 the effective average loss in term of power is about 4.0 dB from the first criteria for Pₑ equal to 10′. The increase in capacity relative to traditional OFDM system is about 84%. In The FIG. 13 relates to the case when the group 1 users have about 4 dB more propagation loss compared to group 2 users. Compared to the traditional OFDM the high capacity OFDM of the invention has about 2.4 dB loss according to the second criteria.

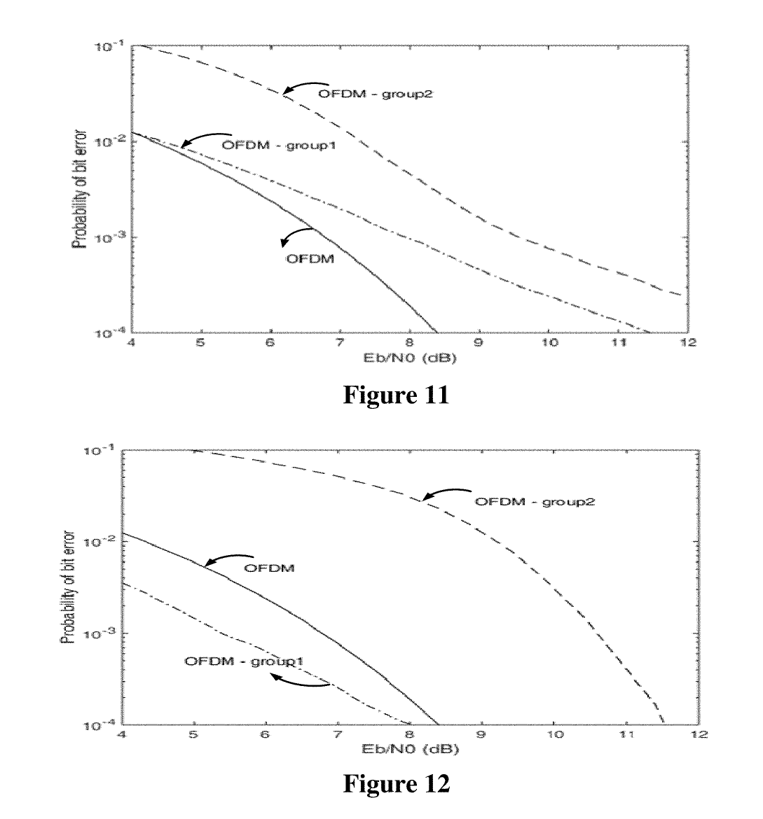

FIG. 14 plots the probability of bit error Pₑ for both group 1 and 2 users versus the effective bit energy to noise power spectral density ratio (E_{b}/N₀), adjusted by 2 dB for the case wherein none of the group 1 and group 2 users' data are encoded by an error correction code with. In FIG. 14 the number of subcarriers N is equal to 32 and Pᵣ=10 dB. Compared to the traditional OFDM the high capacity OFDM of the invention has about 3.5 dB loss at a Pₑ=10⁻³ according to the second criteria. In this case the high capacity OFDM system of the invention results in a 100% increase in capacity compared to the traditional OFDM system.

From the simulation results presented the difference between the Pₑ graphs for the group1 and group 2 users is relatively small when the group2 code has higher error correction capability than the group1 code. Such a selection is appropriate when the difference between the propagation losses from the base station to the two groups of users is relatively small. The difference between the Pₑ graphs for the group1 and group 2 users is relatively large when the group 1 and 2 codes have similar error correction capability. Such a selection is appropriate when the difference between the propagation losses from the base station to the two groups of users is relatively large. In the latter case it is more appropriate to compare the results with the traditional OFDM system wherein half of the users corresponding to group1 are located relatively far from the base station with the other half of the users corresponding to group 2 located relatively close to the base station wherein the relative power level among the two groups of users is selected to be equal to the difference in the power loss in the signal propagation from the base station to the two groups of users. In these cases presented in FIGS. 7,8, 12, and 13 the effective power loss is between 2.4 dB and 3.2 dB for a capacity increase between 84% and 100% depending upon the error correction codes and the number of subcarriers N. For the case of FIG. 9 the loss is 1.1 dB with 64.8% increase in capacity.

In any cellular network the users are spread out over the coverage area experiencing different propagation power loss for signals propagating from the base station to the mobile user stations. With proper selection of the codes and N the effective loss relative to the traditional OFDM system may be kept within about 2 dB with about 85% or higher increase in capacity.

The computational requirements increase with M=N/2 and thus N may be chosen in some optimum manner to increase capacity, minimize the power loss with respect to the traditional OFDM system and limit the computational requirements.

Various modifications and other embodiments of the invention applicable to various problems in broad Communication and other fields will be readily apparent to those skilled in the field of invention. For example, the orthonormal transform employed in the high capacity OFDM transmitter of the invention for the group1 modulation symbols may be different than that for the group2 modulation symbols including the identity transform. In various embodiments of the invention both group 1 and group 2 modulation symbols may be collectively transformed by a single transform.

In various embodiments of the invention the block error correction code encoder in the baseband modulation subsystem1 in FIG. 2D may be different than the block error correction code encoder in the baseband modulation subsystem 2 not shown in the Figure. In various alternative embodiments of the baseband modulation subsystems the two groups of the users' data may be jointly encoded by a single block error correction encoder. The block error correction code may be selected from the various codes known in the literature with non delimiting examples including the linear codes, cyclic codes, BCH codes, finite geometry codes, LDPC codes, etc. In various alternative embodiments of the invention the block error codes may be replaced by convolution codes, trellis codes, and turbo codes, etc.

In various embodiments of the invention the multi carrier modulator in FIG. 2B may include a band limiting filtering of the modulation symbol sequences Xᵢ(k), 1≦i≦N, such as raised cosine filter with a roll off factor r that may reduce the mutual interference among the two groups of OFDM subcarrier signals at the cost of some possible increase in the transmission bandwidth with the spacing among the subcarrier frequencies 2Δf equal to (1+r)/T₀ wherein 0<r≦l.

In various embodiments of the invention only a percentage such as 80% of the subcarriers in group2 may be assigned to carry signals while the remaining subcarriers carry no signal resulting in a reduced amount of mutual interference power among the two groups' subcarriers with a corresponding reduction in the capacity of the high capacity OFDM system of the invention. The subcarriers that do not carry any signal may be selected in a deterministic manner, for example, one out of every 5 subcarriers may carry zero signal. In various alternative embodiments of the invention the subcarriers carrying no signal may be selected according to some probability distribution.

In various embodiments of the invention the frequency shift between the group1 and group2 subcarriers may be equal to an integer multiple of Δf wherein the integer multiple is selected from a group comprised of integer 0 and odd integers less than 2M. Higher value of the selected integer results in reduced mutual interference between the two groups of carriers but with reduced capacity in a given bandwidth. In various embodiments of the invention the frequency shift between the group1 and group2 subcarriers may be a non integer multiple of Δf in the range from 0 to (2M−1)Δf.

The high capacity OFDM system architectures of the invention can be readily modified and applied to various fields where such an architecture is applicable. Examples of such fields include various communication systems in addition to the various wireless communication networks including the satellite communication, terrestrial microwave communication systems, optical communication systems, Radars, sonar, digital audio systems and so on.

It is to be understood that the figures and descriptions of the present invention have been simplified to illustrate elements that are relevant for a clear understanding of the present invention, while eliminating other elements, for purposes of clarity. Those of ordinary skill in the art will recognize that these and other elements may be desirable. However, because such elements are well known in the art and because they do not facilitate a better understanding of the present invention, a discussion of such elements is not provided herein.

In general, it will be apparent that the embodiments described herein may be implemented in many different embodiments of software, firmware, and/or hardware, for example, based on Field Programmable Gate Array (FPGA) chips or implemented in Application-Specific Integrated Circuits (ASICS). The software and firmware code may be executed by a computer or computing device comprising a processor (e.g., a DSP or any other similar processing circuit) including, for example, the computing device described below. The processor may be in communication with memory or another computer-readable medium comprising the software code. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. According to various embodiments, the software may be firmware stored at an EEPROM and/or other non-volatile memory associated with a DSP or other similar processing circuit. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

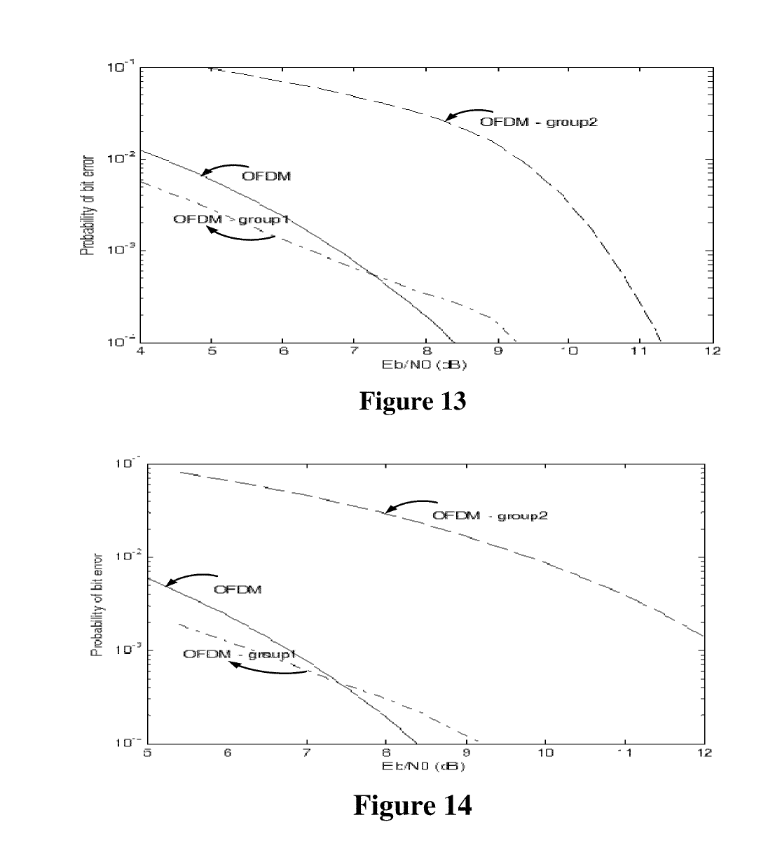

FIG. 15 shows an example of a computing device 1500 according to one embodiment. For the sake of clarity, the computing device 1500 is illustrated and described here in the context of a single computing device. However, it is to be appreciated and understood that any number of suitably configured computing devices can be used to implement a described embodiment. For example, in at least some implementations, multiple communicatively linked computing devices may be used. One or more of these devices can be communicatively linked in any suitable way such as via one or more networks. One or more networks can include, without limitation: the Internet, one or more local area networks (LANs), one or more wide area networks (WANs) or any combination thereof.

In the example of FIG. 15, the computing device 1500 comprises one or more processor circuits or processing units 1502, one or more memory and/or storage circuit component(s) 1504 and one or more input/output (I/O) devices 1506. Additionally, the computing device 1500 comprises a bus 1508 that allows the various circuit components and devices to communicate with one another. The bus 1508 represents one or more of any of several types of bus structures, including a memory bus or memory controller, a peripheral bus, an accelerated graphics port, and a processor or local bus using any of a variety of bus architectures. The bus 1508 may comprise wired and/or wireless buses.

The processing unit 1502 may be responsible for executing various software programs such as system programs, application programs, and/or program modules/blocks to provide computing and processing operations for the computing device 1500. The processing unit 1502 may be responsible for performing various voice and data communications operations for the computing device 1500 such as transmitting and receiving voice and data information over one or more wired or wireless communications channels. Although the processing unit 1502 of the computing device 1500 is shown in the context of a single processor architecture, it may be appreciated that the computing device 1500 may use any suitable processor architecture and/or any suitable number of processors in accordance with the described embodiments. In one embodiment, the processing unit 1502 may be implemented using a single integrated processor. The processing unit 1502 may be implemented as a host central processing unit (CPU) using any suitable processor circuit or logic device (circuit), such as a general purpose processor. The processing unit 1502 also may be implemented as a chip multiprocessor (CMP), dedicated processor, embedded processor, media processor, input/output (I/O) processor, co-processor, microprocessor, controller, microcontroller, application-specific integrated circuit (ASIC), field programmable gate array (FPGA), programmable logic device (PLD), or other processing device in accordance with the described embodiments.

As shown, the processing unit 1502 may be coupled to the memory and/or storage component(s) 1504 through the bus 1508. The bus 1508 may comprise any suitable interface and/or bus architecture for allowing the processing unit 1502 to access the memory and/or storage component(s) 1504. Although the memory and/or storage component(s) 1504 may be shown as being separate from the processing unit 1502 for purposes of illustration, it is worthy to note that in various embodiments some portion or the entire memory and/or storage component(s) 1504 may be included on the same integrated circuit as the processing unit 1502. Alternatively, some portion or the entire memory and/or storage component(s) 1504 may be disposed on an integrated circuit or other medium (e.g., hard disk drive) external to the integrated circuit of the processing unit 1502. In various embodiments, the computing device 1500 may comprise an expansion slot to support a multimedia and/or memory card, for example.

The memory and/or storage component(s) 1504 represent one or more computer-readable media. The memory and/or storage component(s) 1504 may be implemented using any computer-readable media capable of storing data such as volatile or non-volatile memory, removable or non-removable memory, erasable or non-erasable memory, writeable or re-writeable memory, and so forth. The memory and/or storage component(s) 1504 may comprise volatile media (e.g., random access memory (RAM)) and/or non-volatile media (e.g., read only memory (ROM), Flash memory, optical disks, magnetic disks and the like). The memory and/or storage component(s) 1504 may comprise fixed media (e.g., RAM, ROM, a fixed hard drive, etc.) as well as removable media (e.g., a Flash memory drive, a removable hard drive, an optical disk). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 1506 allow a user to enter commands and information to the computing device 1500, and also allow information to be presented to the user and/or other components or devices. Examples of input devices include data ports, analog to digital converters (ADCs), digital to analog converters (DACs), a keyboard, a cursor control device (e.g., a mouse), a microphone, a scanner, a touch sensitive screen, and the like. Examples of output devices include data ports, ADCs, DACs, a display device (e.g., a monitor or projector, speakers, a printer, a network card). The computing device 1500 may comprise an alphanumeric keypad coupled to the processing unit 1502. The keypad may comprise, for example, a QWERTY key layout and an integrated number dial pad. The computing device 1500 may comprise a display coupled to the processing unit 1502. The display may comprise any suitable visual interface for displaying content to a user of the computing device 1500. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 1502 may be arranged to provide processing or computing resources to the computing device 1500. For example, the processing unit 1502 may be responsible for executing various software programs including system programs such as operating system (OS) and application programs. System programs generally may assist in the running of the computing device 1500 and may be directly responsible for controlling, integrating, and managing the individual hardware components of the computer system. The OS may be implemented, for example, as a Microsoft® Windows OS, Symbian OS™, Embedix OS, Linux OS, Android system, Binary Run-time Environment for Wireless (BREW) OS, JavaOS, or other suitable OS in accordance with the described embodiments. The computing device 1500 may comprise other system programs such as device drivers, programming tools, utility programs, software libraries, application programming interfaces (APIs), and so forth.

In various embodiments disclosed herein, a single component may be replaced by multiple components, and multiple components may be replaced by a single component to perform a given function or functions. Except where such substitution would not be operative, such substitution is within the intended scope of the embodiments.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

Embodiments may be provided as a computer program product including a non-transitory machine-readable storage medium having stored thereon instructions (in compressed or uncompressed form) that may be used to program a computer (or other electronic device) to perform processes or methods described herein. The machine-readable storage medium may include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments may also be provided as a computer program product including a transitory machine-readable signal (in compressed or uncompressed form). Examples of machine-readable signals, whether modulated using a carrier or not include, but are not limited to, signals that a computer system or machine hosting or running a computer program can be configured to access, including signals downloaded through the Internet or other networks. For example, the distribution of software may be an Internet download.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

I claim:

1. An OFDM (Orthogonal Frequency Division Multiple Accessing) transmitter system comprised of:
a respective first and a second baseband processing subsystems for receiving and modulating user input data from a respective first and a second groups of users of a multiplicity Mᵤ providing the, in general complex valued, a respective first and a second transformed symbols vectors of a dimension M greater than or equal to Mᵤ; and
a subsystem for the generation of an OFDM signal vector, the subsystem further comprised of:
a multi carrier modulator for modulating the components of the first and second transformed symbols vectors by a respective first and a second groups of subcarriers with a frequency spacing of 2Δf for generating a first and a second OFDM signal vectors of dimension M;
a frequency shifter for shifting the center frequency of the components of the second OFDM signal vector by a frequency shift of an integer multiple of Δf for providing a frequency shifted second OFDM signal vectors wherein the integer multiple is selected from a group comprised of integer 0 and odd integers less than 2M; and
an adder for summing the first and the frequency shifted second OFDM signal vectors for providing an OFDM signal vector.

2. The system of claim 1 further comprised of:
a parallel to serial converter for arranging the elements of the OFDM signal vector into a serial OFDM signal; and
a baseband to RF conversion subsystem further comprised of a cascade of a guard interval insertion unit for providing a digital OFDM signal, a band limiting filter for providing an analog baseband OFDM signal, a carrier modulator for providing a band pass OFDM signal, an RF bandpass filter and amplifier, and a transmit antenna.

3. System of claim 1 wherein a respective first and second baseband processing subsystem is comprised of a block error correction code encoder inputted with the respective group's users data for generating a respective multiplicity M_{I} coded data wherein M_{I} is greater than or equal to Mᵤ; a multiplicity M_{I} baseband modulators for modulating the respective ones of the multiplicity M_{I} coded data for generating a respective multiplicity M_{I} information modulation symbols; a multiplicity M_{I} multipliers for weighting the respective multiplicity M_{I} information modulation symbols; and a scalar to vector converter inputted with the respective weighted multiplicity M_{I} information modulation symbols and a auxiliary symbols comprised of a pilot symbols for providing a respective first and second weighted modulation symbols vector.

4. The system of claim 3 wherein a respective first and second baseband processing subsystem is further comprised of a respective, in general time varying, orthonormal transform operating on the respective weighted modulation symbols vector for generating a respective first and second transformed symbols vector.

5. The system of claim 3 wherein the block error correction code is selected from a group of codes comprised of the Hamming code, The BCH code, the cyclic code, and the identity code.

6. System of claim 1 wherein the subsystem for the generation of an OFDM signal vector is comprised of a first IFFT (Inverse Fast Fourier Transform) block for providing a first OFDM signal vector; a second IFFT block for providing a second OFDM signal vector, a frequency shifter for providing the frequency shifted second OFDM signal vector, and an adder for adding the first OFDM signal vector and the frequency shifted second OFDM signal vector.

7. System of claim 1 wherein the subsystem for the generation of an OFDM signal vector is comprised of a time multiplexed direct digital frequency synthesizer (TMDDFS); a bank of digital modulators; an adder; and a scalar to vector converter.

8. System of claim 3 wherein a baseband modulator is configured to modulate the input coded data according to at least one technique selected from the group comprised of a Multiple Quadrature Amplitude Modulation (MQAM) technique, a Multiple Phase Shift Keying Modulation (MPSK) technique, and a Multiple Amplitude Shift Keying (MASK) technique.

9. An OFDM receiver comprised of:
a receive antenna for receiving the bandpass OFDM signal;
an RF to baseband conversion subsystem for providing the received serial OFDM signal;
a multicarrier demodulator for providing the received symbol vector from the received serial OFDM signal;
a vector splitter for providing a respective first and a second received symbol vector comprised of the elements of the received symbol vector with odd and even indices respectively;
a first and a second inverse transform units for providing a respective first and second inverse transformed symbol vector form the respective first and second received symbol vector;
a symbol detection subsystem for providing a mutual interference mitigated estimates of a first and second multiplicity M_{I} of information modulation symbols; and
a bank of baseband demodulators for providing estimates of users' data.

10. System of claim 9 wherein the multicarrier demodulator is further comprised of a serial to parallel converter for providing a received OFDM signal vector; an odd FFT block for providing an odd component vector, a frequency shifter for providing the frequency shifted received OFDM signal vector; an even FFT block for providing an even component vector; and a collator for collating the first M components of the odd component vector and the even component vector.

11. System of claim 9 wherein the symbol detection sub system inputted with the first and second received inverse transform symbol vectors, is comprised of a symbol estimate update subsystem providing the interference mitigated detected first and second modulation symbol vectors, and a vector to scalar converter for providing the detected information modulation symbols.

12. System of claim 11 wherein the symbol estimate update subsystem is further comprised of a means of recursively providing an updated linear estimate of the first modulation symbol vector on the basis of the detected second modulation symbol vector in a previous iteration; a symbol detector for providing an updated detected first modulation symbol vector; and with a similar means for providing an updated linear estimate of the second modulation symbol vector on the basis of the updated detected first modulation symbol vector; and a symbol detector for providing an updated detected second modulation symbol vector.

13. System of claim 11 wherein the updated linear estimates of the first and second modulation symbol vectors is based on least squares estimation algorithm.

14. System of claim 11 wherein the symbol estimate update subsystem is further comprised of a symbol error correction subsystem for the mitigation of any symbol errors in the detected modulation symbol vector on the basis of the block error correction code encoder in the OFDM transmitter for providing an error corrected detected modulation symbol vector.

15. A method for OFDM transmission and reception of user input data, the transmission method comprising:
implementing, by the computer device, a respective first and a second baseband processing subsystems for receiving and modulating user input data from a respective first and a second groups of users of a multiplicity Mᵤ providing the, in general complex valued, a respective first and a second transformed symbols vectors of a dimension M greater than or equal to Mᵤ;
implementing, by the computer device, a subsystem for the generation of an OFDM signal vector, the subsystem comprised of:
a multi carrier modulator for modulating the components of the first and second transformed symbols vectors by a respective first and a second groups of subcarriers with a frequency spacing of 2Δf for generating a first and a second OFDM signal vectors of dimension M;
a frequency shifter for shifting the center frequency of the components of the second OFDM signal vector by a frequency shift of an integer multiple of Δf for providing a frequency shifted second OFDM signal vectors wherein the integer multiple is selected from a group comprised of integer 0 and odd integers less than 2M; and
an adder for summing the first and the frequency shifted second OFDM signal vectors for providing an OFDM signal vector;
implementing, by the computer device, a cascade of a parallel to serial converter, a guard interval insertion block, and a baseband filtering unit for providing a baseband OFDM signal;
implementation of a carrier modulator unit and a radio frequency (RF) power amplifier for the generation of a bandpass OFDM signal; and
transmission by a transmit antenna.

16. The method of claim 15, wherein the reception method is further comprised of:
receiving the bandpass OFDM signal by a receive antenna;
implementing an RF to baseband conversion subsystem for filtering, amplifying, and the down conversion by the computer device of the bandpass OFDM signal for providing the received serial OFDM signal;
implementing, by the computer device, a multicarrier demodulator for providing the received symbol vector from the received serial OFDM signal;
implementing, by the computer device, a vector splitter for providing a respective first and a second received symbol vector comprised of the elements of the received symbol vector with odd and even indices respectively;
implementing, by the computer device, a first and a second inverse transform units for providing a respective first and second inverse transformed symbol vector form the respective first and second received symbol vector;
implementing, by the computer device, a symbol detection subsystem for providing a mutual interference mitigated estimates of a first and second multiplicity M_{I} of information modulation symbols; and
implementing, by the computer device, a bank of baseband demodulators for providing estimates of users' data.

17. The method of claim 15, wherein implementing the first and second baseband processing subsystem is comprised of implementing, by the computer device, a block error correction code encoder inputted with the respective group's users data for generating a respective multiplicity M_{I} coded data wherein M_{I} is greater than or equal to Mᵤ; a multiplicity M_{I} baseband modulators for modulating the respective ones of the multiplicity M_{I} coded data for generating a respective multiplicity M_{I} information modulation symbols; a multiplicity M_{I} multipliers for weighting the respective multiplicity M_{I} information modulation symbols; and a scalar to vector converter inputted with the respective weighted multiplicity M_{I} information modulation symbols and a auxiliary symbols comprised of a pilot symbols for providing a respective first and second weighted modulation symbols vector.

18. The method of claim 15, wherein implementing the subsystem for the generation of an OFDM signal vector is comprised of implementing, by the computer device, a first IFFT block for providing a first OFDM signal vector, a second IFFT block for providing a second OFDM signal vector; a frequency shifter for providing the frequency shifted second OFDM signal vector; and an adder for adding the first OFDM signal vector and the frequency shifted second OFDM signal vector.

19. The method of claim 15, wherein a baseband modulator is comprised of a band limiting filter.

20. The method of claim 16, wherein implementing the multicarrier demodulator is comprised of implementing, by the computer device, a serial to parallel converter for providing a received OFDM signal vector; an odd FFT block for providing an odd component vector; a frequency shifter for providing the frequency shifted received OFDM signal vector, an even FFT block for providing an even component vector, and a collator for collating the first M components of the odd component vector and the even component vector.

21. The method of claim 16, wherein implementing the symbol detection subsystem is comprised of implementing, by the computer device, a symbol estimate update subsystem providing the interference mitigated detected first and second modulation symbol vectors, and a vector to scalar converter for providing the detected information modulation symbols.

22. The method of claim 16, wherein implementing the symbol estimate update subsystem is comprised of implementing, by the computer device, a means of recursively providing an updated linear estimate of the first modulation symbol vector on the basis of the detected second modulation symbol vector in a previous iteration; a symbol detector for providing an updated detected first modulation symbol vector, and with a similar means for providing an updated linear estimate of the second modulation symbol vector on the basis of the updated detected first modulation symbol vector; and a symbol detector for providing an updated detected second modulation symbol vector.
